(19) United States
(12) Patent Application Publication
(10) Pub. No.: US 2020/0349786 A1
(43) Pub. Date: Nov. 5, 2020

(54) ACCESS MANAGEMENT SYSTEM

(71) Applicant: Gate Labs Inc., San Francisco, CA (US)

(72) Inventors: Harvey HO, San Francisco, CA (US); Ehsan SAEEDI, San Francisco, CA (US); Danial EHYAIE, San Francisco, CA (US); Amin ARIANA, Burlingame, CA (US)

(73) Assignee: Gate Labs Inc., San Francisco, CA (US)

(21) Appl. No.: 16/834,886

(22) Filed: Mar. 30, 2020

Related U.S. Application Data
(63) Continuation of application No. PCT/US2018/053606, filed on Sep. 28, 2019.
(60) Provisional application No. 62/564,852, filed on Sep. 28, 2017.
(60) Provisional application No. 62/578,295, filed on Oct. 27, 2017.
(60) Provisional application No. 62/615,726, filed on Jan. 10, 2018.

(51) Int. Cl. G07C 9/00; E05B 47/00; G06K 9/00

(52) U.S. Cl. CPC G07C 9/00912; G06K 9/00288; E05B 47/0012

(57) ABSTRACT

Disclosed are systems, apparatus, and methods for remotely managing access to a space and performing trust verification to authorize or deny people access to the space. An access management platform comprising an electronic lock installed on a door can enable a user to establish a virtual presence at the door. For example, a delivery person can activate a doorbell button or icon of the lock and the lock can send a message to a smartphone of a user of the platform. The user can remotely use the smartphone to initiate a video stream using a camera of the platform and a two way audio stream. The user can use the smartphone to unlock the door and ask the delivery person to deliver the package inside. The platform can also determine and control the status of the space and communicate with other devices regarding the status of the space.

### CROSS-REFERENCE TO RELATED APPLICATIONS

This application is a continuation of PCT/US2018/053606, filed Sep. 28, 2018, which claims priority to U.S. Provisional Patent Application No. 62/564,852, filed on Sep. 28, 2017, U.S. Provisional Patent Application No. 62/578,295, filed on Oct. 27, 2017, and U.S. Provisional Patent Application No. 62/615,726, filed on Jan. 10, 2018, the contents of which are incorporated herein by reference in their entireties.

### FIELD OF TECHNOLOGY

This disclosure relates generally to systems, devices, and methods for accessing areas; more specifically, this disclosure relates to systems and devices for locking and unlocking doors and gates and methods of operation thereof.

### BACKGROUND

Delivery services deliver packages, merchandise, groceries, etc. to homes and businesses. When making a delivery that requires a signature, a driver of the delivery service may knock on a door or ring a doorbell of a home/business/etc. When a recipient is at the home or business, the recipient can answer the door, accept delivery of the package, and sign for the package delivery. When no person is at the home or business, the delivery driver often will not make the delivery. Instead, the package may be delivered on another day, the person to whom the package is addressed may need to go to the delivery service to pick up the package, the package may be returned to the shipper, etc. In some cases, items of a delivery that does not require a signature can be left outside a home or business. In such cases, there is a risk that someone may steal the delivered items.

In addition, many types of resources, such as physical properties/entities, virtual properties/entities, etc., are access controlled. Examples of physical properties/entities include, for example, a house, office, automobile, etc. Examples of virtual properties/entities include, for example, a bank account, investment account, website login ID, credit account, etc.

To manage access to physical properties/entities, proprietors often use physical locks to restrict access to authorized individuals. A proprietor grants an authorized individual access to a physical property/entity, such as a house, car, etc., by providing the authorized individual with a physical key to the lock of the house, car, etc. This may involve going to a lock smith to make a copy of the key in order to have a spare key to provide to the individual.

Further, once an individual has a key, disabling access to the property/entity may be difficult. For example, the individual may lose or refuse to return the key, or may, unknown to the proprietor, make a copy of the key. In such a situation, a proprietor may need to pay a lock smith to re-key the lock in order to eliminate access to an unauthorized possessor of a key.

Similar issues exist for managing access to virtual properties/entities, such as when a party responsible for a credit account wants to authorize another person to access the credit account. For example, a business owner may want to authorize an employee to access his business credit account to purchase supplies for the business. To do this, the business owner may need to apply for and obtain a credit card for the employee, or the business owner may provide his credit card to the employee for the employee to use to purchase the business supplies.

Taking measurements such as those described above to enable an authorized individual to access a virtual property/entity, such as enabling the employee to access the business credit account, has inherent complexities and/or risks. Further, these complexities and/or risks increase, in some cases exponentially, as the number of authorized individuals increases.

### SUMMARY

This application discloses technology related to an access management system that enables a person to remotely manage his door from anywhere in the world with access to the Internet. The disclosed technology includes a hardware platform, such as a remote door management platform, that enables the person to have a virtual presence at his door. In some embodiments, a remote door management platform replaces a door lock of a door and includes a camera, microphone, speaker, motorized lock, keypad, wireless communication system, battery power supply, and a processor. Such a remote door management platform can enable a person, such as a recipient, to interact with, for example, a delivery person, and enable the delivery person to deliver the delivery items inside the home or business, even when the recipient is not present at the home or business.

In one example, a delivery person walks up to a door equipped with a door management platform. In this example, the door previously had a door handle that included a deadbolt locking mechanism, and the door lock (or “the access management system is installed on the door”) was replaced by the door management platform, which also includes a deadbolt locking mechanism in this example. The delivery person presses a doorbell button on the door management platform (also referred to herein as the “platform”) to notify a recipient that the delivery person is at the door, also the door management system is motion activate, so no need to press the doorbell. Optionally, the delivery person can have a mobile device that communicates with the platform to identify the delivery person and the tracking number for the package. Additionally, the delivery person can also enter a key code that uniquely identifies the delivery service. The platform has Internet access, such as via a Wi-Fi network of the home or business, via a cellular network, etc., and can relay the received information to a mobile device of the recipient, such as to the recipient's smartphone.

In response to the press of the doorbell button, or motion at the door, the platform emits a chime sound from the platform and sends a notification to the recipient's smartphone. The notification can include identifying information for the delivery person, such as identifying information that was received from the mobile device of the delivery person or from a computer of an employer of the delivery person, a live photograph of the delivery person that is taken by the platform, etc. Even though the recipient is not home, using his smartphone, he acknowledges the notification and chooses to bring up a video feed from a camera of the platform. The recipient recognizes that there is a delivery person at the door and uses his smartphone to initiate a two way real-time audio connection with the platform, which outputs the audio via a speaker of the platform. The recipient greets the delivery person and is told that there is a package that needs to be signed for. The recipient uses an application on his smartphone to sign for the package and sends his electronically captured signature to a computer system of the delivery service or to the delivery person's mobile device.

The recipient remotely unlocks the door by use of his smartphone, which sends a message to the platform instructing the platform to unlock the deadbolt of the door management system, which accordingly unlocked the door. The recipient, also using his smartphone, asks the delivery person to leave the package just inside the entryway of the home. The delivery person opens the door and drops off the package inside the home and closes the door. The video feed continues to run, and the camera of the platform is able to send video of the delivery person as he opens the door and delivers the package. The recipient sees that the package was delivered and remotely locks the door.

Moreover, a locking device can perform trust verification to authorize or deny people access to a space, determine and control the status of a space, and communicate with other devices regarding the status of a space.

### BRIEF DESCRIPTION OF THE DRAWINGS

One or more embodiments are illustrated by way of example in the figures of the accompanying drawings, in which like references indicate similar elements.

FIGS. 1A-1C are each an illustration of an environment in which an electronic lock is used to restrict access to a door, consistent with various embodiments.

FIG. 2 is a system diagram illustrating a platform that includes a b-lock, a biometric data device, and a mobile device, consistent with various embodiments.

FIG. 3 is a block diagram illustrating an embodiment of an electronic lock that includes a personal data device, consistent with various embodiments.

FIG. 4A is a flow diagram illustrating an example process to establish an owner or administrator of an electronic lock, consistent with various embodiments.

FIG. 4B is a flow diagram illustrating an example process to add an administrator or an authorized user of an electronic lock, consistent with various embodiments.

FIG. 5A is a system diagram illustrating a platform that includes a b-lock, a biometric data device, a mobile device, and a server, consistent with various embodiments.

FIG. 5B is a system diagram of a variation a platform that can include a b-lock, a biometric data device, a mobile device, a 1st server, and a 2nd server.

FIG. 6A is a block diagram illustrating an embodiment of an electronic lock that communicates with a server, consistent with various embodiments.

FIG. 6B is a block diagram of a variation of an electronic lock that can communicate with a first server.

FIG. 7A is a flow diagram illustrating an example process that involves a server, to establish an owner or administrator of an electronic lock, consistent with various embodiments.

FIG. 7B is a flow diagram illustrating an example process that includes a server, to add an administrator or an authorized user of an electronic lock, consistent with various embodiments.

FIGS. 8A and 8B are activity diagrams each illustrating a different example process for managing access to a physical property with access controlled by an electronic lock, consistent with various embodiments.

FIG. 9 is an illustration of a user interface for a resource management platform for managing access to shared resources, consistent with various embodiments.

FIGS. 10A, 10B, and 10C are activity diagrams illustrating example processes for managing and enabling access to resources, consistent with various embodiments.

FIG. 11 is an exploded view illustrating the relationship of various components of an electronic lock, consistent with various embodiments.

FIG. 12 is an illustration of a front view of an electronic lock with a rotating cover with the cover positioned to expose a keyhole, consistent with various embodiments.

FIG. 13 is an illustration of a front view of an electronic lock with a rotating cover with the cover positioned to expose a fingerprint scanner, consistent with various embodiments.

FIG. 14 is an illustration of a front view of an electronic lock with a rotating cover, consistent with various embodiments.

FIG. 15 is an illustration of an angled view of an electronic lock that shows both exterior facing and interior facing portions of the b-lock, consistent with various embodiments.

FIG. 16 is an illustration of an angled view of an electronic lock that shows a rotating base and a battery pod that has been removed, consistent with various embodiments.

FIG. 17 is a second illustration of an angled view of an electronic lock that shows a rotating base and a battery pod that has been removed, consistent with various embodiments.

FIG. 18 is an illustration of an angled view of an electronic lock that includes a battery pod mounted on a rotating base, consistent with various embodiments.

FIG. 19 is a cut-away view of a battery pod, consistent with various embodiments.

FIG. 20 is a high-level block diagram showing internal electronics of an electronic lock, consistent with various embodiments.

FIG. 21 is an illustration of an outside face of a door management platform that includes a keypad and a doorbell, consistent with various embodiments.

FIGS. 22A-C are flow diagrams illustrating examples of processes to manage access to an area protected by a door management platform, consistent with various embodiments.

FIG. 23 is a flow diagram illustrating example processes where an electronic lock takes security-related actions based on security-related sensor data, consistent with various embodiments.

FIG. 24 is a block diagram illustrating an example of a processing system in which at least some operations described herein can be implemented, consistent with various embodiments.

FIGS. 25A and 25B are front and rear perspective views, respectively, of a variation of a locking device mounted in a door.

FIG. 25C is a side view of a variation of the locking device mounted in a door.

FIG. 26 illustrates a variation of a strike plate mounted in a door jamb.

FIG. 27 shows a cross-section of a variation of the locking device mounted in the door.

FIGS. 28A-28C are side, front perspective, and rear perspective views, respectively, of cross-section A-A of FIG. 25A.

FIG. 29 is a variation of cross-section B-B of FIG. 25A.

FIG. 30A is a variation of cross-section C-C of FIG. 25B.

FIG. 30B is a variation of cross-section D-D of FIG. 25B.

FIGS. 31A and 31B are side and rear perspective views, respectively, of a close-up of cross-section A-A.

FIGS. 32A and 32B illustrate a view of the rear interior of a variation of the locking device in a first rotated configuration and a second rotated configuration, respectively.

FIG. 33 is a view of a close-up of the rear interior of a variation of the locking device with some elements not shown for illustrative purposes.

FIG. 34 is a rear perspective view of a variation of the locking device mounted in a door with the back cover removed.

FIGS. 35A and 35B are front and rear views, respectively, of a variation of the back cover.

FIG. 35C is a rear view of another variation of the back cover.

FIG. 36 is a schematic diagram of a variation of data components of the locking system.

FIG. 37 is a block diagram illustrating a variation of an electronic lock that includes a personal data device.

FIG. 38 is a schematic diagram of a variation of data transfers between components of the locking system.

FIG. 39 is a horizontal cross-sectional view of a variation of the locking device mounted in a door in a closed configuration.

FIG. 40 is a horizontal cross-sectional view of the variation of the locking device mounted in a door from FIG. 39 in an opened configuration.

FIG. 41 is a graph of a variation of angular velocity of a door over time during opening of the door.

FIG. 42A is a horizontal cross-sectional view of a variation of the locking device mounted in a door in a closed configuration.

FIG. 42B is a horizontal cross-sectional view of the variation of the locking device mounted in a door from FIG. 42A in an opened configuration.

FIG. 43A is a horizontal cross-sectional view of a variation of the locking device mounted in a door in a closed configuration.

FIG. 43B is a horizontal cross-sectional view of the variation of the locking device mounted in a door from FIG. 43A in an opened configuration.

FIG. 44A is a screenshot including a variation of an image from the camera when the door is in a closed configuration.

FIG. 44B a screenshot including a variation of an image from the camera from FIG. 44A when the door is in an opened configuration.

FIG. 45 is a block diagram illustrating variations of functional modules executable by the locking device.

FIG. 46 is a block diagram illustrating variations of submodules within an authentication module executable by the locking device.

FIGS. 47A-47G illustrate a variation of a method of installing a locking device to a door.

### DETAILED DESCRIPTION

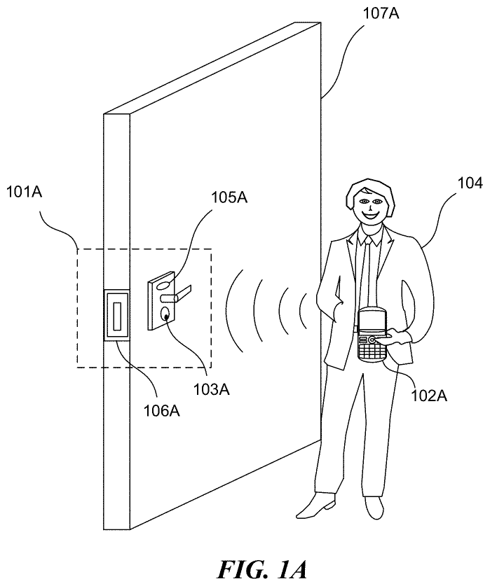

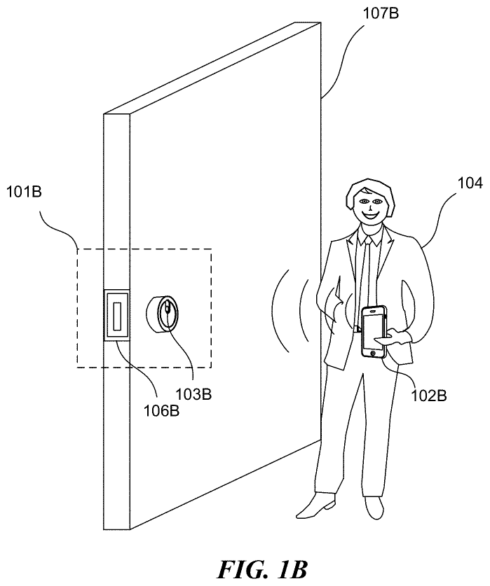

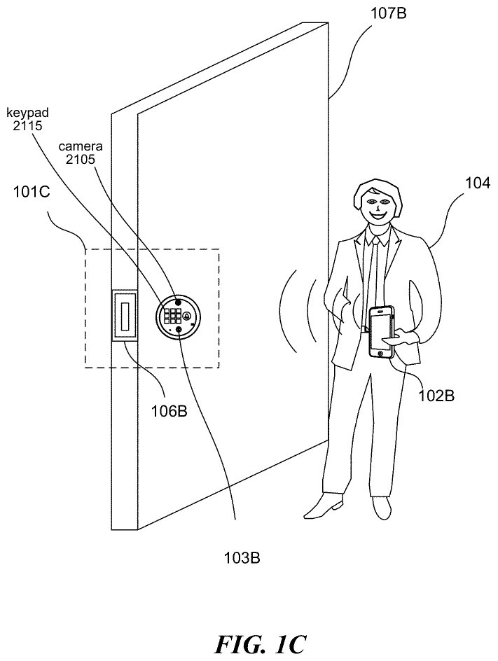

FIG. 1A is an illustration of an environment in which an electronic lock is used to restrict access to a door, consistent with various embodiments. The electronic lock of the embodiment of FIG. 1A is a b-lock. While the following discussion involves a b-lock, much of the discussion is applicable to other types of electronic locks, such as a password lock or a voice recognition lock, among others. B-lock 101A includes key hole 103A, biometric authentication device 105A, and deadbolt 106A. B-lock 101A is being used to lock door 107A, which is a door of a building, in order to restrict access to the building. In the embodiment of FIG. 1A, biometric data device 105A is a fingerprint scanner. A biometric data device is a device that can obtain biometric data of an individual that can be used to verify the identity of the individual.

Returning to FIG. 1A, b-lock 101A in the embodiment of FIG. 1A can validate a first time user in two ways. Other embodiments of a b-lock can validate a first time user in various other ways. The first method validates an administrator based on a security key obtained with a purchase of a b-lock. When user 104 purchased b-lock 101A, the packaging for b-lock 101A included a security key, which is a string of characters, such as alphanumeric characters or other symbols. User 104 installs a b-lock application on mobile device 102A, which is an Android smart phone in this example, and enters the security key into the b-lock application. User 104 then uses mobile device 102A to wirelessly send a signal to b-lock 101A that includes the security key. Upon receipt and validation of the security key, b-lock 101A allows user 104 to scan his finger using biometric data device 105A, and to register his fingerprint data so that user 104 can be verified to be an administrator of b-lock 101A. Examples of mobile devices include smart phones, tablets, portable media devices, wearable devices, laptops, and other portable computers.

The second method validates an administrator based on a physical key. When user 104 purchased b-lock 101A, the packaging for b-lock 101A included a physical key, which fits in key hole 103A and unlocks b-lock 101A. When user 104A inserts the physical key into key hold 103A and opens b-lock 101A, b-lock 101A allows user 104 to scan his finger using biometric data device 105A, and to register his fingerprint data as the fingerprint data of an administrator of b-lock 101A. In some embodiments, when user 104 installs a b-lock application on mobile device 102A, the b-lock application includes a security key that can be used to establish that user 104 is an administrator of b-lock 101A.

After the fingerprint data of user 104 is registered by b-lock 101A, user 104 no longer needs mobile device 102A, or any other mobile device, to open b-lock 101A. To open b-lock 101A, user 104 simply scans his finger using biometric data device 105A. B-lock 101A determines that his fingerprint data matches the registered fingerprint data of an administrator of b-lock 101A, and opens deadbolt 106A to allow user 104 to open door 107A and enter the building.

FIG. 1B is an illustration of an environment in which an electronic lock, such as b-lock 101B, is used to restrict access to a door, consistent with various embodiments. While the following discussion involves a b-lock, much of the discussion is applicable to other types of electronic locks, such as a password lock or a voice recognition lock, among others. The embodiment of FIG. 1B illustrates b-lock 101B, which includes key hole 103B and deadbolt 106B. B-lock 101B is being used to lock door 107B, which is a door of a building, in order to restrict access to the building.

Similar to b-lock 101A, b-lock 101B can validate a first time user in two ways. The first method validates an administrator based on a security key obtained during a purchase of a b-lock. Similar to the process described above for b-lock 101A, user 104 installs a b-lock application on mobile device 102B, which is an iPhone smart phone in this example, and enters a security key that was obtained when the b-lock was purchased into the b-lock application. User 104 then uses mobile device 102B to wirelessly send a signal to b-lock 101B that includes the security key. Upon receipt and validation of the security key, b-lock 101B allows user 104 to scan his finger using a fingerprint scanner of mobile device 102B. The b-lock application wirelessly sends the fingerprint data to b-lock 101B, and b-lock 101B registers the fingerprint data so that user 104 can be verified to be an administrator of b-lock 101B.

The second method validates an administrator based on a physical key. When user 104 purchased b-lock 101B, the packaging for b-lock 101B included a physical key, which fits in key hole 103B and unlocks b-lock 101B. When user 104 inserts the physical key into key hole 103B and opens b-lock 101B, b-lock 101B allows user 104 to scan his finger using a fingerprint scanner of or coupled to mobile device 102B. The b-lock application wirelessly sends the fingerprint data to b-lock 101B, and b-lock 101B registers the fingerprint data so that user 104 can be verified to be an administrator of b-lock 101B.

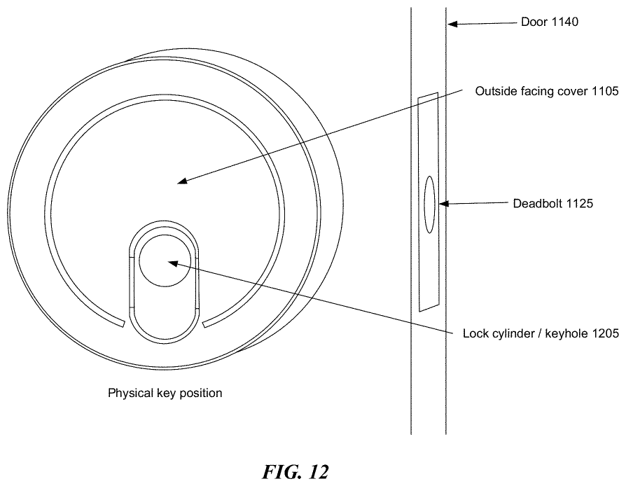

In some embodiments, b-lock 101B does not include a biometric data device. In these embodiments, a mobile device, such as mobile device 102B, can be used to capture biometric data, such as fingerprint data, and to send the biometric data to b-lock 101B, where b-lock 101B validates the fingerprint data and unlocks deadbolt 106B upon validation of the fingerprint data. In other embodiments, such as the b-lock embodiment of FIGS. 12, 13, and 14, the external facing face plate of b-lock 101B rotates. When in a first position, as is illustrated in FIG. 1B, key hole 103B can be accessed by user 104. When in a second position (not shown), such as when rotated 180 degrees relative to the position of FIG. 1B, the opening of the face plate enables a biometric data device to be accessible. In some of these embodiments, a biometric data device of b-lock 101B can be used to obtain biometric data of user 104, such as fingerprint data of user 104. B-lock 101B can validate the fingerprint data and unlock deadbolt 106B upon validation of the fingerprint data.

FIG. 1C is an illustration of an environment in which an electronic lock, such as b-lock 101C, is used to restrict access to a door, consistent with various embodiments. While the following discussion involves a b-lock, much of the discussion is applicable to other types of electronic locks, such as a password lock or a voice recognition lock, among others. The embodiment of FIG. 1C illustrates b-lock 101C, which includes key hole 103B, deadbolt 106B, a camera 2105, and a keypad 2115. B-lock 101C is being used to lock door 107B, which is a door of a building, in order to restrict access to the building.

As will be discussed in more detail in the following sections, the keypad 2115 can be used to verify the owner or administrator of the electronic lock. The camera 2105 can be used for biometric facial recognition to recognize or verify the identity of a user 104 at the door 107B.

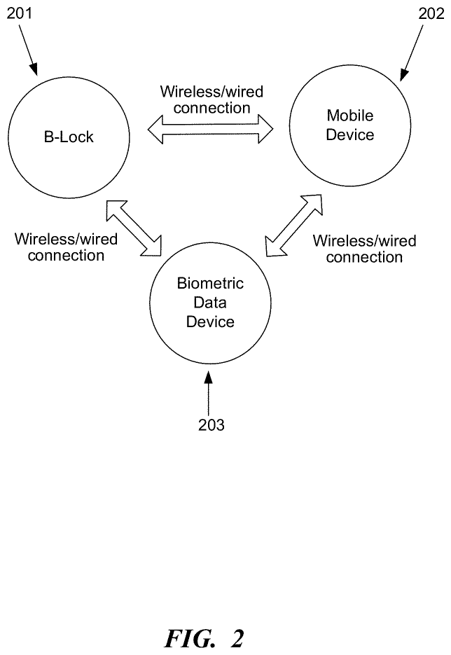

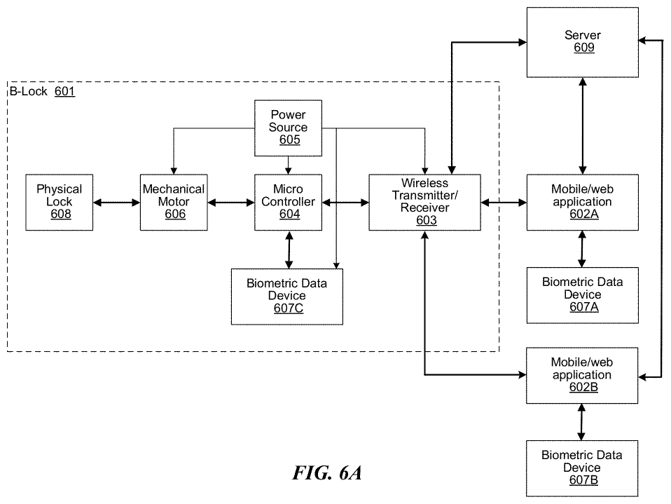

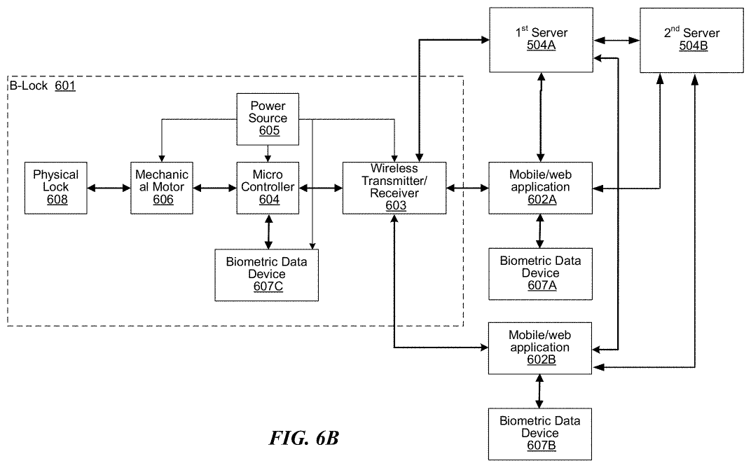

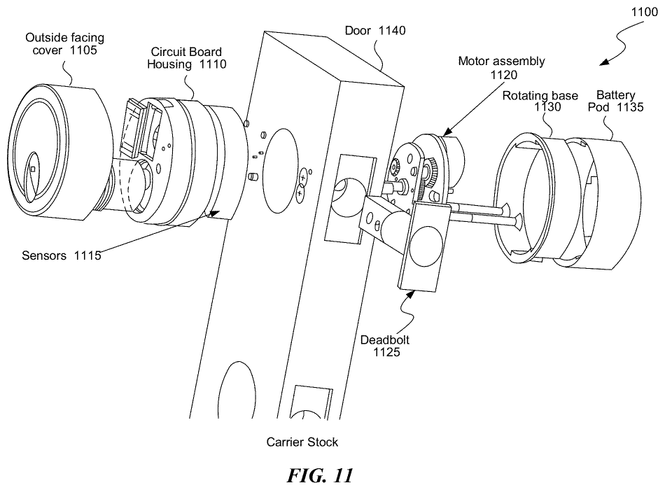

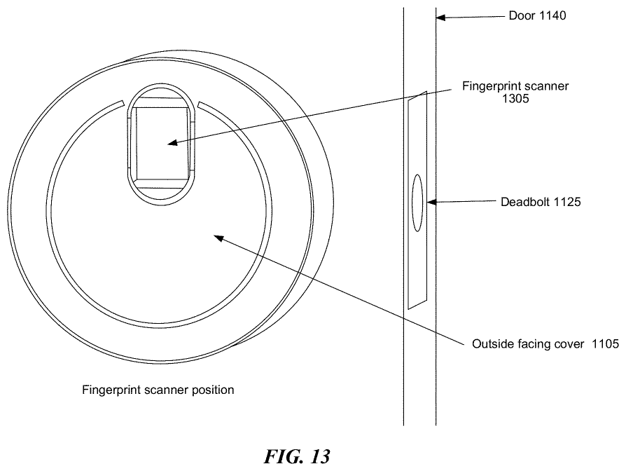

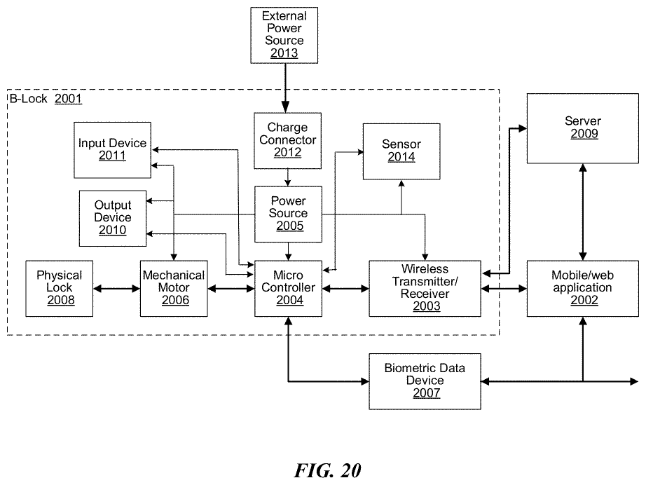

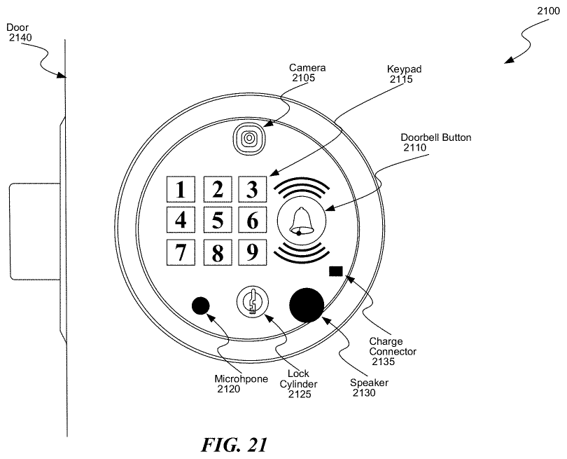

FIG. 2 is a system diagram illustrating a platform that includes a b-lock, a biometric data device, and a mobile device, consistent with various embodiments. B-lock 201 can be, e.g., b-lock 101A of FIG. 1A, b-lock 101B of FIG. 1B, b-lock 301 of FIG. 3, b-lock 601 of FIG. 6A, b-lock 1100 of FIG. 11, b-lock 2001 of FIG. 20, door management platform 2100 of FIG. 21, etc. Mobile device 202 can be, e.g., mobile device 102A of FIG. 1A, mobile device 102B of FIG. 1B, a mobile device executing mobile/web application 602A or 602B of FIG. 6A, etc. Biometric data device 203 can be, e.g., biometric data device 105A of FIG. 1A, a biometric data device of or coupled to mobile device 102B, such as a fingerprint scanner of or coupled to mobile device 102B, biometric data device 307 of FIG. 3, biometric data device 607A, 607B, or 607C of FIG. 6A, fingerprint scanner 1305 of FIG. 13, etc.

FIG. 3 is a block diagram illustrating an embodiment of an electronic lock that includes a personal data device, consistent with various embodiments. In some embodiments, the electronic lock is a b-lock, and the personal data device is a biometric scanner, with which a user can input personal data, such as biometric data of a biometrically identifiable part of his body. In other embodiments, the electronic lock is a password lock, and the personal data device is a keypad 309, touchpad, microphone, etc., with which a user can input personal data, such as a password or pass phrase. Keypad 309 can be the same as or another instance of keypad 2115 discussed in the following sections. In yet other embodiments, the electronic lock is a voice recognition lock, and the personal data device is a microphone into which a user can provide personal data, such as a sample of his voice. In some embodiments, personal data is identifying information that can be used to establish an identity of an individual. While the following discussion involves a b-lock, much of the discussion is applicable to other types of electronic locks, such as a password lock or a voice recognition lock, among others.

B-lock 301 of the embodiment of FIG. 3 can be, for example, b-lock 101A of FIG. 1A, b-lock 101B of FIG. 1B, b-lock 601 of FIG. 6A, b-lock 1100 of FIG. 11, b-lock 2001 of FIG. 20, or door management platform 2100 of FIG. 21. B-lock 301 includes physical lock 308. As will be appreciated by a person of ordinary skill in the art, physical lock 308 includes some components that are similar to those of a standard lock for a particular application. For example, a b-lock for a particular application of locking a door of a building can include some components similar to those of a standard lock to lock a door of a building. The components can include, for example, a dead bolt, mechanical parts to cause the dead bolt to move and lock/unlock a door, a key hole/cylinder into which a key can be inserted to lock/unlock a door, etc.

As a second example, a b-lock for a particular application of locking a door of a safe can include some components similar to those of a standard lock to lock a door of a safe. The components can include, for example, a combination or security code entry mechanism, multiple dead bolts, each of which extend from the door and enter the door frame of the safe to secure the safe door, mechanical parts to cause the dead bolts to move and lock/unlock the safe door, etc. As a third example, a b-lock for a particular application of locking a door of a car can include some components similar to those of a standard lock to lock a door of a car. The components can include, for example, a latch to latch the car door closed, a key hole/cylinder into which a key can be inserted to lock/unlock the car door, a wireless receiver and a processing unit to receive a wireless signal (that includes a security code), to validate the security code, and to unlock/lock the car door upon validation of the security code, etc.

As discussed above, various embodiments of b-lock 301 can be used to lock any of various doors, such as a door on a building, a door on a car, a door on a safe, a door on a cabinet, etc. B-lock 301 can be unlocked and/or locked based on validation of biometric data, which is obtained by biometric data device 307. Biometric data device 307 is a device that can obtain data of a biometrically identifiable object where the data can be used to identify the biometrically identifiable object. Examples of biometrically identifiable objects include a finger, a hand, an iris, a face, etc. Examples of biometric data devices include a fingerprint scanner, a hand scanner, an iris scanner, a face scanner, a camera, etc. In some embodiments, biometric data device 307 is not integrated in a b-lock, but rather is integrated in or coupled to a mobile device, such as a mobile device that is executing mobile/web application 302.

Biometric data device 307, which is a personal data device, can obtain biometric data of a user, and can send the biometric data to microcontroller 304. Microcontroller 304 can have a local memory that stores various types of data and information, such as security keys, biometric information, access details, logs of user interaction, associated usage timestamps, etc. Microcontroller 304 can keep a record of owner and/or administrator information for b-lock 301. In some embodiments, each b-lock has a single registered owner. In some of these embodiments, in addition to having a single registered owner, each b-lock can have one or more administrators. An owner can authorize a user to be an administrator. Both owners and administrators can authorize a user to be able to unlock/lock a b-lock.

When a new user indicates a request to open b-lock 301 by scanning his fingerprint using biometric data device 307, the request is sent to microcontroller 304. Microcontroller 304 compares biometric data obtained by biometric data device 307 from the new user against registered user data that is stored in local memory, which can be non-volatile memory. If the biometric data matches a registered user that is authorized to open b-lock 301, microcontroller 304 signals mechanical motor 306 to actuate the deadbolt of physical lock 308 in order to open b-lock 301.

Power source 305 provides power to b-lock 301, and can operate on a battery energy source, a wired power outlet, etc. For example, power source 305 can be a rechargeable battery.

B-lock 301 can include light emitting diodes (LEDs), a display, etc. to indicate the lock/unlock status of b-lock 301 to users. Physical lock 308 can include a knob for manually locking/unlocking b-lock 301 that is accessible from the inside of the door on which b-lock 301 is mounted. Physical lock 308 can also include a key hole/cylinder that is accessible from the outside of the door on which b-lock 301 is mounted, and into which a user can insert a physical key to lock/unlock b-lock 301.

B-lock 301 can include an alphanumerical keypad 309 that allows users to press buttons to input a code to unlock the lock. The pin code can be stored in the microcontroller 304 to be verified. The micro controller can talk to the mobile application 302 directly or via an indirect connection such as a cloud service. The mobile application 302 can allow the user to assign a pin or pass code that is then transmitted to the lock 301. The pin code itself can have associated parameters such as: valid times for use, expiration date of the code, and how many times it can be used before it goes invalid. The keypad 309 can also be included as part of a separate unit or device that is configured to wirelessly connect or communicate with the B-lock 301 via a short-range communication protocol such as a Bluetooth™ or Bluetooth™ Low Energy (BLE) communication protocol.

In various embodiments, wireless transmitter/receiver 303 can communicate via any of various technologies, such as a cellular network, a short-range wireless network, a wireless local area network (WLAN), etc. The cellular network can be any of various types, such as code division multiple access (CDMA), time division multiple access (TDMA), global system for mobile communications (GSM), long term evolution (LTE), 3G, 4G, etc. The short-range wireless network can also be any of various types, such as Bluetooth, Bluetooth low energy (BLE), near field communication (NFC), etc. The WLAN can similarly be any of various types, such as the various types of IEEE 802.11 networks, among others. In some embodiments, wireless transmitter/receiver 303 can also or alternately communicate via a wired connection, such as via internet protocol (IP) messages sent over a wired Ethernet network. In some embodiments, wireless transmitter/receiver 303 can communicate with a server, such as server 609 of FIG. 6A.

Microcontroller 304 can maintain a log of entries and exits and can send the log information via wireless communication facilitated by wireless transmitter/receiver 303 to, for example, a b-lock application running on a mobile device, such as mobile/web application 302. Microcontroller 304 can log when a user opens b-lock 301 with a physical key, and can share this log information with the lock owner and/or administrator(s). Logs of b-lock 301 being locked and/or unlocked through the use of a physical key can, for example, inform the owner of events such as unauthorized access into a space (e.g., a burglary). In some embodiments, a voltage output of mechanical motor 306 is monitored by a circuit of b-lock 301 in order to sense when physical lock 308 is manually locked and/or unlocked using a physical key. In some embodiments, a capacitive/optical sensor of b-lock 301 can track the opening and closing of the door. B-lock 301 can be equipped with other sensors that track vibrations, temperature, etc. B-lock 301 can also be equipped with a display, touch sensors, and/or a camera to enable communication to and/or from users.

In some embodiments, biometric data device 307 can communicate with both microcontroller 304 and mobile/web application 302. Mobile/web application 302 can be a mobile or a web application that runs on, for example, a mobile device such as mobile device 102A of FIG. 1A or mobile device 102B of FIG. 1B. In some embodiments, biometric data device 307 is not part of b-lock 301, but is rather part of or coupled to a mobile device. FIG. 6A provides a block diagram illustrating how a biometric data device, such as biometric data device 607A, can be part of or coupled to a mobile device executing a mobile/web application, such as mobile/web application 602A which can be executed on a mobile device. Returning to FIG. 3, in some embodiments, biometric data device 307, rather than microcontroller 304, validates the biometric data, such as by comparing the biometric data to stored biometric data of users that are authorized to unlock/lock b-lock 301. The stored biometric data can be stored, for example, in a database. The stored biometric data can reside locally on microcontroller 304, can reside on biometric data device 307, or can reside at another location that is accessible via wireless transmitter/receiver 303. If a user is verified as being authorized to lock/unlock b-lock 301 at the time of the verification, b-lock 301 will lock or unlock the door/gate on which b-lock 301 is mounted.

In some embodiments, mobile/web application 302 can help users of b-lock 301 to organize and manage access to a protected resource, such as a house, a car, a safe, etc. The log information can help inform the owners and/or administrators how the resource is accessed. B-lock 301 can also be applied to an object which has a lock mechanism, but not a door for restricting access to the object, such as a computer or a boat. For example, b-lock 301 can be used as a lock mechanism for the computer or the boat. An owner and/or administrator of b-lock 301 can utilize mobile/web application 302 to authorize an individual to be able to lock/unlock b-lock 301 for any period of time.

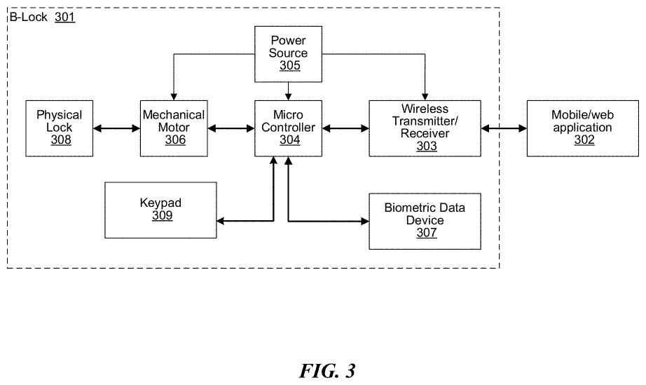

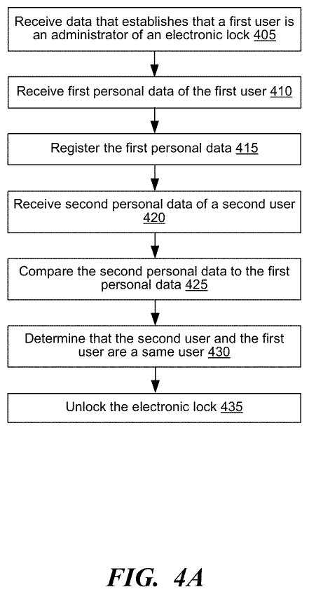

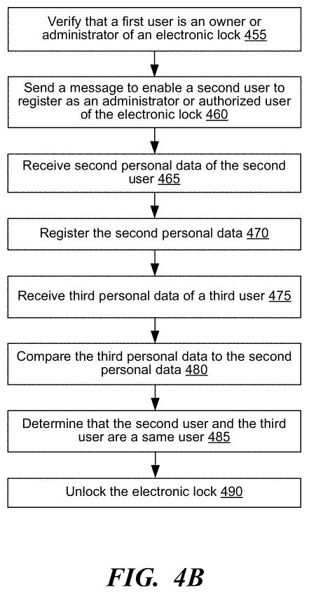

FIG. 4A is a flow diagram illustrating an example process to establish an owner or administrator of an electronic lock, such as b-lock 101A of FIG. 1A, b-lock 101B of FIG. 1B, b-lock 301 of FIG. 3, b-lock 601 of FIG. 6A, b-lock 1100 of FIG. 11, b-lock 2001 of FIG. 20, or door management platform 2100 of FIG. 21, consistent with various embodiments. To facilitate locking or unlocking an electronic lock based on personal data, an owner or administrator of the electronic lock can be established. The electronic lock receives data that establishes that a user is an owner or administrator of the electronic lock (step 405). For example, b-lock 301 can receive the data via wireless transmitter/receiver 303. Any of a variety of methods can be utilized to establish that a user is an owner or administrator of an electronic lock. In a first example, a security code that is unique to a particular electronic lock is delivered to a user in association with a purchase of the electronic lock by the user, such as via product packaging or via registering the electronic lock at a website. The security key can be a one-time use key to set up and establish the identity of a user as an authorized user. The security key can be different or separate form a pin code used to unlock the electronic lock. When the security key is delivered via product packaging, the user, for example, obtains a document from the package that contains the security key. When the security key is delivered via a website, the user inputs a string, such as an alphanumeric string that contains the serial number of the electronic lock, at the website, such as by use of a desktop computer. The website can display the security key or send the security key to the user, such as via email or text message.

Once the user has the security key, the user can use the security key to establish that he is an owner or administrator of the electronic lock in any of several ways. For example, the user can download from a website and install on a mobile device an electronic lock application, which is an application associated with an electronic lock. A mobile device, such as mobile device 102A or 102B, can download and install an electronic lock application, such as mobile/web application 302. The user can launch the electronic lock application, and can input the security code via the electronic lock application. In some embodiments, when the electronic lock application is installed on the mobile device, the electronic lock application includes a security key.

The electronic lock application can communicate with the electronic lock either wirelessly or via a wired connection, and can send the security key to the electronic lock. For example, mobile device 102A of FIG. 1A or 102B of FIG. 1B can send the security key to b-lock 301 of FIG. 3 via a wireless or wired connection with wireless transmitter/receiver 303. The security key can be sent via an encrypted message, and b-lock 301, such as via microcontroller 304, can unencrypt the message to obtain the unencrypted security key. B-lock 301 can include non-volatile storage, such as a magnetic floppy or hard disk, a magnetic-optical disk, an optical disk, a flash memory such as NAND flash memory or NOR flash memory, a read-only memory (ROM) such as a CD-ROM, a programmable read-only memory such as EPROM or EEPROM, a magnetic or optical card, or another form of non-volatile storage. B-lock 301, such as via microcontroller 304, can access security key related data from the non-volatile storage, and can use the security key related data to verify that the security key is valid for b-lock 301. Upon validation of the security key, b-lock 301 establishes that the user is an administrator or owner of b-lock 301.

As another example of using the security key to establish that a user is an owner or administrator of an electronic lock, such as b-lock 301, the security key can be input at b-lock 301. B-lock 301 can include an input mechanism, such as a keypad 309, a touchpad, a microphone and associated voice recognition, or other input capability, and the user can input the security key using the input mechanism, which can be sent to microcontroller 304. B-lock 301, such as via microcontroller 304, can access security key related data from non-volatile storage, and can use the security key related data to verify that the security key is valid for b-lock 301. Upon validation of the security key, b-lock 301 establishes that the user is an administrator or owner of b-lock 301.

A second example of a method to establish that a user is an administrator of an electronic lock uses a physical key that is keyed to a particular electronic lock. The user can use the physical key to establish that he is an owner or administrator of the electronic lock by using the key to unlock, for example, b-lock 301. Microcontroller 304 determines that b-lock 301 has been unlocked by use of a physical key, and, accordingly, establishes that the user is an administrator or owner of b-lock 301. The security key can be different from a pin code that is authorized to unlock a deadbolt of the b-lock 301.

Once an electronic lock establishes that a user is an administrator or owner of the electronic lock, the personal data of the user is registered. The personal data can be obtained in any of various ways. In embodiments where an electronic lock, such as b-lock 301, includes a personal data device, such as biometric data device 307, the personal data device can be used to obtain personal data of the user, such as biometric data of the user, a password of pass phrase for the user, a voice sample of the user. etc. In some embodiments, such as the embodiment of FIG. 6A, a personal data device of or coupled to a mobile device, such as biometric data device 607A or 607B, which can be integrated in or coupled to a mobile device that is executing, respectively, mobile/web application 602A or 602B, can be used to obtain personal data of the user. An electronic lock, such as b-lock 301, can receive the personal data of the user (step 410), and can register the personal data (step 415). Registering personal data includes storing the data or a representation of the data in memory, such as non-volatile storage, and associating the personal data with a role or permission related to b-lock 301. For example, b-lock 301 can receive fingerprint data of a user who has been established to be an administrator or owner of b-lock 301. B-lock 301 can store the personal data in memory, and can associate the personal data with an owner role, an administrator role, with b-lock related permissions, etc. An owner or administrator can be, for example, authorized to unlock or lock b-lock 301 at any time.

At a later point in time, a second user attempts to unlock b-lock 301. The second user uses a personal data device to obtain second personal data, which in this example is the second user's biometric data. The second user uses a personal data device, for example, biometric data device 307 or a biometric data device of or coupled to a mobile device of the second user, to obtain second personal data. Biometric data device 307 or the mobile device of the second user send the personal data to b-lock 301, where the personal data is received (step 420). At step 425, b-lock 301, such as via microcontroller 304, compares the second personal data to the personal data of step 415 to determine whether the second user is an owner or administrator of b-lock 301. At step 430, b-lock 301 determines that the second user and the user of step 405 are a same user, and accordingly also determines that the second user is an owner or administrator of b-lock 301. Based on the validation that the second user is an owner or administrator of b-lock 301, b-lock 301 unlocks the locking mechanism of physical lock 308 (step 435), such as by microcontroller 304 sending a signal to mechanical motor 306 to cause mechanical motor 306 to unlock b-lock 301. A locking mechanism is an assembly of moving parts that enables a door, gate, lid, drawer, or the like in which the locking mechanism is installed to be secured in a closed position. In some embodiments, a locking mechanism consists of a bolt or series of bolts propelled and withdrawn by an assembly of moving parts. In some embodiments, a motor moves parts of a locking mechanism to propel or withdraw a bolt or series of bolts in order to secure or unsecure a door, gate, lid, drawer, or the like in which the locking mechanism is installed.

FIG. 4B is a flow diagram illustrating an example process to add an administrator or an authorized user of an electronic lock, such as b-lock 101A of FIG. 1A, b-lock 101B of FIG. 1B, b-lock 301 of FIG. 3, b-lock 601 of FIG. 6A, b-lock 1100 of FIG. 11, b-lock 2001 of FIG. 20, or door management platform 2100 of FIG. 21, consistent with various embodiments. To facilitate adding an administrator or an authorized user of an electronic lock, the electronic lock can initially have an owner or administrator established, such as via the process of FIG. 4A. The owner or administrator can authorize an addition of an authorized user or an additional administrator.

An electronic lock, such as b-lock 301 of FIG. 3, verifies that a user is an owner or administrator of the electronic lock (step 455). This verification can be accomplished in any of various ways. For example, when the user is established to be an administrator or owner of the electronic lock, such as at step 405 of FIG. 4A, b-lock 301 of FIG. 3, or another device, can send first security data to a mobile device of the user to enable the mobile device to be identifiable. Messages sent by the mobile device to b-lock 301 can include second security data that enables b-lock 301 to verify that the message is from the mobile device of the user. The second security data can be verified to be the same as, derived from, associated with, etc., the first security data. Once the identity of the mobile device is established via validation of the second security data, and the second security data is validated to be associated with an owner or administrator of the electronic lock, any messages sent from the mobile device can be validated as being from an owner or administrator of the electronic lock.

Once the user is validated to be an owner or administrator of b-lock 301, the user can initiate a process to add a new administrator or authorized user. An administrator is able to manage an electronic lock, for example, by adding or deleting authorized users or other administrators. In some embodiments, only an owner can change roles/permissions of an administrator, such as adding a new administrator or deleting an existing administrator. The user can enable a second user to register as an administrator or an authorized user of b-lock 301 by causing b-lock 301 or mobile/web application 302 to send a message to the second user. For example, the user can use an electronic lock application running on his mobile device to add a second user. The user can enter any of the email address, mobile phone number, etc. of the second user, and the electronic lock application can send a message that includes a security key to the second user via email, text, etc. The security key can be recognized by b-lock 301 as granting administrator or authorized user permissions to the second user. The second user, such as by running an electronic lock application that has access to the security key on his mobile device, or by logging into a website into which the security key can be input, can cause the security key to be sent to b-lock 301. B-lock 301 can validate the security key and, based on the security key, determine that the second user has administrator or authorized used permissions.

At step 465, which is similar to step 410 of FIG. 1A, b-lock 301 receives the personal data of the second user, and registers the personal data (step 470, which is similar to step 415). At a later point in time, a third user attempts to unlock b-lock 301. The third user uses a personal data device to obtain third personal data, which in this example is the third user's biometric data. The third user uses biometric data device 307 or a biometric data device of or coupled to a mobile device of the third user, to obtain third personal data. Biometric data device 307 or the mobile device send the personal data to b-lock 301, where the personal data is received (step 475, which is similar to step 420). At step 480, which is similar to step 425, b-lock 301, such as via microcontroller 304, compares the third personal data to the personal data of step 470 to determine whether the second user is an administrator or authorized user of b-lock 301. At step 485, which is similar to step 430, b-lock 301 determines that the third user and the user of step 470 are the same user. Based on the validation that the third user is an administrator or authorized user of b-lock 301, b-lock 301 unlocks the locking mechanism of physical lock 308 (step 490, which is similar to step 435).

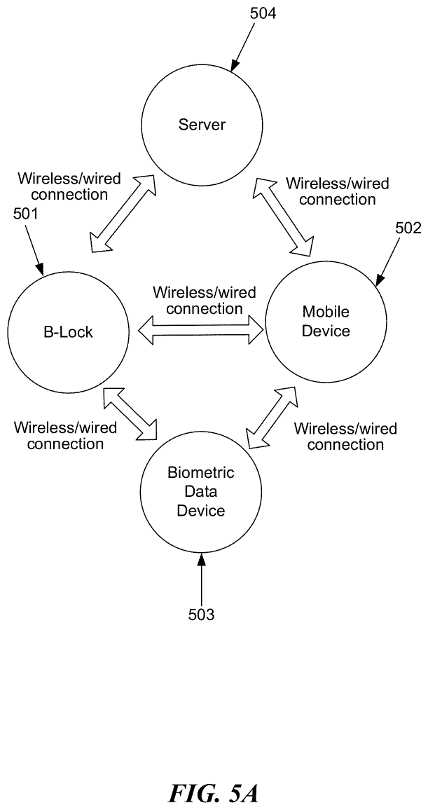

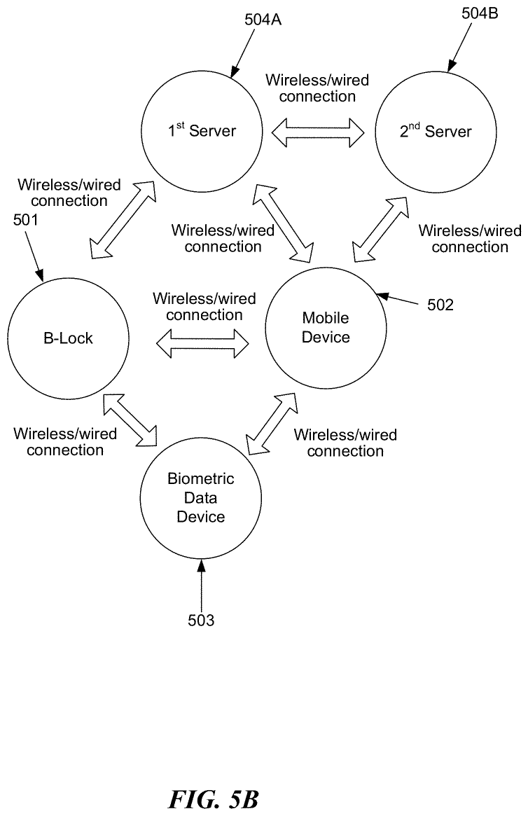

FIG. 5A is a system diagram illustrating a platform that includes a b-lock, a biometric data device, a mobile device, and a server, consistent with various embodiments. B-lock 501 can be, e.g., b-lock 101A of FIG. 1A, b-lock 101B of FIG. 1B, b-lock 301 of FIG. 3, b-lock 601 of FIG. 6A, b-lock 1100 of FIG. 11, b-lock 2001 of FIG. 20, door management platform 2100 of FIG. 21, etc. Mobile device 502 can be, e.g., mobile device 102A of FIG. 1A, mobile device 102B of FIG. 1B, a mobile device executing mobile/web application 602A or 602B, etc. Biometric data device 503 can be, e.g., biometric data device 105A of FIG. 1A, a biometric data device of or coupled to mobile device 102B, biometric data device 307 of FIG. 3, biometric data device 607A, 607B, or 607C of FIG. 6A, fingerprint scanner 1305 of FIG. 13, etc. Server 504 can be, e.g., server 609 of FIG. 6A, server 2009 of FIG. 20, etc. The platform of FIG. 5A can be used, for example, to manage access to physical (e.g., house, office, car, etc.) or virtual (e.g., bank account, website, etc.) properties based on biometric data. The platform can use biometric data to eliminate the need for users to carry, for example, physical keys, account specific authentication tokens, etc.

FIG. 5B illustrates that a platform can include a b-lock, a biometric data device, a mobile device, and two servers, or combinations thereof. B-lock 501 can be b-lock 101A of FIG. 1A, b-lock 101B of FIG. 1B, b-lock 301 of FIG. 3, b-lock 601 of FIG. 6A, b-lock 1100 of FIG. 11, b-lock 2001 of FIG. 20, door management platform 2100 of FIG. 21. Mobile device 502 can be mobile device 102A of FIG. 1A, mobile device 102B of FIG. 1B, a mobile device executing mobile/web application 602A or 602B, or combinations thereof. Biometric data device 503 can be the biometric data device 105A of FIG. 1A, a biometric data device of or coupled to mobile device 102B, biometric data device 307 of FIG. 3, biometric data device 607A, 607B, or 607C of FIG. 6A, fingerprint scanner 1305 of FIG. 13, or combinations thereof. First server 504A can be the server 609 of FIG. 6A, server 2009 of FIG. 20, or combinations thereof. The functionality of server 504 of FIG. 5A can be split between two or more servers. Second server 504B can be the second server 504B of FIG. 6B, server 2009 of FIG. 20, or combinations thereof. The platform of FIG. 5B can be used, for example, to manage access to physical (e.g., house, office, car, or combinations thereof) or virtual (e.g., bank account, website, or combinations thereof) properties based on biometric data. The platform can use biometric data to eliminate the need for users to carry, for example, physical keys, account specific authentication tokens, or combinations thereof.

The first server 504A can be a server of a first company and the second server 504B can be a server of a second company different from the first company. For example, the first company can be a locking device company and the second company can be any third party company, for example, a vendor such as a delivery company, a service company (e.g., cleaning company, dog walking company), or any combination thereof. The first server 504A can be part of the backend of the first company. The first server 504A can be a cloud server. The second server 504B can be part of the backend of the second company. The second server 504B can be a cloud server. For example, the first server 504A can be a server of the locking device company (also referred to as a device server) and the second server 504B can be a server of a vendor (also referred to as a vendor server). Further, although FIG. 5B illustrates first and second servers 504A, 504B, the access management system can have 1 to 100 or more servers, for example, a device server and one or multiple vendor servers (e.g., a second server 504B). Each vendor can have a vendor server configured to communicate with the locking device (e.g., the B-lock 601), the device server, one or multiple user computers, or any combination thereof. The user computers can be mobile devices such as smartphones or package delivery scanners (e.g., portable, possibly wearable, battery-powered barcode scanners or QR code scanners use by a delivery person configured to communicate over WiFi, Bluetooth, and/or a cellular network and/or over wired connections, such as a Motorola MC3090 gun-style, laser barcode scanner with a pistol grip, or a Motorola RS419 ring scanner finger bar code reader). The user computers can be non-mobile devices such as desktop computers. The user computers can have software configured to interface with the locking device and one or more backend systems, for example, a device server and/or a vender server (e.g., first and second servers 504A, 504B).

The servers (e.g., first and second servers 504A, 504B) can each independently communicate with the locking device (e.g., the B-lock 601), user computers, another server (e.g., the first server 504A can communicate with the second server 504B and vice versa), or any combination thereof. The first and second servers 504A, 504B can individually or collectively communicate with the locking device, user computers, another server (e.g., the first server 504A can communicate with the second server 504B and vice versa), or any combination thereof. The first and/or second server 504A, 504B can generate signals (or access codes) configured to lock and unlock the locking device. As another example, the device server (e.g., first server 504A) can coordinate locking and unlocking of the locking device with one or multiple vendor servers (e.g., second server 504B).

FIG. 6A is a block diagram illustrating an embodiment of an electronic lock that communicates with a server, consistent with various embodiments. The electronic lock of the embodiment of FIG. 6A is b-lock 601. B-lock 601, wireless transmitter/receiver 603, microcontroller 604, power source 605, mechanical motor 606, and physical lock 608 are, respectively, substantially similar to b-lock 301, wireless transmitter/receiver 303, microcontroller 304, power source 305, mechanical motor 306, and physical lock 308 of FIG. 3. In some embodiments, b-lock 601 includes a biometric data device, such as biometric data device 607C, while in other embodiments, b-lock 601 does not include a biometric data device. In some embodiments, regardless as to whether a b-lock includes a biometric data device, biometric data of a user can be obtained by a remote device, such as a biometric data device that is part of or coupled to a mobile device.

FIG. 6B illustrates that the electronic lock can communicate with a first server 504A. First server 504A can communicate with a second server 504B. The electronic lock of the embodiment of FIG. 6B is b-lock 601. B-lock 601, wireless transmitter/receiver 603, microcontroller 604, power source 605, mechanical motor 606, and physical lock 608 can be, respectively, substantially similar to b-lock 301, wireless transmitter/receiver 303, microcontroller 304, power source 305, mechanical motor 306, and physical lock 308 of FIG. 3. B-lock 601 can include a biometric data device, such as biometric data device 607C. B-lock 601 may not include a biometric data device. Regardless as to whether a b-lock includes a biometric data device, biometric data of a user can be obtained by a remote device, such as a biometric data device that is part of or coupled to a mobile device.

For example, in some embodiments, regardless as to whether b-lock 601 includes biometric data device 607C, biometric data of a user can be obtained by biometric data device 607A or 607B that is part of or coupled to, respectively, a first mobile device that is executing mobile/web application 602A or a second mobile device that is executing mobile/web application 602B. Either mobile/web application 602A or 602B can send the biometric data to b-lock 601. For example, mobile/web application 602A or 602B can send the biometric data to wireless transmitter/receiver 603, which can relay the biometric data to microcontroller 604. Further, b-lock 601 can communicate with server 609 via wireless transmitter/receiver 603. B-lock 601 can also communicate with first server 504A via wireless transmitter/receiver 603.

In some embodiments, server 609 is a cloud server. For example, server 609 can be a server that is a shared cloud computing resource. In some embodiments, server 609, or any computing device that can communicate with other computing devices via a network, can store data using cloud storage. For example, server 609 can store data using storage that is part of a shared could computing resource.

The functionality of server 609 can be split between two or more servers. For example, a first server 504A and a second server 504B can be used in place of server 609. First server 504A can communicate with second server 504B.

The first server 504A can be a cloud server. For example, first server 504A can be a server that can be a shared cloud computing resource. The first server 504A, or any computing device that can communicate with other computing devices via a network, can store data using cloud storage. For example, first server 504A can store data using storage that is part of a shared could computing resource.

The second server 504B can be a cloud server. For example, second server 504B can be a server that can be a shared cloud computing resource. The second server 504B, or any computing device that can communicate with other computing devices via a network, can store data using cloud storage. For example, second server 504B can store data using storage that is part of a shared could computing

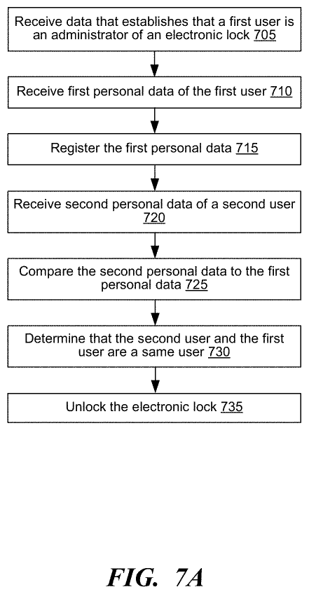

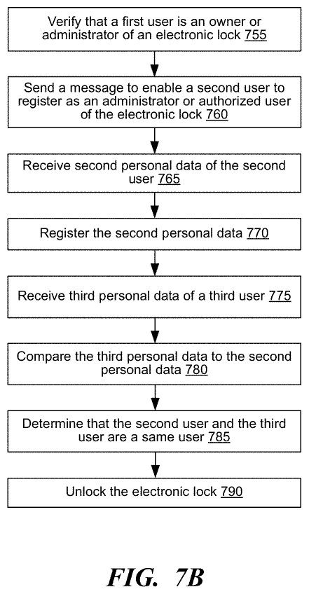

FIG. 7A is a flow diagram illustrating an example process that involves a server, to establish an owner or administrator of an electronic lock, consistent with various embodiments. The electronic lock of the embodiment of FIG. 7A is a b-lock, such as b-lock 101A of FIG. 1A, b-lock 101B of FIG. 1B, b-lock 301 of FIG. 3, b-lock 601 of FIG. 6A, b-lock 1100 of FIG. 11, b-lock 2001 of FIG. 20, or door management platform 2100 of FIG. 21. To facilitate locking or unlocking an electronic lock based on personal data, an owner or administrator of the electronic lock can be established. A server, such as server 609 or server 2009 or first server 504A or second server 504B, receives data that establishes that a user is an administrator of the electronic lock (step 705). As is discussed above in the description of FIG. 4A, any of a variety of methods can be utilized to establish that a user is an administrator of an electronic lock, and to enable the user to obtain a security key for the electronic lock.

As is discussed above in the description of FIG. 4A, once the user has the security key, the user can use the security key to establish that he is an owner or administrator of the electronic lock in any of several ways. For example, the user can download from a website and install on a mobile device an electronic lock application. A mobile device, such as mobile device 102A or 102B, can download and install mobile/web application 602A, which can be an electronic lock application. The user can launch the electronic lock application, and can input the security code via the electronic lock application. The electronic lock application can communicate with the server either wirelessly or via a wired connection, and can send the security key to the server. For example, mobile device 102A of FIG. 1A or 102B of FIG. 1B can send the security key to server 609. Server 609 can include non-volatile storage, such as a magnetic floppy or hard disk, a magnetic-optical disk, an optical disk, a flash memory such as NAND flash memory or NOR flash memory, a read-only memory (ROM) such as a CD-ROM, a programmable read-only memory such as EPROM or EEPROM, a magnetic or optical card, or another form of non-volatile storage. Server 609 can access security key related data from the non-volatile storage, and can use the security key related data to verify that the received security key is valid for b-lock 601. Upon validation of the security key, server 609 establishes that the user is an administrator or owner of b-lock 601.

Once a server establishes that a user is an administrator or owner of an electronic lock, the personal data of the user is registered. As is discussed above in the description of FIG. 4A, the personal data can be obtained in any of various ways. In the embodiment of FIG. 7A, the user uses biometric data device 607A, which is part of or coupled to a mobile device that is running mobile/web application 602A, to obtain personal data of the user. Server 609 can receive the personal data of the user (step 710), and can register the personal data (step 715). Registering personal data includes storing the data or a representation of the data in memory, such as non-volatile storage, and associating the personal data with a role or permission related to b-lock 601. For example, server 609 can receive fingerprint data of a user who has been established to be an administrator or owner of b-lock 601. Server 609 can store the personal data in memory, and can associate the personal data with an owner or administrator role, can associate the personal data with b-lock 601 related permissions, etc.

At a later point in time, a second user attempts to unlock b-lock 601. The second user uses a personal data device to obtain second personal data, which in this example is the second user's biometric data. The second user uses, for example, biometric data device 607B, which is part of or coupled to a mobile device executing mobile/web application 602B, to obtain the second personal data. Biometric data device 607B sends the second personal data to mobile/web application 602B, which in turn sends the personal data to server 609, where the personal data is received (step 720). At step 725, server 609 compares the second personal data to the personal data of step 715 to determine whether the second user is an owner or administrator of b-lock 601. At step 730, server 609 determines that the second user and the user of step 705 are a same user, and accordingly also determines that the second user is an owner or administrator of b-lock 601. Based on the validation that the second user is an owner or administrator of b-lock 601, which can be communicated to b-lock 601 by server 609 when server 609 accomplishes the validation, b-lock 601 unlocks the locking mechanism of physical lock 608 (step 735), such as by microcontroller 604 sending a signal to mechanical motor 606 to cause mechanical motor 606 to unlock b-lock 601.

FIG. 7B is a flow diagram illustrating an example process that includes a server, to add an administrator or an authorized user of an electronic lock, consistent with various embodiments. The electronic lock of the embodiment of FIG. 7B is a b-lock, such as b-lock 101A of FIG. 1A, b-lock 101B of FIG. 1B, b-lock 301 of FIG. 3, b-lock 601 of FIG. 6A, b-lock 1100 of FIG. 11, b-lock 2001 of FIG. 20, or door management platform 2100 of FIG. 21. To facilitate adding an administrator or an authorized user of an electronic lock, the electronic lock can initially have an owner or administrator established, such as via the process of FIG. 7A. The owner or administrator can authorize an addition of an authorized user or an additional administrator.

A server, such as server 609 of FIG. 6A, verifies that a user is an owner or administrator of an electronic lock, such as b-lock 601 (step 755). As is discussed above in the description of FIG. 4B, this verification can be accomplished in any of various ways. For example, when the user is established to be an administrator or owner of the electronic lock, such as at step 705 of FIG. 7A, server 609 of FIG. 6A can send first security data to a mobile device of the user, such as a mobile device running mobile/web application 602A, to enable the mobile device to be uniquely identifiable. Messages sent by the mobile device to b-lock 601 or server 609 can include second security data that enables b-lock 601 or server 609 to verify that the message is from the mobile device of the user. The second security data can be the same as the first security data, can be generated based on the first security data, etc. Once the identity of the mobile device is established via validation of the second security data, and the second security data is validated to be associated with an owner or administrator of b-lock 601, any messages sent from the mobile device can be validated as being from an owner or administrator of b-lock 601.

As a second example, server 609 can have access to a list of owners and/or administrators for b-lock 601. Each user, including each owner and/or administrator, can have an account at server 609, with the user's status as an owner or administrator of b-lock 601 being available via the account profile. When the user logs into the account, server 609 can verify that the user is an owner or administrator of b-lock 601 via the user's account profile.

Once the user is validated to be an owner or administrator, the user can initiate a process to add a new administrator or authorized user. An administrator is able to manage an electronic lock, for example, by adding or deleting authorized users or other administrators. The user can enable a second user to register as an administrator or an authorized user of b-lock 601 by causing server 609 send a message to the second user. For example, the user can use an electronic lock application running on his mobile device to add a second user. The user can enter the email address, mobile phone number, etc. of the second user, and the electronic lock application can send a message that includes a security key to the second user via email, text, etc. The security key can be recognized by b-lock 601 or server 609 as granting administrator or authorized user permissions to the second user. The second user, such as by running an electronic lock application that has access to the security key on his mobile device, or by logging into a website into which the security key can be input, can cause the security key to be sent to b-lock 601 or server 609. B-lock 601 or server 609 can validate the security key and, based on the security key, recognize that the security key grants administrator or authorized used rights to the second user.

At step 765, which is similar to step 710 of FIG. 7A, server 609 can receive the personal data of the second user, and can register the personal data (step 770, which is similar to step 715). At a later time, a third user attempts to unlock b-lock 601. The third user uses a personal data device, which in this example is a biometric scanner, to obtain third personal data, which in this example is the third user's biometric data. The third user uses, for example, biometric data device 607B to obtain third personal data. Biometric data device 607B sends the third personal data to mobile/web application 602B, which in turn sends the third personal data to server 609, where the personal data is received (step 775, which is similar to step 720). At step 780, which is similar to step 725, server 609 compares the third personal data to the personal data of step 770 to determine whether the second user is an administrator or authorized user of b-lock 601. At step 785, which is similar to step 730, server 609 determines that the third user and the user of step 770 are a same user. Based on the validation that the third user is an administrator or authorized user of b-lock 601, which can be communicated to b-lock 601 by server 609 when server 609 accomplishes the validation, b-lock 601 unlocks the locking mechanism of physical lock 608 (step 790, which is similar to step 735).

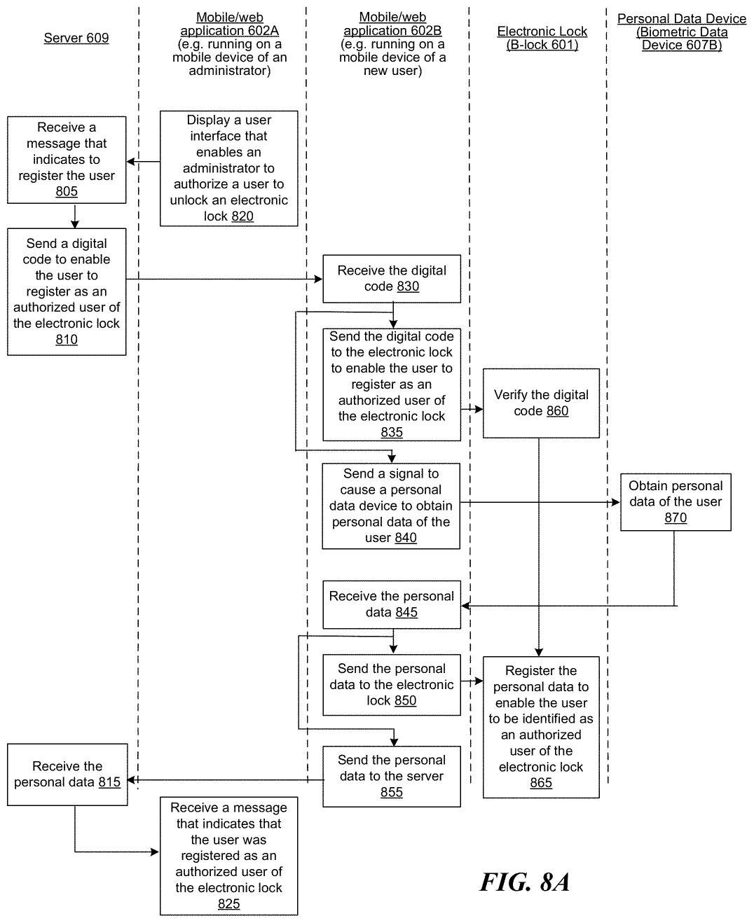

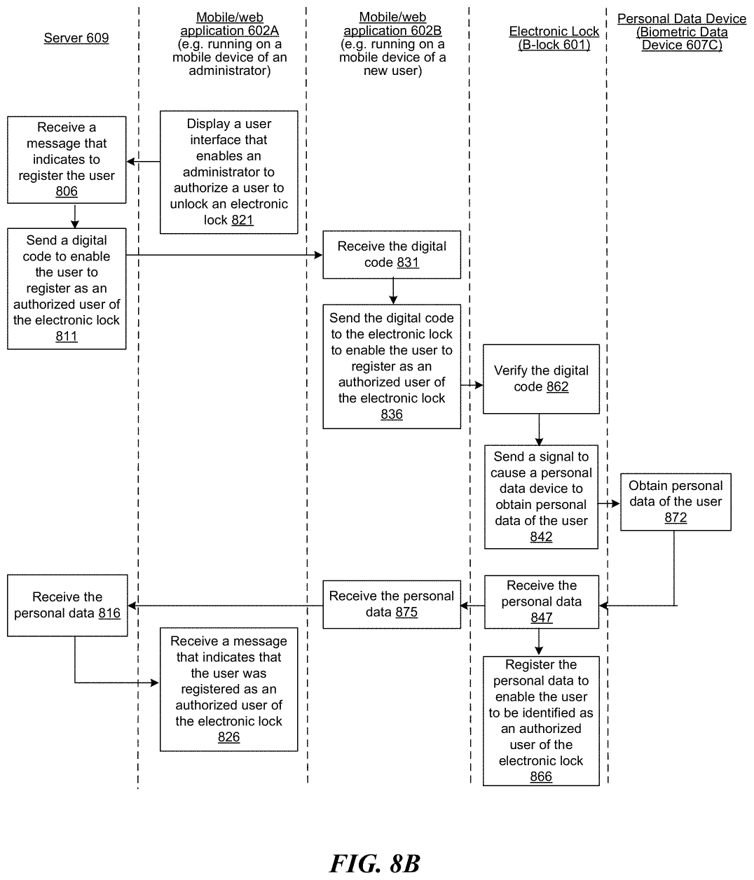

FIG. 8A is an activity diagram illustrating an example process for managing access to a physical property with access controlled by an electronic lock, consistent with various embodiments. The electronic lock of the example of FIG. 8A is b-lock 601. The description of the example process of FIG. 8A will refer to the embodiment and labels of FIG. 6A. Using, for example, the process of FIG. 7A, a user who is a purchaser of an electronic lock can register himself as an owner and/or administrator of the electronic lock. The user can download an electronic lock application, such as mobile/web application 602A, on his mobile device and can execute the electronic lock application. The electronic lock application can display a user interface that enables an administrator, such as the user, to authorize a new user to unlock an electronic lock, such as b-lock 601 (step 820). To authorize the new user to unlock the electronic lock, the new user can be registered as an authorized user. An authorized user is a user that is authorized to unlock or lock an electronic lock during one or more periods of time.

For example, an authorized user can be authorized to lock and/or unlock an electronic lock at any time, Monday through Friday from 9:00 am to 5:00 pm, on the first Monday of every month, today from 4:00 pm to 6:00 pm, at any time between noon today to noon one week from today, etc. Once registered as an authorized user, the authorized user can lock and/or unlock the electronic lock during the period(s) of time that he is authorized to lock and/or unlock the electronic lock.

Being able to grant access to a physical property without having to provide any physical item, such as a physical key, is useful to a variety of people who want to grant access to a physical property. Such an ability can be useful to, for example, a property owner who rents his house using an online lodging website, an apartment dweller who wants to enable a cleaning person to enter his house when a cleaning is scheduled, a car owner who wants to lend his car to his friend for a period of time, etc. In each of these cases, rather than having to deliver a physical key to the renter, cleaning person, or friend, the access granting person can authorize the renter, cleaning person, or friend to be able to lock and unlock the electronic lock during the desired period of time. For example, the property owner can authorize the renter to be able to lock and unlock the electronic lock on the door of the house during the period of time that the renter rents the house. The apartment dweller can authorize the cleaning person to be able to lock and unlock the electronic lock on the door of his apartment during the scheduled cleaning time. The car owner can authorize his friend to be able to lock and unlock the door of the car during the period of time that he has decided to loan the car to his friend. Another embodiment of an electronic lock can be used to enable the friend to be able to start the car during the period of time that the car owner wants to loan the car to the friend.

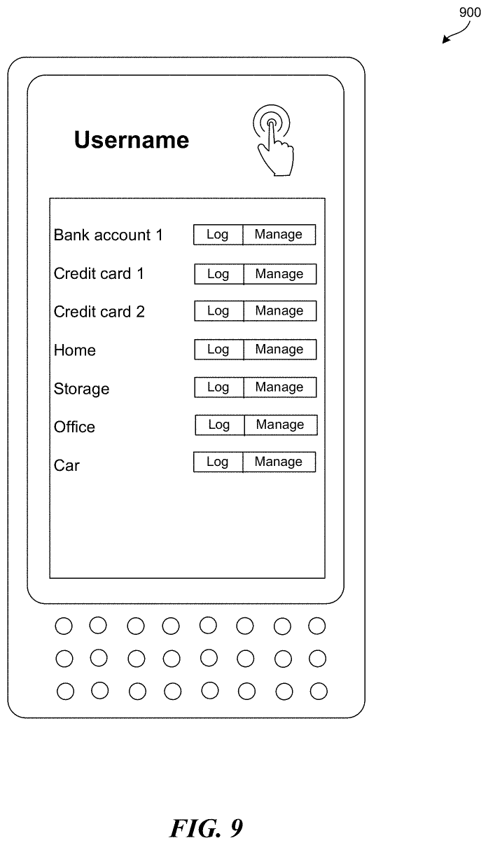

The user can use the user interface to manage access to a physical property or object with access controlled by an electronic lock. Using a user interface of an application, such as interface 900 of FIG. 9 which is a user interface of mobile/web application 602A, a user can manage access to physical properties, such as his home, a storage facility, his office, his car, etc. Interface 900 can be an interface to a resource management platform for managing access to shared resources. To manage access to his home, which in this example has access controlled by b-lock 601, the user can touch the “Manage” icon of user interface 900 that is associated with his home. A second level user interface is displayed to enable the user to input contact information for a new user that he wants to grant access to his home. The user can input, for example, an email address, a phone number of a mobile device, an IP address, etc. of the new user. Mobile/web application 602A sends a message that indicates a request to register the new user as an authorized user of b-lock 601 to a server, such as server 609 (step 805). The message can include contact information of the new user, as well as an indication of one or more periods of time when the new user is authorized to lock and/or unlock b-lock 601.

Server 609 verifies that the message is from an administrator of b-lock 601, and, based on the verification, sends a digital code to the new user to enable the user to register as an authorized user of b-lock 601. The digital code can include, for example, an encrypted security key. The digital code can be sent via an email to the email address of the new user, via a text message to the phone number of the new user, via a message sent to an IP address of the new user, etc. Once the digital code is received by the new user, mobile/web application 602B can obtain the digital code and can obtain the security key (step 830). The new user can be registered as an authorized user of b-lock 601 when, for example, the new user sends the security key to b-lock 601, and b-lock 601 verifies the security key.

Mobile/web application 602B sends a signal to a personal data device, such as biometric data device 607B, to cause biometric data device 607B to obtain personal data of the new user. Biometric data device 607B can be part of or coupled to a mobile device that is running mobile/web application 602B. For example, biometric data device 607B can be an integrated fingerprint scanner of a mobile device that is running mobile/web application 602B, can be a fingerprint scanner that is plugged into a connector, such as a micro-USB or Lightning connector, of a mobile device that is running mobile/web application 602B, etc. In some embodiments, the new user can use biometric data device 607A or biometric data device 607C to obtain personal data of the new user. In response to the signal, biometric data device 607B obtains personal data of the new user, such as by obtaining fingerprint data of the new user (step 870). Biometric data device 607B sends the personal data to mobile/web application 602B, where the personal data is received (step 845).

Mobile/web application 602B sends the digital code to b-lock 601 to enable the new user to register as an authorized user of b-lock 601 (step 835). B-lock 601 validates the digital code, such as by unencrypting the digital code to obtain and validate a security key (step 860). Mobile/web application 602B sends the personal data to b-lock 601 (step 850). Sending the personal data can include sending a representation of the personal data, for example, sending a digital representation of a fingerprint. After verifying the digital code and receiving the personal data, b-lock 601 registers the new user as an authorized user by storing the personal data in storage, such as non-volatile memory (step 865). Storing the personal data enables the new user to be identified as an authorized user by comparing personal data that is received in the future to the stored personal data. Mobile/web application 602B further sends information as to the period or periods when the new user is authorized to lock and/or unlock b-lock 601. B-lock 601 associates the personal data with the received period or periods when the new user is authorized to lock and/or unlock b-lock 601.

In some embodiments, mobile/web application 602B sends the personal data to server 609 (step 855), where the data is received (step 815). Server 609 sends a message to mobile/web application 602A that indicates that the new user was registered as an authorized user of b-lock 601 (step 825). In some embodiments, server 609, rather than b-lock 601, compares received personal data to stored personal data of an authorized user to determine whether the received personal data matches the stored personal data. In some embodiments, server 609 stores personal data of authorized users for one or more electronic locks. If an electronic lock breaks down and needs to be replaced, the new electronic lock can populate data for authorized users by obtaining the personal data and other associated data of the authorized users of the broken electronic lock.

In some embodiments, software updates can be pushed to a device with an application installed, such as a mobile device with mobile/web application 602A or 602B installed. Software updates can further be pushed to a computing device with an application installed, such as a desktop computer with a web application installed. Software updates can additionally be pushed to an electronic lock. For example, server 609 can cause a software update to be applied to a mobile device that is executing mobile/web application 602A, 602B, or can cause an update to be applied to b-lock 601. The software update can be sent to b-lock 601 via a network with which wireless transmitter/receiver 603 can communicate, such as a Wi-Fi network of a physical property for which b-lock 601 is being used to restrict access, or can be sent from any of mobile/web application 602A or 602B to b-lock 601, such as via wireless transmitter/receiver 603, or can be sent via any other compatible way.

FIG. 8B is an activity diagram illustrating a second example process for managing access to a physical property with access controlled by an electronic lock, consistent with various embodiments. The electronic lock of FIG. 8B is b-lock 601. The process of FIG. 8B is similar to the process of FIG. 8A, with one point of difference being that, in some embodiments, a personal data device of an electronic lock is used to obtain personal data of a new user. The description of the example process of FIG. 8B will refer to the embodiment and labels of FIG. 6A. Steps 821, 806, 811, 831, and 836 are, respectively, substantially similar to steps 820, 805, 810, 830, and 835 of FIG. 8A. At step 862, b-lock 601 validates the digital code received at step 836, such as by unencrypting the digital code to obtain a security key and validating the security key. B-lock 601 sends a signal to a personal data device, such as biometric data device 607C, to cause biometric data device 607C to obtain personal data of a new user (step 842). In response to the signal, biometric data device 607C obtains personal data of the new user, such as by obtaining fingerprint data of the new user (step 872). Biometric data device 607C sends the personal data to b-lock 601, where the personal data is received (step 847). B-lock 601 relays the personal data to mobile/web application 602B, where the personal data is received (step 875).

After verifying the digital code and receiving the personal data, b-lock 601 registers the new user as an authorized user, such as by storing the personal data in storage (step 866). Storing the personal data enables the new user to be identified as an authorized user by comparing personal data that is received in the future to the stored personal data. Mobile/web application 602B can further send to b-lock 601 information as to a period or periods when the new user is authorized to lock and/or unlock b-lock 601. B-lock 601 associates the personal data with the received period or periods when the new user is authorized to lock and/or unlock b-lock 601.

In some embodiments, mobile/web application 602B sends the personal data to server 609, where the personal data is received (step 816). Server 609 sends a message to mobile/web application 602A that indicates that the new user was registered as an authorized user of b-lock 601 (step 826).

The administrator or authorized user can approve sharing of information from the first server 504A with the second server 504B. The administrator or authorized user can approve the sharing of information from the second server 504B with the first server 504A. The approved information can include account login credentials, personal data, and resource identifiers. Approved information from the first server 504A can be stored in a database associated with the second server 504B. Approved information from the second server 504B can be stored in a databased associated with the first server 504A. A secure communication protocol can be used for communication between the first server 504A and the second server 504B. For example, secure socket layer (SSL) communication can be used between the two servers. SSL communication can use SSL certificates in a key database file that belongs to each server.

The second server 504B can be a vendor or merchant server and the first server 504A can be a server in communication with the b-lock 601. A user may have an online account with the vendor. The user can store preferences on the vendor website which can include settings to access the remote door management system of the user. The user could also enter his remote door management system credentials each time the user places an order on the vendor website. A user can place or trigger an order via the second server 504B. The order can be a one-time order or an auto recurring order. An auto recurring order could be a subscription to a product. For example, a user could trigger a monthly toothbrush or cat litter order etc. The second server 504B can securely inform the first server 504A that a delivery will be attempted and request an access code to the b-lock 601. The secure information can include a delivery time window and a delivery identifier. A delivery identifier can be a serial number or invoice number. The secure information from the second server 504B to the first server 504A can also include name of the product ordered, the size and weight of the delivery, the mode of delivery and the identifier of the person making the delivery. The mode of the delivery can be bicycle courier, delivery van, lift-gate truck, or roll-back truck. The delivery person identifier information can include a name, employee identification number, a picture, a 3D image, fingerprints, facial features or other biometric identifying information.

The first server 504A can grant or deny the request from the second server 504B for an access code to the b-lock 601 by sending a response message. The response message can be contingent on approval of the administrator or authorized user. The first server 504A can grant access by sending a one-time access code to the second server 504B and sending the access code to the b-lock 601 along with delivery time window. The first server 504A can also send to the b-lock 601 other information including the delivery person's biometric information, and maximum door open period. Door opening in excess of the maximum door open period can trigger an alert. The alert can be sent from the b-lock 601 to the first server 504A and administrator or authorized user via a mobile device or other connected device.

The delivery person can access and open the b-lock 601 when the correct access code is entered within the delivery time window. When the correct access code is entered but not within the delivery time window, the b-lock 601 will not open. The b-lock 601 can be programmed such that after a first successful opening of the b-lock 601 with the access code, subsequent attempts at opening the b-lock 601 within the delivery time window with the access code will fail. The b-lock 601 can also be programmed such that a specified maximum number of openings of the b-lock 601 with the access code within the delivery time window are enabled.

The delivery person can access and open the b-lock 301 when the 3-D facial recognition of the biometric data device 307 matches the 3-D facial biometric data obtained by the b-lock 301 and biometric identifying information sent by the second server 504B to the first server 504A and the 3-D facial recognition match occurs within the delivery time window.

FIG. 9 is an illustration of a user interface for a resource management platform for managing access to shared resources, consistent with various embodiments. As discussed above, in some embodiments, a resource management platform is used to manage access to physical resources, such as homes, offices, cars, etc., that use an electronic lock to restrict access to the physical resource.

In some embodiments, a resource management platform is used to manage access to virtual resources, and in other embodiments, to manage access to both physical resources and virtual resources. A virtual resource can be, for example, a bank account, a credit union account, a checking account, a payment card account (e.g., a credit card account, a debit card account, an automated teller machine (ATM) card account, a gift card account, a stored value card account, etc.), a credit account, etc.

A user can create a profile at the resource management platform, can identify each virtual resource that he desires to share with another person, and can input information that enables the platform to access each virtual resource, such as a login ID and password for each virtual resource. The user can use interface 900 of the resource management platform to manage access to, for example, his home, which in this example has access controlled by an electronic lock, and his credit card account. The user can touch the “Manage” icon of user interface 900 that is associated with a virtual resource, such as his credit card account.

A second level of user interface can be displayed, and the user can identify a new user with whom he wants to share the virtual resource. The user can provide contact information for the new user, such as an email address of the new user, or a phone number or IP address of a computing device of the new user, such as a mobile device of the new user, etc. The resource management platform can send a message to the new user to enable the new user to register with the resource management platform.

The new user can use, for example, his mobile device to obtain personal data, such as biometric data of a biometrically identifiable part of his body, and can send the personal data to the resource management platform, where the platform can store the personal data for future validation of the new user. The user can further identify the resource that he is going to share with the new user, and any access restrictions, such as one or more periods of time that the new user is authorized to utilize the shared resource, or restrictions on his access to the virtual resource, such as being limited to withdraw a maximum amount each day from the user's checking account, or being limited to charge a maximum amount each day using a payment account of the user.

When the new user attempts to access a virtual resource that the user shared with the new user, the resource management platform can send a message to the new user's mobile device that prompts the mobile device to obtain personal data of the new user. The resource management platform can obtain and validate the personal data of the new user. Based on this validation, the resource management platform can use, for example, the stored login ID and password of the virtual resource that the user shared with the new user to enable the new user to obtain access to the virtual resource.

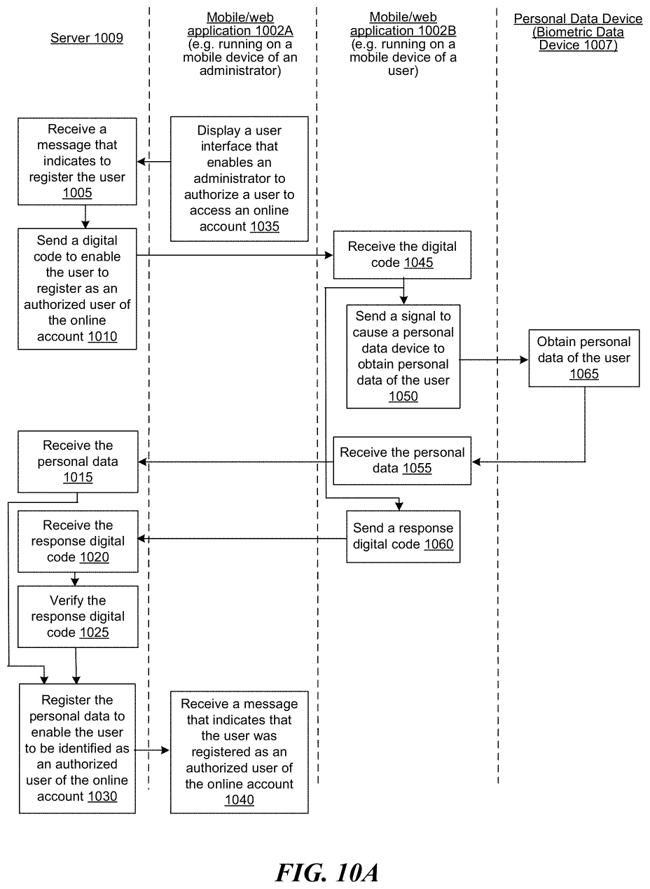

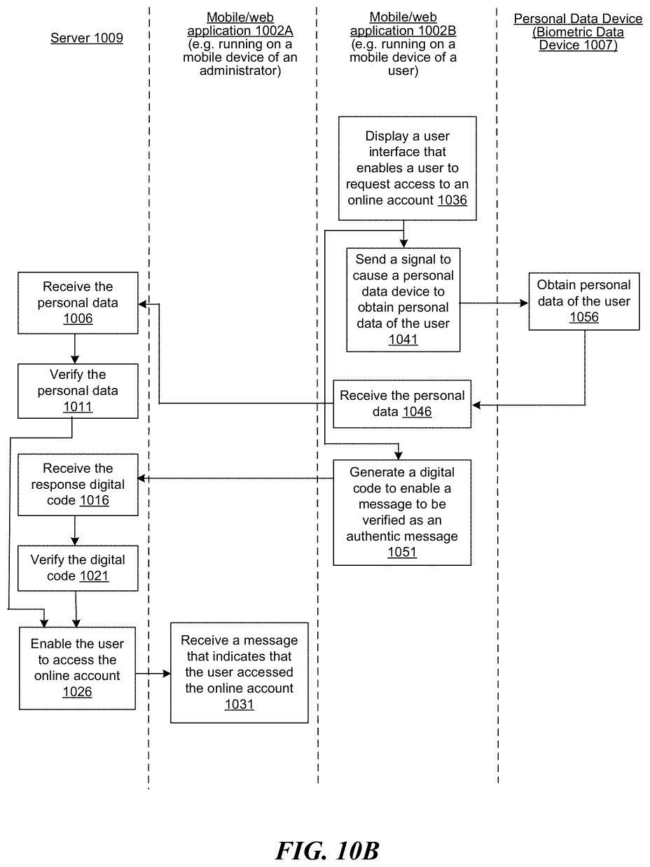

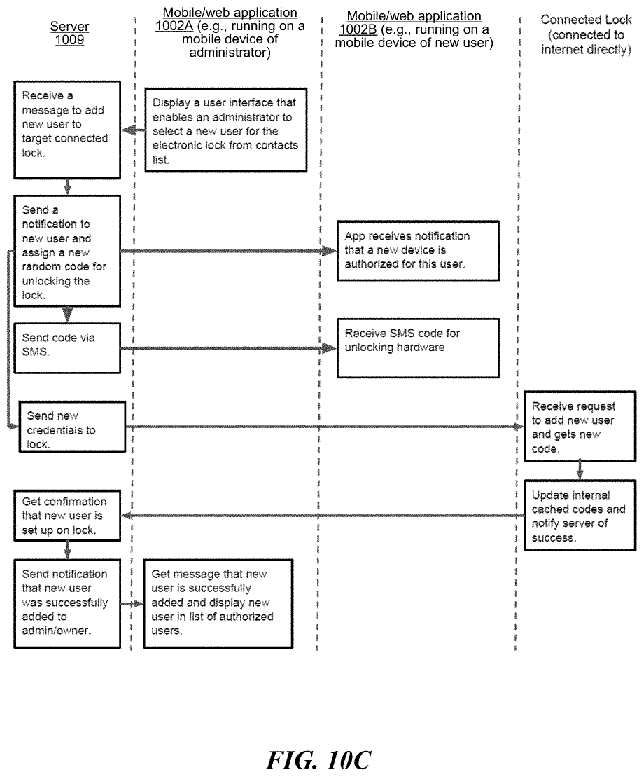

FIG. 10A is an activity diagram illustrating an example process for managing access to a virtual resource, consistent with various embodiments. Steps 1035, 1005, 1010, 1045, 1050, 1065, 1055, and 1015 are, respectively, substantially similar to steps 820, 805, 810, 830, 840, 870, 845, and 815 of FIG. 8A, with one point of difference being that the steps of FIG. 10A that are related to authorizing a user to access an online account are, in the associated step of FIG. 8, related to authorizing a user to access an electronic lock. In some embodiments, server 1009, mobile/web application 1002A, mobile/web application 1002B, and biometric data device 1007 are, respectively, server 609, mobile/web application 602A, mobile/web application 602B, and biometric data device 607B of FIG. 6A.

At step 1060, mobile/web application 1002B sends a response digital code to server 1009. In some embodiments, the response digital code is the same as the digital code received at step 1045. In other embodiments, the response digital code is a security code generated by mobile/web application 1002B based on the digital code received at step 1045. When generated based on the digital code received at step 1045, the response digital code can be verified, such as by server 1009, to be a security code that was generated based the digital code received at step 1045. Mobile/web application 1002B sends the response digital code to server 1009 (step 1060), where the response digital code is received (step 1020). Server 1009 verifies the response digital code (step 1025), such as by verifying that the response digital code is the same as the digital code that was sent to mobile/web application 1002B at step 1010, by verifying that that the response digital code was generated based on the digital code that was sent to mobile/web application 1002B at step 1010, etc.

Upon receipt of the personal data of step 1015, and based on the verification of step 1025 of the response digital code, server 1009 registers the personal data to enable the user to be identified as an authorized user of the online account (step 1030). The personal data can be registered, for example, by storing the personal data in storage that can be accessed by server 1009, and associating the personal data with the user. Registering the personal data enables the user to be identified as an authorized user by comparing personal data that is received in the future to the registered personal data. Server 1009 sends a message that indicates that the user was registered as an authorized user of the online account to mobile/web application 1002A, where the message is received (step 1040).

FIG. 10B is an activity diagram illustrating an example process for enabling access to a virtual resource, consistent with various embodiments. Steps 1041, 1056, 1046, and 1006 are, respectively, substantially similar to steps 1050, 1065, 1055, and 1015 of FIG. 10A. At step 1036, mobile/web application 1002B displays a user interface that enables a user to request access to a shared online account, such as an online account of another person. The user can identify a particular online account in any of various ways. For example, the user can indicate the online account he wants to access by selecting a particular online account from a list of online accounts for which he has registered as an authorized user. As a second example, the user can input identifying information for the account, such as a website and user name that can be used to access the account.

Mobile/web application 1002B generates a digital code (step 1051). The digital code can enable a message, such as a message that indicates a request to access an online account, to be verified as being authentic. The digital code of step 1051 can be generated based on, e.g., the digital code received at step 1045. Mobile/web application 1002B sends the digital code to server 1009, where the digital code is received (step 1016). At step 1011, server 1009 verifies the personal data received at step 1006. The personal data can be verified by comparing the personal data against reference personal data for the user, such as by comparing the personal data to personal data that was stored in association with step 1030. At step 1021, server 1009 verifies the digital code received at step 1016.

Upon verification of the personal data and the digital code, server 1009 enables the user to access the online account (step 1026). For example, server 1009 can act as an intermediary between mobile/web application 1002B and a server that hosts the online account, for example, an online account server. Server 1009 can use the online account owner's login ID and password to login to the online account server. The user, via mobile/web application 1002B, can request certain actions for the online account, such as obtaining an account balance, transferring money between the online account and an account of the user, etc. Server 1009, acting as an intermediary, can cause the requested actions to happen and can report the result of the action back to mobile/web application 1002B. Server 1009 can send a message to mobile/web application 1002A to notify the administrator of the online account that the user accessed the online account (step 1031).

FIG. 10C is an activity diagram illustrating an example process for an administrator to enable a new user with access to the electronic lock. As a first step, mobile/web application 1002A can display a user interface that can enable an administrator to select a new user for the electronic lock. The administrator can identify a particular user, for example, by selecting a new user for the electronic lock from a contacts list stored in memory of any of the servers, inputting identifying information for the user, such as a username, email address, and phone number that can be used to access the account, or combinations thereof.

Mobile/web application 1002A can send a message that indicates a request to register the new user as an authorized user of b-lock 601 to a server, such as server 1009. The server 1009 can be in a cloud system. The message can include the mobile phone number of the new user, as well as an indication of one or more periods of time when the new user is authorized to lock and/or unlock b-lock 601.

Server 1009 can verify that the message is from an administrator of b-lock 601. Based on the verification, the server 1009 can send a digital code to the mobile/web application 1002B. The server 1009 can send the digital code to a mobile device, server, and/or other computer of the new user to enable the new user to register as an authorized user of b-lock 601. The server 1009 can send the digital code via SMS or text message to the mobile device, server, and/or other computer of the new user.

The server 1009 can send the credentials of the new user and the digital code to the b-lock 601. After verifying the digital code and receiving the credentials, b-lock 601 can register the new user as an authorized user by storing the credentials and digital code in storage, such as non-volatile memory. Storing the credentials and digital code enables the new user to be identified as an authorized user by comparing credentials and digital codes that are received in the future to the stored data. A confirmation that the can then be sent from the b-lock 601 to the server 1009.

The server 1009 can send information to the b-lock 601 and/or mobile/web application 1002A including the time period or time periods when the new user is authorized to lock and/or unlock b-lock 601. B-lock 601 can associate the credentials with the received period or periods when the new user is authorized to lock and/or unlock b-lock 601.

Once the server 1009 receives the confirmation from the b-lock 601, the server 1009 can send a notification to the mobile/web application 1002A informing the administrator that the new user was successfully added.

The web/application 1002A can display the new user as an authorized user of b-lock 601 when, the mobile/web application 1002A receives the notification from the server 1009 that the new user was successfully added.

The server 1009 can store credentials and digital codes of authorized users for one or more electronic locks. If an electronic lock breaks and needs to be replaced, the new electronic lock can populate data for authorized users by obtaining the credentials and digital codes of the authorized users of the broken electronic lock.

Software updates can be downloaded (pushed) to a device with an application installed, such as a mobile device with mobile/web application 1002A or 1002B installed. Software updates can be pushed to a computing device with an application installed, such as a desktop computer with a web application installed. Software updates can be pushed to the electronic lock. For example, server 1009 can cause a software update to be applied to a mobile device that is executing mobile/web application 1002A, 1002B, or can cause an update to be applied to b-lock 601. The software update can be sent to b-lock 601 via a network with which wireless transmitter/receiver 603 can communicate, such as a Wi-Fi network of a physical property for which b-lock 601 is being used to restrict access, or can be sent from any of mobile/web application 1002A or 1002B to b-lock 601, such as via wireless transmitter/receiver 603, or can be sent via any other compatible way. The lock 601 can be connected directly to the internet (e.g., not via a LAN).

The lock can receive a request to add a new user and get a new code for the new user from the server or the lock can create the new code itself.

The lock can update internal cached user codes to and/or from the server and notify the server of the update success.

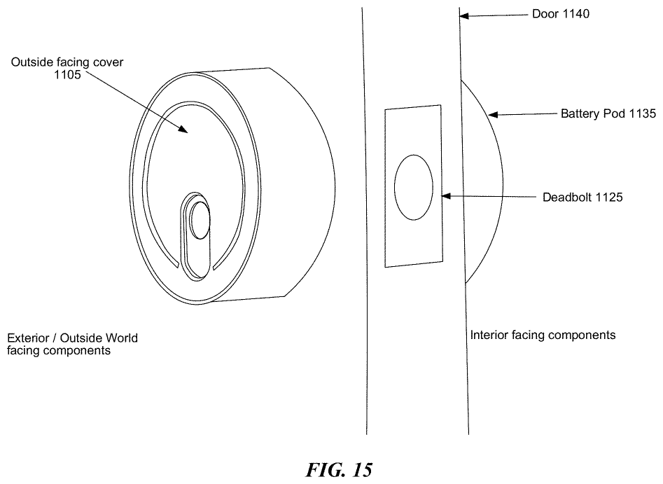

FIG. 11 is an exploded view illustrating the relationship of various components of an electronic lock, consistent with various embodiments. The electronic lock of the embodiment of FIG. 11 is a b-lock. B-lock 1100, which in the example of FIG. 11 is mounted in door 1140, includes outside facing cover 1105, circuit board housing 1110, sensors 1115, motor assembly 1120, deadbolt 1125, rotating base 1130, and battery pod 1135. B-lock 1100 can be used to lock, for example, an exterior door of a house. As is illustrated in FIG. 15, the components on one side of door 1140, such as outside facing cover 1105, face the outside world. The components on the other side of door 1140, such as battery pod 1135, face the interior of the house.

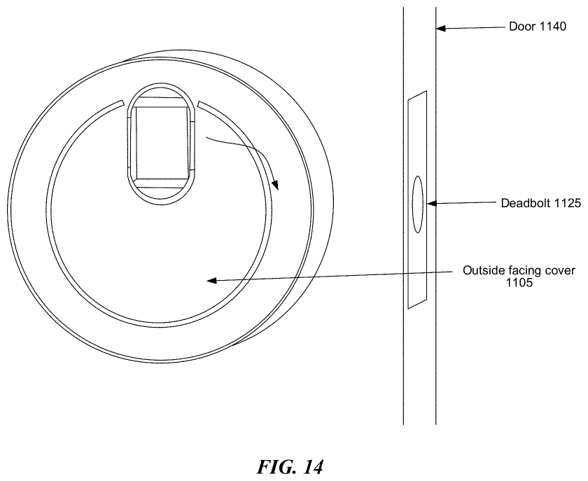

As is shown in FIG. 14, outside facing cover 1105 can be rotated. For example, as is illustrated in FIG. 12, outside facing cover 1105 can be rotated to a first position that exposes lock cylinder/keyhole 1205. While in the first position, a user can insert a physical key into lock cylinder/keyhole 1205, and can turn the key in a first direction to extend deadbolt 1125 and lock door 1140, or can turn the key in a second direction to retract deadbolt 1125 and unlock door 1140.

The user can further rotate outside facing cover 1105 to expose one or more other components of b-lock 1100. For example, in FIG. 13 the user has rotated outside facing cover 1105 to a second position that exposes fingerprint scanner 1305. Fingerprint scanner 1305 is a device that can obtain personal data, such as a user's fingerprint data, that can be used to identify a finger of a user. While in this second position, the user can place his finger on fingerprint scanner 1305. B-lock 1100, such as via fingerprint scanner 1305, can obtain the user's fingerprint data. If b-lock 1100 verifies that the user's fingerprint data matches fingerprint data of an authorized user of b-lock 1100, b-lock 1100 can determine, such as via a processor coupled to circuit board housing 1110, to lock or unlock b-lock 1100.

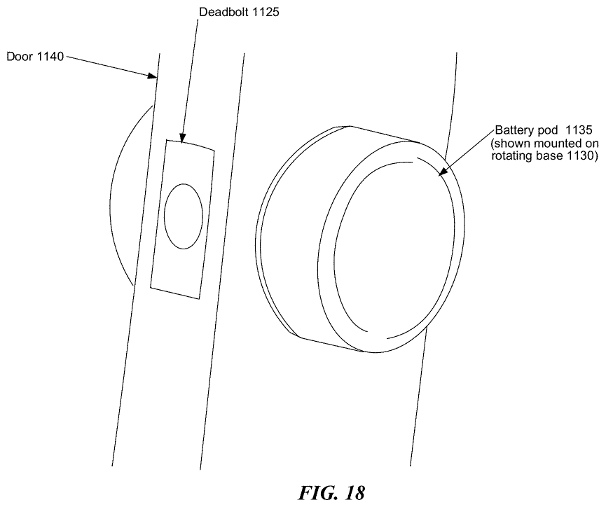

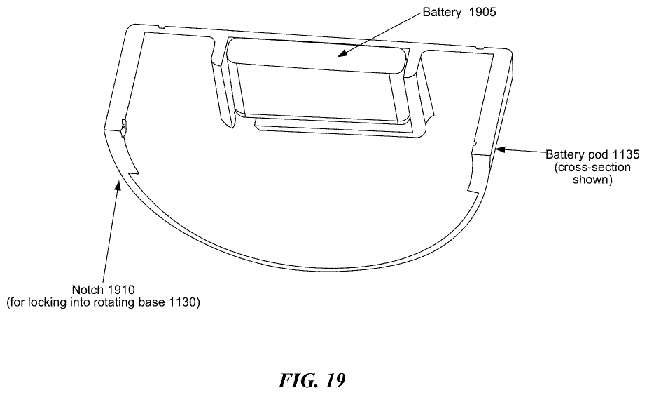

In various embodiments, outside facing cover 1105 can be rotated to expose any of various components. For example, outside facing cover 1105 can be rotated to expose a charging port (not pictured). The charging port can be any of various types of connectors. For example, the charging port can be compatible with an industry standard connector, such as a USB connector, a micro-USB connector, a Lightning connector, etc., can be a custom or proprietary connector, can be a puzzle connector, etc. The charging port can be used to charge a battery of b-lock 1100. For example, in a situation where the user does not have a physical key that he can insert in lock cylinder/keyhole 1205 to unlock b-lock 1100, the user may need to rely upon being able to unlock b-lock 1100 based on a biometric scan of his finger. If a battery of b-lock 1100 were discharged, the user may not be able to unlock b-lock 1100 using his finger. For example, if battery 1905 of FIG. 19 were discharged, motor assembly 1120 may not be able to obtain enough power from battery 1905 to provide sufficient mechanical force to move deadbolt 1125.

In a situation where b-lock 1100 is not able to unlock door 1140 due to battery 1905 being discharged, the user can rotate outside facing cover 1105 to expose a charging port, for example, a micro-USB port that can be used to charge battery 1905 and/or to substantially immediately power b-lock 1100. The user can use, e.g., a micro-USB cable connected to a power source to recharge battery 1905 and/or to substantially immediately power b-lock 1100. The user can connect the USB connector of the micro-USB cable to a power source, such as a USB port of a laptop computer, a USB port of a portable battery pack, etc. The user can connect the micro-USB connector of the micro-USB cable to the exposed micro-USB port of b-lock 1100. Once the connections are made, electrical current can flow from the power source to battery 1905 and can recharge battery 1905, and/or can flow to the various components of b-lock 1100, such as to the components inside circuit board housing 1110, to the components of sensors 1115, and to the components of motor assembly 1120.

In embodiments where the charging port immediately or substantially immediately powers b-lock 1100, the user can immediately or substantially immediately use his finger to cause b-lock 1100 to unlock door 1140. In embodiments where the charging port can be used to charge battery 1905, but not to additionally power b-lock 1100, once battery 1905 is sufficiently recharged, the user can use his finger to cause b-lock 1100 to unlock door 1140.

In some embodiments, the charging port has only a direct connection to the charging circuits and there is no data connection to the digital components of b-lock 1100, such as to microcontroller 304, 604, or 2004. By isolating the charging port from the data connections of digital components of b-lock 1100, security is increased by isolating the digital components and associated software from tampering via the charging port.

Circuit board housing 1110 is a housing that includes a circuit board, such as a circuit board that includes a processing system of b-lock 1100. The processing system can include, for example, micro-controller 304 and wireless transmitter/receiver 303 of FIG. 3, micro-controller 604 and wireless transmitter/receiver 603 of FIG. 6A, or processing system 2000 of FIG. 20, among other components. Sensors 1115 can include any of various sensors, such as a camera, a microphone, an audio sensor, an accelerometer, a pressure sensor, a location sensor, a global positioning system (GPS) sensor, a temperature sensor, a humidity sensor, a magnetic field sensor, an electric field sensor, a light sensor, an infrared light sensor, or a proximity sensor, among other sensors.

Motor assembly 1120 is a motor assembly that provides mechanical force to extend and retract deadbolt 1125. For example, when a user's identity has been validated based on personal data of the user and b-lock 1100 determines to unlock door 1140, motor assembly 1120 can retract deadbolt 1125 to unlock the door.

Rotating base 1130 is a base that can be manually rotated to lock or unlock deadbolt 1125. Battery pod 1135 can be mounted on or otherwise mechanically coupled to rotating base 1130, as is illustrated in FIGS. 16 and 18. Notch 1910 of FIG. 19 can be used to mechanically couple battery pod 1135 to rotating base 1130, such as by locking battery pod 1135 to rotating base 1140, as is illustrated in FIG. 18. As is illustrated in FIG. 15, battery pod 1135 and rotating base 1130, on which battery pod 1135 is mounted, are interior facing components. To open door 1140 from the inside of, for example, a house that includes door 1140, a user can rotate rotating base 1130 by grabbing and rotating battery pod 1135, which is mechanically coupled to rotating base 1130. Battery pod 1135 can provide force to rotate rotating base 1130.

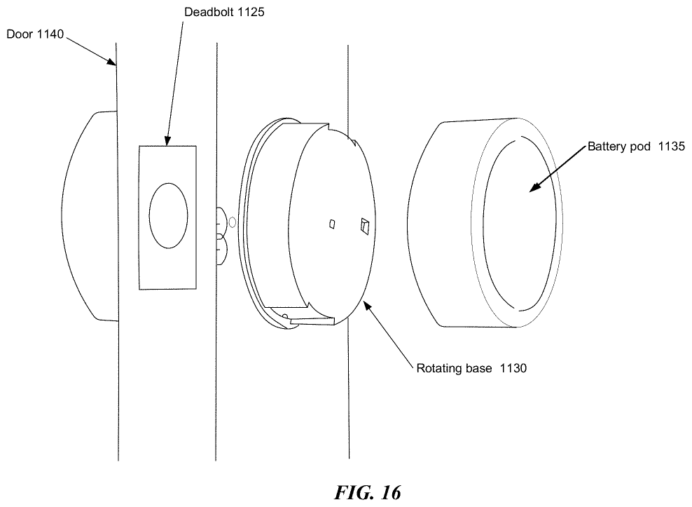

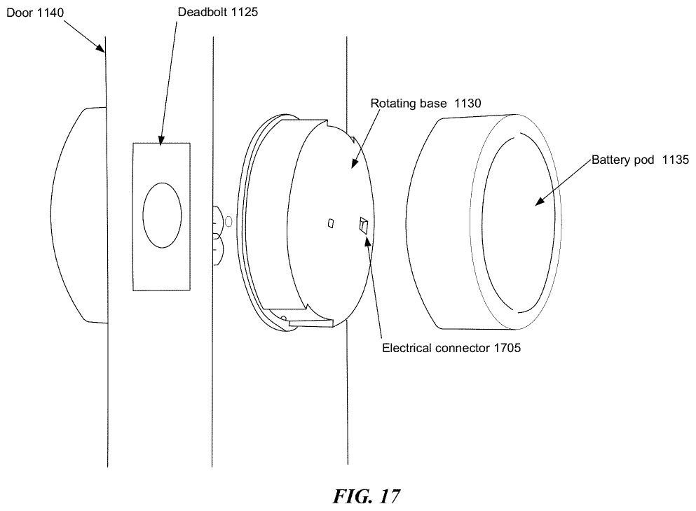

Battery pod 1135 is a battery pod for holding batteries. Battery 1905 of battery pod 1135 can be electrically connected to b-lock 1100, for example, by a wire that connects battery 1905 with an electrical connector, such as electrical connector 1705 of FIG. 17. A battery that powers b-lock 1100, such as battery 1905, can be any type of battery, such as a rechargeable battery, a non-rechargeable battery, etc. FIG. 19 shows a cross section of battery pod 1135, and shows the placement of battery 1905 inside of battery pod 1135. A user can detach battery pod 1135 from rotating base 1130, and can remove battery 1905, which can be a single battery or multiple batteries. The user can replace battery 1905 with a new battery or, when battery 1905 is a rechargeable battery, can remove battery 1905 to recharge the battery. In some embodiments, battery pod 1135 includes a charging port, similar to the charging port discussed above, that enables a user to recharge battery 1905 from, for example, the inside of a house for which b-lock 1100 is being used to restrict access.

FIG. 20 is a high-level block diagram showing internal electronics of an electronic lock, consistent with various embodiments. The electronic lock can be a door management platform, such as the door management platform of FIG. 21. The embodiment of FIG. 20 includes b-lock 2001, mobile/web application 2002, wireless transmitter/receiver 2003, micro-controller (MCU) 2004, power source 2005, mechanical motor 2006, biometric authentication device 2007, physical lock 2008, server 2009, output device 2010, input device 2011, charge connector 2012, external power source 2013, and sensor 2014.

The embodiment of FIG. 20 can be broken into a grouping of sub-components that incorporates the standard structure of conventional door locks with moving parts to lock/unlock the door. The door can be any door, such as a door on a building, a door on a car, a door on a safe, a door on a cabinet, etc. Rather than solely relying on physical keys to actuate physical lock 2008, which can be e.g. deadbolt 1125 of FIG. 11, b-lock 2001 includes mechanical motor 2006, which can be a DC motor. Microcontroller (MCU) 2004 can control mechanical motor 2006 and can cause mechanical motor 2006 to open or close physical lock 2008. Mechanical motor 2006 can have associated gears in order to generate the required torque to move physical lock 2008. MCU 2004 can have a local memory that stores any of digital keys, biometric information, access details, logs of user interactions, or associated usage timestamps. MCU 2004 can keep a record of owner or administrator information.

In some embodiments, b-lock 2001 has a single registered owner and has multiple administrators. When a user requests for access via the biometric authentication device 2007, which can be fingerprint scanner 1305 of FIG. 13, the request can be sent to MCU 2004, which is inside b-lock 2001. MCU 2004 can compare the data received from biometric authentication device 2007 to the registered personal data in local memory. If a match is found, the data is deemed valid and MCU 2004 signals mechanical motor 2006 to actuate physical lock 2008 to open the door.

When output device 2010 is a speaker, MCU 2004 can also send a signal to the speaker to cause the speaker to emit a sound indicating a successful authentication. When a match is not found, the data is deemed not valid and MCU 2004 can send a signal to the speaker to cause the speaker to emit a sound indicating an unsuccessful authentication attempt. The speaker can additionally or alternately be used for a variety of purposes. For example, MCU 2004 can send a signal to the speaker that causes the speaker to emit any of various sounds based on any of various occurrences, conditions, etc. The speaker can emit various sounds to indicate, e.g., that the b-lock was successfully locked or unlocked, or that a security mode of the b-lock has been activated, such as via the user's mobile device or a web site, or that valid or invalid biometric data was received by the b-lock, or that a valid or invalid unique identifier was received by the b-lock, etc. Examples of security modes include that the b-lock is locked or unlocked, that the b-lock is set or not set to emit an alarm via output device 2010, etc.

Output device 2010 can be any of various output devices that enable information to be communicated to a user. For example, output device 2010 can be a speaker, a light emitting diode (LED) or other light source, an LED display, a liquid crystal display (LCD), etc.

Input device 2011 can be any of various input devices that enable a user to communicate information to b-lock 2001. For example, input device 2011 can be a keypad, a camera, a microphone, etc. A user can use the keypad to input a password, passphrase, etc. When input device 2011 is a camera, the camera can recognize the face or some other identifiable body part of a user, can recognize physical gestures that a user uses for communication, etc. When input device 2011 is a microphone, a user can speak commands, passwords, pass phrases, etc., which the microphone can receive, and which speech or voice recognition can be used to understand the words spoken, identify the user, etc.

Power source 2005 can operate based on a battery energy source, a wired power outlet, etc. For example, power source 2005 can be based on a rechargeable battery. Charge connector 2012 can be charge connector 2135 of FIG. 21, and can be used to charge a rechargeable battery of b-lock 2001, to provide power to b-lock 2001, etc. For example, a user can plug one end of a USB to micro-USB cable into an external power source 2013, such as a portable battery pack, a portable computing device, etc., and can plug the other end of the cable into charge connector 2012. External power source 2013 can provide power to charge a rechargeable battery that is part of power source 2005, to directly power the electronics of b-lock 2001, etc.

The lock and unlock status of b-lock 2001 can be presented to the users via output device 2010, such as by a distinctive sound emitted from a speaker, a specific color or flashing pattern of an LED, an icon or message displayed by an LCD, etc. The capability to manually lock and unlock the gate from inside can be maintained through a knob, such as battery pod 1135 of FIG. 11 mounted on rotating base 1130. Users can also use a physical key to lock or unlock b-lock 2001 from the outside, such as by inserting a key into lock cylinder 1205 of FIG. 12.

MCU 2004 can maintain logs of all entries and exits and can transfer the information to a mobile app via wireless communication facilitated by wireless transmitter/receiver 2003 (e.g. Bluetooth, Bluetooth Low Energy (BLE), Wi-Fi, etc.). In the event that a user opens the door with a physical key, this event can be logged and shared with the lock owner. The logs of the door opening and closing through the use of physical key can inform the owner of events such as unauthorized access into a space (e.g. a burglary). A sensing function to determine when physical lock 2008 is manually opened or closed can be implemented by tracking the DC motor output signal change as the bolt of physical lock 2008 is manually actuated. Alternatively, a sensor in b-lock 2001, such as sensor 2014, which can be a capacitive/optical sensor, can track the opening and closing of physical lock 2008.

An electronic lock, such as b-lock 2001, can be equipped with other sensors, such as sensor 2014, which can track vibrations, temperature, etc. Sensor 2014 can be sensors 1115 of FIG. 11, and can include any of various sensors, such as a camera, a microphone, an audio sensor, an accelerometer, a pressure sensor, a location sensor, a global positioning system (GPS) sensor, a temperature sensor, a humidity sensor, a magnetic field sensor, an electric field sensor, a light sensor, an infrared light sensor, or a proximity sensor, among other sensors.

The biometric authentication device 2007 consists of a biometric sensor (e.g. fingerprint, iris, facial pattern, etc.) that collects data from a user. Biometric authentication device 2007 can communicate with both b-lock 2001 and the mobile/web application 2002, which can be on a mobile device of the user, via wires or a wireless communication standard. Biometric authentication device 2007 can capture the user's biometric data and compare the data to the database of users with access to that specific gate. The database of biometric data can reside locally on the MCU 2004 or on server 2009, which can be a cloud server. If the user has access to the gate at that time, b-lock 2001 would unlock the gate/door.

Mobile/web application 2002 helps owners and/or administrators of the gate system to organize and manage access to a protected resource. The log information can help inform the owners/administrators how the resource is accessed. Examples of a protected resource utilizing access control can include: the entrance to a house or door of a car. Access control can also be applied to objects which have lock mechanisms such as a computers or vehicles. The owner and/or administrators of each b-lock can grant access to other individuals for any period of time via the mobile/web application.

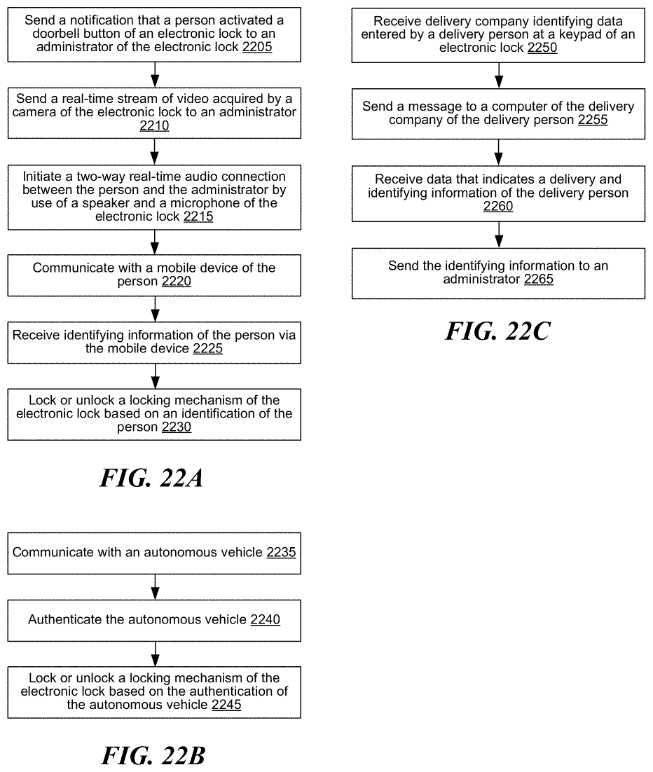

FIGS. 22A-C are flow diagrams illustrating examples of processes to manage access to an area protected by a door management platform, consistent with various embodiments. The processes of FIGS. 22A-C will be explained in conjunction with the door management platform of FIG. 21, which is an illustration of an outside face of a door management platform that includes a keypad and a doorbell, consistent with various embodiments.

The door management platform of the embodiment of FIG. 21, door management platform 2100, includes camera 2105, doorbell button 2110, keypad 2115, microphone 2020, lock cylinder 2125, speaker 2130, and charge connector 2035. Output device 2010 of FIG. 20 can include speaker 2130. Input device 2011 of FIG. 20 can include any of camera 2105, doorbell button 2110, keypad 2115, or microphone 2120, among others. Sensor 2014 of FIG. 20 can include any of camera 2105, doorbell button 2110, keypad 2115, or microphone 2120, among others. Door management platform 2100 can be an electronic lock.

In some embodiments, keypad 2115 is a virtual keypad displayed by a touchscreen display and doorbell button 2110 is a virtual button displayed by the touchscreen display. In some embodiments, door management platform 2100 includes a capacitive sensor to detect a touch of a button of the keypad. In some embodiments, door management platform 2100 includes a force sensor to detect a touch of a button of the keypad. In some embodiments, keypad 2115 is a mechanical keypad.

A door management platform, such as door management platform 2100, can enable a person, such as an administrator of the door management platform, to remotely manage access to an area that is protected by the door management platform. For example, when a door management platform is installed on an entrance door of a home or business, the door management platform can enable a person, such as an administrator of the door management platform, to remotely manage access to the inside of the home or business by use of a mobile device or other connected device, such as a computer.

The area that is protected by the door management platform can be, for example, the inside of an object where access to the inside of the object is restricted by an apparatus, such as door, gate, lid, drawer, etc., that can be secured in a closed position, and in which the door management platform is installed. As another example, the area can be a fenced in area to which access is restricted by a gate a) that is part of a fence that bounds a portion of the fenced in area, and b) in which the door management platform is installed. The object can be a house, building, automotive vehicle, airplane, safe, container, cabinet, etc. The door management platform can protect the area by locking the apparatus, the gate, etc. in a closed position, thereby restricting access to the area.

In addition to enabling delivery of packages, groceries, merchandise, etc. inside a home, business, or other area that is protected by a door where access is managed by a door management platform, the door management platform can enable service people, such as a cable repair person, a house keeper, a dog walker, etc., to enter the house/business/etc. to provide their service.

In some embodiments, a door management platform has an applications programming interface (API) that enables developers to create applications that interface with the platform. For example, a delivery service company can develop an application that can communicate with a door management platform. The communication can be via any of various communication standards and protocols, such as via a short distance wireless communication standard, examples of which include Bluetooth and Bluetooth low energy, via a local area wireless network, examples of which include a Wi-Fi network and an Institute of Electrical and Electronics Engineers (IEEE) 802.11 network, via a cellular network, examples of which include 3G, 4G, Long Term Evolution (LTE), etc.

An application developed by, e.g., a delivery service company can enable a mobile device of a delivery service person to communicate with a door management platform. The mobile device can send identifying information for the delivery person and other information to the platform, which can relay the identifying information to, for example, the home owner that owns the home protected by the door management platform. The identifying information can include, e.g., a photo of the person, the person's name, employee badge number, etc. The mobile device can further send information or data that enables the recipient device to verify that the information is from the delivery service company. With the identifying information verified to be from the delivery service company, and with a visual verification of the delivery person via a camera of the door management platform, the home owner can be confident of the identity and authenticity of the delivery person. The mobile device can further send additional information, such as a tracking number of the delivery, the contents of the delivery, etc.

Companies other than delivery service companies can also develop applications that communicate with the door management platform. For example, a house cleaning company, a dog walking service, etc. can develop an application that runs on a mobile device of a cleaning person, dog walker, etc. When the cleaning person, dog walker, etc. arrives at a home, the mobile device can communicate with the door management platform and send a bill for the cost of the service (e.g., the house cleaning service, the dog walking service) to the platform, which the platform relays to the home owner. The home owner can use his smartphone to pay for the service, which the platform can relay to the mobile device of the person providing the service. As a second example, a mobile device of a cable repair person can communicate with the door management platform, and can provide, for example, an estimated duration for the repair, and can provide updates as the repair progresses.

In one example, a grocery delivery person is to deliver groceries to a house, and approaches a door protected by a door management platform, such as door 2140 that is protected by door management platform 2100. The grocery delivery person uses his mobile device to communicate with platform 2100, and the platform sends a message to the home owner's smartphone notifying him of the grocery delivery. The platform sends one or more photos of the house or instructions that enable the grocery delivery person to correctly identify the door.

For example, when the door is on the side of the house, the door management platform can send a series of photos, a video, written instructions, recorded instructions, etc., that direct the grocery delivery person to the door on the side of the house. The mobile device of the delivery person, or a computer of the delivery service company, can send, via the mobile device of the delivery person or via the Internet, a photo of the delivery person to the door management platform (step 2225). When the photo is sent to the door management platform, the platform can relay the photo to the home owner.

The home owner initiates a live video stream from camera 2105 to his smartphone (step 2210), and, in some embodiments, uses the photo of the delivery person to verify the identity of the delivery person. The owner can use his smartphone to send a message to the door management platform that causes the door management platform to lock or unlock a locking mechanism of the door management platform. This enables the delivery person to open the door/gate/etc. in which the door management platform is installed, and to deliver the goods to the area that is protected by the door management platform.

In some cases, a delivery is being made by a delivery person that does not have a mobile device. The delivery person presses doorbell button 2110. The door management platform sends a message that the delivery person activated the doorbell button to the home owner (step 2205).

In some cases, the delivery person enters data at keypad 2115. The data can be information that identifies the delivery service for which the delivery person is making the delivery. An electronic lock company that sells electronic lock 2100 can maintain a database that enables a delivery company, as well as other types of companies or entities, to register with the electronic lock company. The database can be stored at cloud storage provided by a cloud storage service and can be stored at a computer of the electronic lock company, etc. The electronic lock company can assign the delivery company a unique code that can be used to identify the company, and can similarly assign unique codes to other registered companies/entities.

The database can include the unique code and contact information for the delivery company, as well as secure communication information that enables a computer of or associated with the electronic lock company to securely communicate with a computer of the delivery company. The secure communication information can include, for example, an IP address, URL, etc. of or associated with a computer of the delivery company. The database can further contain registration information of purchasers of electronic locks. For example, the database can include contact information for a person, company, etc. that purchased an electronic lock, along with an address where the electronic lock is installed.

The data entered at keypad 2115 can include the unique code for the delivery company for which the delivery person is making a delivery. Electronic lock 2100 can send the code to a computer of the electronic lock company, where the code is received (step 2250). The electronic lock computer can, based on the unique code, determine the delivery company and, based on the secure communication information, send a secure message to a computer of the delivery company (step 2255). The message can enable the computer of the electronic lock company to verify whether the delivery company has a delivery scheduled at the address where electronic lock 2100 is installed for that day and time.

For example, the message can include commands or information that cause or trigger a query of a database of the delivery service company. The query can determine whether a delivery is scheduled at that time/date at the address where the electronic lock is installed. The electronic lock company computer can receive information that indicates a delivery (step 2260) from the delivery company computer, such as results of the database query, a message confirming that a delivery is scheduled at that time/date, etc. The delivery company computer can further send identifying information of the delivery person. In some embodiments, the data that indicates that a delivery is scheduled is the identifying information. The electronic lock company computer can send the identifying information to the home owner (step 2265). The home owner can be the person to whom the electronic lock is registered (e.g., the owner). In some embodiments, the electronic lock is administered by an administrator, who can be a person authorized by the home owner to administer the electronic lock.

The home owner, based on the notification of step 2205, the video of step 2210, or the message of step 2265, can use his smartphone to initiate a two way audio link between the smartphone and the door management platform by use of microphone 2120 and speaker 2130 (step 2215). This enables the home owner and the delivery person to have a real-time two way conversation. The home owner can identify the delivery person based on the identifying information of step 2225 or step 2265. The home owner asks the delivery person to open the door and deliver the groceries inside the door, and uses his smartphone to send a message to platform 2100 that causes platform 2100 to unlock the door (step 2230). Once the door unlocks, the delivery person opens the door and places the groceries inside the door. As the delivery is happening, camera 2105 can continue to stream live video and the home owner can monitor the grocery delivery person to make sure he doesn't do anything inappropriate.

Once the delivery is complete, the home owner uses his smartphone to electronically capture his signature acknowledging delivery of the groceries. In some embodiments, the smartphone sends the electronically captured signature to door management platform 2100, which relays the signature data to the mobile device of the grocery delivery person. In some embodiments, the smartphone sends the electronically captured signature to a computer of the grocery delivery company for record storage.

When the home owner gets home, he can unlock door management platform 2100 in any of several ways. For example, he can insert a key in lock cylinder 2125 to unlock the platform, he can type in a security code using keypad 2115, he can use his smartphone to unlock the platform, etc. In some embodiments, door management platform 2100 is a biometric lock, and the home owner can unlock door management platform 2100 upon verification of his biometric data.

In some embodiments, door management platform 2100 includes facial recognition functionality. In one example, a person approaches door management platform 2100, and camera 2105 captures an image of the face of the person. The facial recognition functionality recognizes the face as being a face of an authorized user (e.g., a user who is authorized to unlock the door management platform), and unlocks the door management platform to enabled the authorized user to open the door.

In some embodiments, door management platform 2100 includes speech recognition functionality. In one example, a person approaches door management platform 2100, and microphone 2120 captures audio of the person's voice. The speech recognition functionality recognizes the voice as being a voice of an authorized user, and unlocks the door management platform to enable the authorized user to open the door.

In some embodiments, a door management platform is able to communicate with an autonomous vehicle (step 2235). In one example, an autonomous vehicle is delivering an item to a home owner at the home owner's home. The autonomous vehicle communicates with the door management platform, and the door management platform authenticates the autonomous vehicle (step 2240). For example, the door management platform verifies that the autonomous vehicle is a vehicle of a delivery service, and that the autonomous vehicle is making a delivery to the home of the home owner. In response to the authentication, the door management platform unlocks the locking mechanism to enable the autonomous vehicle to deliver the item inside the doorway of the home (step 2245).

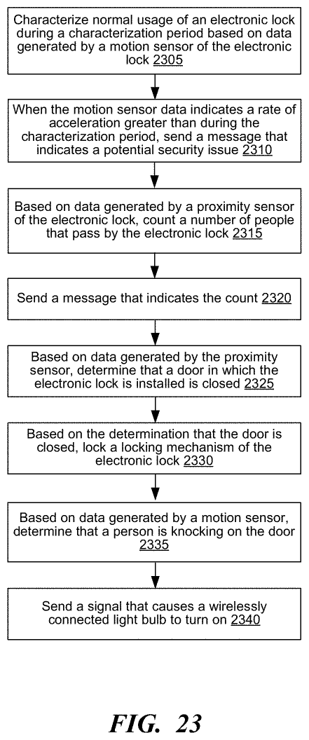

FIG. 23 is a flow diagram illustrating example processes where an electronic lock takes security-related actions based on security-related sensor data, consistent with various embodiments. The process of FIG. 23 can be executed by an electronic lock, such as b-lock 101A of FIG. 1A, b-lock 101B of FIG. 1B, b-lock 301 of FIG. 3, b-lock 601 of FIG. 6A, b-lock 1100 of FIG. 11, b-lock 2001 of FIG. 20, door management platform 2100 of FIG. 21, etc.

Some embodiments of an electronic lock have a sensor. For example, b-lock 1100 of FIG. 11 includes sensors 1115 and b-lock 2001 includes sensor 2104. A sensor is a device that responds to a physical stimulus and transmits a resulting signal. Examples of physical stimuli include heat, light, sound, pressure, magnetism, an electric field, or motion, among others. A signal from a sensor can be used to determine a measure of a physical stimulus, such as the temperate of the environment of the sensor, the intensity, wavelength, etc. of light, the volume, pitch, etc. of a sound, a measure of the pressure, a measure of the strength, direction, etc. of a magnetic or electric field, a proximity of an object/person/etc. to the sensor, an acceleration of the sensor, a particular location of the sensor, vibrations, etc.

An electronic lock can take an action based on sensor data of a sensor of the electronic lock. Sensor data can be, for example, the signal that is transmitted by a sensor as the sensor responds to a physical stimulus. In some embodiments, an electronic lock takes a security-related action based on security-related data of a sensor of the electronic lock. Security-related sensor data or a security-related action is data or an action related to controlling or restricting access to an area protected by the electronic lock. An example of an area that is protected by an electronic lock is the inside of an object whose access is controlled or restricted by an apparatus, such as door, gate, lid, drawer, etc., that can be secured and locked in a closed position by an electronic lock that is coupled to the apparatus. The object can be a house, building, automotive vehicle, airplane, safe, container, cabinet, etc. The electronic lock can protect the area, e.g., by locking the apparatus in a closed position, thereby restricting access to the area.

A second example of an area that is protected by an electronic lock is a fenced in area to which access is restricted by a gate that is part of a fence that bounds a portion of the fenced in area, and that can be secured and locked in a closed position by an electronic lock that is coupled to the gate.

In some embodiments, the sensor is a motion sensor and the security-related sensor data is data from the motion sensor. The motion sensor data is security-related because it can indicate motion of a door/gate/etc. to which the electronic lock is coupled, and motion of the door/gate/etc. can indicate that the door/gate/etc. is being opened to allow access to an area to which access is restricted by the door/gate/etc., that a person is attempting to break through the door/gate/etc., that a person is knocking on the door/gate/etc., etc.

In an example, a motion sensor of an electronic lock transmits motion sensor data to a processor of the electronic lock during a characterization period during which motion of a door/gate/etc. to which the electronic lock is coupled is deemed to be normal/typical. The electronic lock, or a computer with which the electronic lock can communicate, analyzes and characterizes the motion sensor data from the characterization period (step 2305). The characterization can include, for example, determining a maximum rate of acceleration, a maximum speed of movement, a range of motion, etc.

After the characterization period, the electronic lock or the computer determine that motion sensor data indicates a possible security-related issue. For example, the motion sensor data can indicate an acceleration that is more than a pre-determined amount above a maximum rate of acceleration observed during the characterization period, which can indicate that a person may be trying to break through the door, that a physical altercation may be happening resulting in the door being slammed, etc. When the motion sensor data indicates a possible security-related issue, such as an acceleration more than a pre-determined amount above a maximum rate of acceleration observed during the characterization period, the electronic lock or the computer can send a message that indicates a possible security-related issue (step 2310). The message can be sent to an owner or administrator of the electronic lock, to a third-party, such as a security company, to the police, etc. The pre-determined amount can be zero or any other value.

In some embodiments, the sensor is a proximity sensor and the security-related sensor data is data from the proximity sensor. The proximity sensor data is security-related because it can indicate that a person is near a door and may attempt to break through the door that a door is in a closed or open position based on the proximity to a door frame in which the door is installed, etc.

In an example, a proximity sensor is able to detect when a door/gate/etc. that includes an electronic lock is open, and is able to detect when people pass by the door/gate/etc. and into or out of an area that is protected by the electronic lock. The electronic lock or a computer with which the electronic lock can communicate are able to use proximity sensor data to count the number of people that pass by the electronic lock (step 2315). The electronic lock or the computer can further maintain a count of the people that pass by the electronic lock to enter or exit the protected area, and can maintain a count of the people that are in the protected area. The electronic lock or the computer can send a message to an owner or administrator of the lock to a third party that indicates any of these counts (step 2320).

In another example, the electronic lock or the computer is able to detect when a door/gate/etc. is closed based on the proximity sensor data (step 2325). For example, when an electronic lock is coupled to a door, the electronic lock or the computer can determine, based on the proximity data that the door is adjacent to a door frame in which a door is installed. The electronic lock can further determine the position of a locking mechanism of the electronic lock, and can determine if the locking mechanism is locked or unlocked. When the door is closed and the locking mechanism is unlocked, the electronic lock can lock the locking mechanism (step 2330), such that the door is locked in a closed position where it restricts entry into an area that is protected by the electronic lock.

In some embodiments, the sensor is a motion sensor or a microphone. The motion sensor data and the microphone data are security-related because either can indicate that someone is knocking on the door. When the sensor is a motion sensor, a processor of the electronic lock or a computer with which the electronic lock can communicated can determine, based on the motion sensor data that a person is knocking on the door (step 2335). When the sensor is a microphone, the processor or computer can determine based on microphone data that indicates sounds that are indicative of someone knocking on the door that a person is knocking on the door. Based on a determination that a person is knocking on the door, the electronic lock or the computer can send a signal to a wirelessly connected light bulb that causes the light bulb to illuminate an area near the electronic lock (step 2340). For example, the light bulb can illuminate the area in front of the door and can illuminate an area inside of the house that contains the door, etc.

An electronic lock can take any of various security-related actions based on security-related sensor data. For example, when a proximity sensor of the electronic lock indicates that a person is within a predetermined distance of the sensor, the electronic lock can initiate a video stream to an administrator/owner of the electronic lock using a camera of the electronic lock, can initiate an audio stream to the administrator/owner using a microphone and/or speaker of the electronic lock, etc. The administrator/owner can use the video stream to see what is going on near the door, and can use a two-way audio stream to talk to a person that is near the electronic lock.

In another example, when security-related sensor data indicates a possible security-related issue, the electronic lock or a computer with which the electronic lock can communicate can cause a signal to be sent to a speaker of the electronic lock, to cause the speaker to emit an alarm sound. In yet another example, when security-related sensor data indicates a possible security-related issue, the electronic lock or the computer can cause a signal to be sent that causes a camera of the electronic lock to begin recording or taking images, for example, to capture an image or video of a burglar who is attempting to break into an area protected by the electronic lock.

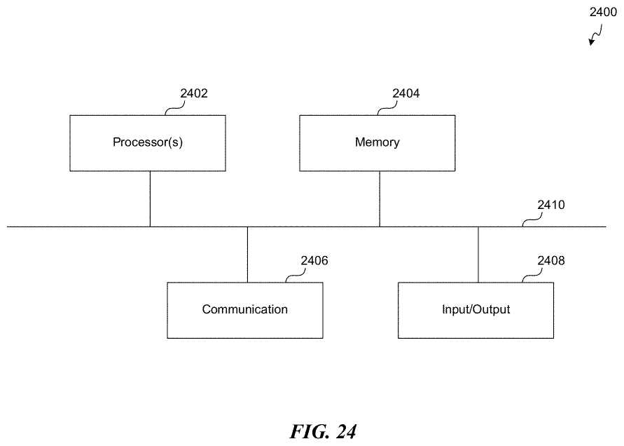

FIG. 24 is a high-level block diagram showing a processing system, consistent with various embodiments, in which at least some operations related to the disclosed technology can be implemented. The embodiment of FIG. 24 can represent, for example, b-lock 101A or 101B, b-lock 201, b-lock 301, wireless transmitter/receiver 303, micro controller 304, biometric data device 307, b-lock 501, b-lock 601, wireless transmitter/receiver 603, micro controller 604, biometric data device 607A, 607B, or 607C, server 609, the computing device on which mobile/web application 302, 602A, or 602B is executed, server 1009, the computing device on which mobile/web application 1002A or 1002B is executed, biometric data device 1007, b-lock 1100, b-lock 2001, microcontroller 2004, wireless transmitter/receiver 2003, biometric data device 2007, server 2009, the computing device on which mobile/web application 2002 is executed, or door management platform 2100, among others. Any of these processing systems may include two or more processing devices such as represented in FIG. 24, which may be coupled to each other via a network or multiple networks. A network can be referred to as a communication network.

In the illustrated embodiment, the processing system 2400 includes one or more processors 2402, memory 2404, a communication device 2406, and one or more input/output (I/O) devices 2408, all coupled to each other through an interconnect 2410. In some embodiments, each device is a module in a device that includes the module, as well as other modules. The interconnect 2410 may be or include one or more conductive traces, buses, point-to-point connections, controllers, adapters and/or other conventional connection devices. Each processor 2402 may be or include, for example, one or more general-purpose programmable microprocessors or microprocessor cores, microcontrollers, application specific integrated circuits (ASICs), programmable gate arrays, or the like, or a combination of such devices. The processor(s) 2402 control the overall operation of the processing device 2400. Memory 2404 may be or include one or more physical storage devices, which may be in the form of random access memory (RAM), read-only memory (ROM) (which may be erasable and programmable), flash memory, miniature hard disk drive, or other suitable type of storage device, or a combination of such devices. Memory 2404 may store data and instructions that configure the processor(s) 2402 to execute operations in accordance with the techniques described above. The communication device 2406 may be or include, for example, an Ethernet adapter, cable modem, Wi-Fi adapter, cellular transceiver, Bluetooth transceiver, or the like, or a combination thereof. Depending on the specific nature and purpose of the processing device 2400, the I/O devices 2408 can include devices such as a display (which may be a touch screen display), audio speaker, keyboard, mouse or other pointing device, microphone, camera, etc.

### Third Party Delivery

Consumers (e.g., users that have locking devices, people who are purchasing goods to be delivered to and/or services to be rendered on-site—e.g., at the home of—for people who have a locking device) can place online orders via websites or mobile apps for goods or services from vendors using vendor software that is integrated with the locking device software. The goods or services can be delivered by the vendor through the doorway that has the locking device. For example, vendors can have websites (inclusive of apps) hosted on vendor servers (e.g., the second server 504B) that can communicate with the door management platform (e.g., the locking device), a device server (e.g., the first server 504A), a user's mobile device, or any combination thereof. The website can have a button configured to trigger one or more events that allows for the purchased good or service to be delivered though the doorway that has the locking device, and/or the recipient's address can be identified in a database (e.g., on the first and/or second server) as having a locking device and eligible to receive the goods and/or services through the locking device. For example, the vendor button can be a “buy” button or a “delivery” button on a vendor website (e.g., a “buy now with Gate delivery” button, or more generally, a “lock device delivery” button). The website can recognize users that have door management platforms installed on a door, users can register their locking device with one or more vendors, vendors and the locking device company can share data so that the vendor can offer locking device delivery options to users who have locking devices, or any combination thereof.

When the locking device purchase and/or delivery button is selected by a purchaser, the website (e.g., via the second server) can prompt the purchaser for a password associated with the locking device and/or can associate the purchaser's account with a locking device. The first server can auto-generate a random password associate with the locking device specifically linked (i.e., associated or correlated with) the goods or services purchases. The example, the auto-generated password can be temporary and expire as soon as delivery of the goods or services is confirmed or a fixed time (e.g., 2 minutes) following the delivery of the goods or services. The password can act as the access code for the locking device, and/or the password can be sent to the first server at the time of delivery (e.g., by the delivery person's mobile device) with an instruction to create a short-term access code for the locking device that will expire after a single (or limited multiple—e.g., double) use and/or time (e.g., within 3 minutes).

When the locking device purchase and/or delivery button is selected by a purchaser, (1) a verified order can be created on the vendor server 504B, (2) the vendor server 504B can communicate with the device server 504A to set up an access code and one or more delivery identifications (e.g., delivery time, delivery person, package tracking number), or any combination thereof, (3) the locking device can confirm the access code and/or one or more of the delivery identifications when the delivery arrives to allow the delivery person to enter the space locked by the locking device, (4) information from the locking device can be sent to the device server 504A and/or to the vendor server 504B to confirm delivery and/or to share information available about the delivery (e.g., delivery time, delivery person, video of the delivery, audio of the delivery), or any combination thereof.

When the goods or services are delivered to/through a door management platform, the locking device, the first server 504A, the second server 504B, a delivery computer (e.g., a mobile device of a delivery person), or any combination thereof, can generate a signal configured to activate the camera 2105 to record video of the delivery (the camera is activated when the delivery person presses the access code or send a signal via server that they are at the door), for example, from the vantage point of the locking device. As another example, the generated signal can be configured to activate one or more cameras associated with the locking device but not physically integrated with the locking device, such as mounted remotely from the locking device on a nearby wall, window sill, pole and/or eaves.

The video of the delivery can be sent to the first server and/or the second server directly by the locking device and/or by the first server. The first server and/or second server can send the video to be shown in a third party application, for example, on a website on a vendor's computer and/or the user's computer, on an application on the vendor's and/or the user's mobile device, or any combination thereof. The video can be shown in the third party application to indicate receipt of the delivery.

For example, the user having a door management platform can schedule a service with a vendor, for example, an in-home cleaning or maid service with a cleaning company. The user can schedule the service with the vendor with a vendor application. The user can choose a “check-in” option via a mobile device app for controlling their locking device and/or through a third-party vendor (e.g., the cleaning company) application, for example, “check-in via Gate,” or more generally, “check-in via a locking device.”

The backend of the locking device company (e.g., the first server 504A) can provide access to the delivery person (e.g., the cleaner of the cleaning company) via a one-time access code or any of the other access methods disclosed herein. When the cleaner enters the home, the camera 2105 on the locking device and/or one or more other cameras associated with the locking device can record a video clip of the cleaning person entering the space locked by the locking device. The video clip can be sent to and accessible and viewable in the vendor application on the user's mobile device and/or the consumer's mobile device or computer as a receipt of the vendor's service or delivery of goods to the customer/locking device user.

The camera 2105 and/or one or more other cameras associated with the locking device can automatically record video when the locking device is in an unlocked configuration, when the door having the locking device is partially or fully ajar, when the locking device is in an unlocked configuration as a result of access via a vendor (e.g., from a vendor passcode, from delivery person biometric data), or any combination thereof.

Cameras not physically integrated with the locking device can be in wired or wireless communication with the locking device, the first server 504A, the second server 504B, or any combination thereof. Cameras not physically integrated with the locking device can be mounted on a non-door or a non-door frame surface, for example, a wall, ceiling, or a floor. Cameras not physically integrated with the locking device can be integrated with a roving unit configured to follow a delivery person through the house. The roving unit can have wheels or other transportation mechanism such as tracks. One or more cameras can be placed in one or more of the rooms (e.g., all of the rooms) of the building on which the door management platform is installed. The cameras can be turned on all at once or can be sequentially turned on as the delivery person triggers a motion sensor associated with each of the cameras. In this way, one or more cameras (e.g., camera 2105) can record video of package or service delivery. The camera 2105 can be a multi-module camera, for example, a dual module camera. The camera 2105 can rotate to keep a delivery person in the field of view or to otherwise maximize the time in which the delivery person is in the field of view when the door is open, opening, closed, closing, or any combination thereof.

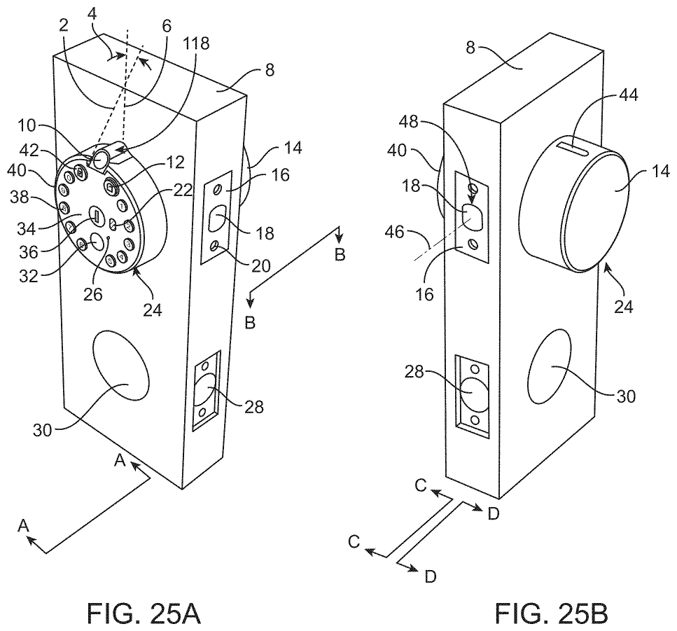

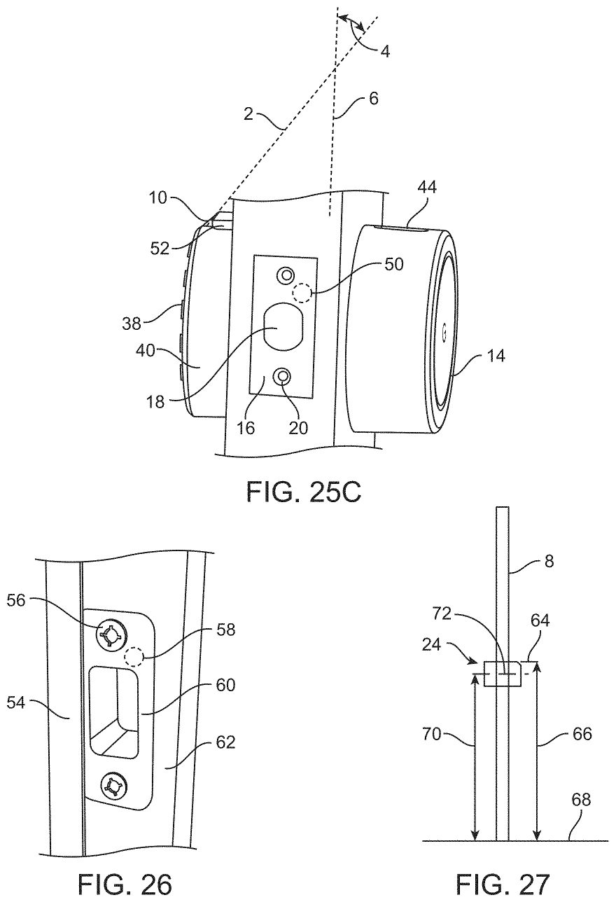

FIGS. 25A through 25C illustrate that a locking device 24 can be mounted in a door 8. The door 8 can be, for example, a rotating hinged door. The locking device 24 can be used to lock and unlock the door 8. The locking device 24 can be activated to lock or unlock from a remote signal triggering a motor in the locking device 24 and/or by manually turning or pressing on a control element on the locking device 24. The locking device 24 can sense the status of the lock and the position of the door 8 and report the status of the lock and the position of the door 8 to a local processor in the locking device 24 and/or a remote processor located over a wired or wireless network away from the locking device 24. For example, this data can be sent to a mobile device, such as a smartphone, and trigger the display of a notification and be fully or partially displayed in a mobile software app.

The locking device 24 can have a lock front enclosure 40 or front case. The lock front enclosure 40 can be fixed to the door 8. The rear surface of the lock front enclosure 40 can be in contact and flush with the front surface of the door 8.

The lock front enclosure 40 can have one or more buttons or switches extending through the lock front enclosure 40. For example, the lock front enclosure 40 can have a lock button 42. When depressed, the lock button 42 can send a signal to the electronics of the locking device 24 to lock the door 8. For example, the lock button 42 can activate a motor that can rotate a deadbolt 48 in the locking device 24 into a locked position.

The locking device 24 can have a camera 118. In some instances, the camera 118 can be the same or similar to the camera 2105 previously described. The camera 118 can be in a camera housing 52 or extension. The camera housing 52 or extension can extend from the top of the remainder of the lock front enclosure 40. The camera 118 can have a camera face 10. The camera face 10 or lens can be flush with, extend out of, or otherwise be visible through the lock front enclosure 40. The camera 118 can pan, tilt and zoom within a camera enclosure such as within a frame or enclosure inside of the camera housing 52 or extension.

The door 8 can have a door vertical axis 6. The camera face 10 can have a camera face axis 2, for example along a plane coinciding with the camera face 10.

A camera face angle 4 can be the angle at which the camera face axis 2 and the door vertical axis 6 intersect. The camera face angle 4 can be angled upward, for example from about 10° to about 60° from horizontal, more narrowly from about 30° to about 40°, for example about 35°.

The field of view (FOV) angle of the camera 118 can be from about 130° to about 170° horizontally, for example about 150° horizontally, and from about 120° to about 110° vertically. The camera 118 can have an image sensor sensitive to visible light, infrared light, ultraviolet light, or a combination thereof.

The camera 118 can face toward an interior of a space accessible via the door (also referred to as an interior space), toward an exterior of the space (also referred to as an exterior space), or both. For example, the camera 118 can face toward the exterior space when the door is closed and can face toward the interior space, less toward the exterior space, or both when the door is open. As another example, when the door is closed the camera FOV can include the exterior space and when the door is open the camera FOV can include the exterior space, the interior space, or both.

One or more numerical keys 38 or code buttons on a keypad can extend through the lock front enclosure 40. For example, the locking device 24 can have ten numerical keypad buttons, from 0 through 9, radially arranged around the front face of the locking front enclosure. As another example, the numerical keypad buttons can have a non-radial arrangement on the front face of the locking front enclosure, for example, a rectangular or circular array. The code buttons can be used, for example, to enter lock codes to unlock the deadbolt 48. The buttons on the keypad can be illuminated and/or be made from a glow-in-the-dark material.

The locking device 24 can have a button for a doorbell 12 extending through the lock front enclosure 40.

The locking device 24 can have a keyway 36 or key slot exposed through the lock front enclosure 40. During use a key can be inserted into the keyway 36 to unlock the door 8, for example as with a pin tumbler lock. The key can be a metal key, a key shaped as a credit card, or any other type of key. The key can be a mechanical key, a non-mechanical key, or both. For example, the key can be a pin tumbler key, a magnetic key, an RFID key, or any combination thereof.

The locking device 24 can have a single microphone or microphone array, for example a first microphone 34 and a second microphone 26. The microphones in the microphone array can be symmetrically located on opposite lateral sides of the front of the lock front enclosure 40, for example, below the keyway 36. The microphone array can produce multiple input audio signals to use with noise cancellation and/or echo cancellation algorithms. The microphones can be behind and against microphone ports that can extend through the lock front enclosure. The microphones can be positioned on a side of the locking device facing an interior of a space accessible via the door, on a side facing an exterior of the space, or both. For example, the microphones can face toward the exterior space when the door is closed and can face toward the interior space, less toward the exterior space, or both when the door is open.

The locking device 24 can have one or more speakers. The speakers can be behind and against one or more corresponding speaker grills 22 extending through the lock front enclosure 40. Speaker grills 22 can be symmetrically positioned on opposite lateral sides of the keyway 36.

The locking device 24 can have a motion sensor, such as an infrared (IR) motion sensor. The motion sensor can have a motion sensor face through which to receive input signals. The motion sensor face can extend through the lock front enclosure 40.

The locking device can have an air quality sensor, such as a smoke detector, a humidity sensor, a carbon monoxide sensor, or any combination thereof. The air quality sensor can be positioned on a side of the locking device facing an interior of a space accessible via the door, on a side facing an exterior of the space, or both. For example, the air quality sensor can face toward the exterior space when the door is closed and can face toward the interior space, less toward the exterior space, or both when the door is open.

The locking device 24 can have a face plate 16 attached to the lateral side of the door. The face plate 16 can have one or more door mounting screw holes 20, for example along a mid-line symmetrically at the top and bottom of the face plate 16. Door mounting screws can be inserted through the door mounting screw holes 20 to fix the face plate 16 and locking device 24 to the door 8.

The locking device 24 can have a deadbolt 48. The deadbolt 48 can have a deadbolt distal end 18. The deadbolt distal end 18 can be coplanar with the lateral side of the door 8 when the deadbolt 48 is in an unlocked position. The deadbolt 48 can have a deadbolt longitudinal axis 46.

The locking device 24 can have a back cover or battery pack 14. The battery pack 14 can be attached to and removed from the remainder of the locking device 24 without the use of tools. The battery pack 14 can have an angle indicator 44 and/or grip. The angle indicator 44 or grip can have an indentation, a texturing (e.g., knurling), a ridge, or combinations thereof, along a radially outer surface of the battery pack 14.

The battery pack 14, shell or pod can house a rechargeable (e.g., Li-ion) battery 90. The battery pack 14 can be removed from the remainder of the locking device 24. The battery 90 can then be charged from an external power source. Then the battery back can be reattached to the remainder of the locking device 24. The battery 90 can deliver electrical power to the remainder of the locking device 24. The battery pack 14 can be attached to the remainder of the locking device 24 through corresponding magnets 58 and/or geometric features, such as ridges, snaps, clasps, hooks, or combinations thereof, in or on the battery pack 14 and/or the remainder of the locking device 24.

The door 8 can have a handle lock bore hole 30 and a handle latch port 28 extending laterally from the handle lock bore hole 30 through the lateral side of the door 8. A door handle with a latch and a secondary lock can be attached to the door 8 through the handle lock bore hole 30 and the handle latch port 28.

The face plate 16 can have one or more magnets 58 and/or magnetic sensors 50 or magnetometers 214 (as shown). The magnetic sensor 50 or magnetometer 214 can be connected to one or more microprocessors in the locking device 24 to deliver data regarding the strength of detected magnetic fields 212. The magnet 58 can be a permanent magnet and/or an electromagnet connected to one or more microprocessors in the locking device 24 to activate and create specific strength and/or a specific frequency.

FIG. 26 illustrates that a strike plate 60 can be mounted into a door jamb 62 adjacent to a door stop 54. The strike plate 60 can be attached to the door jamb 62 with jamb mounting screws 56 driven through the door mounting screw holes 20. The strike plate 60 can have one or more magnets 58 (as shown), sensors 50 (e.g., one or more magnetic sensors, light sensors, distance sensors), magnetometers 214, or any combination thereof. The magnet 58 and/or sensors 50 can be positioned to align longitudinally coaxially with corresponding sensors and/or magnets in the face plate 16 when the door 8 is closed, for example the door 8 being pressed against the door stop 54. Corresponding magnets 58 and/or sensors 50 can also be attached to or integrated with the deadbolt 48. The magnets and/or sensors in the deadbolt 48 can detect the magnet in the strike plate 60 and/or be detected by the sensor in the strike plate 60 to indicate that the deadbolt 48 has been sufficiently extended to lock the door. For example, the magnets and/or magnetic sensors in the deadbolt 48 can detect the magnet in the strike plate 60 and/or be detected by the magnetic sensor in the strike plate 60 to indicate that the deadbolt 48 has been sufficiently extended to lock the door. The magnets and/or sensors can determine whether the door is open or closed, for example by determining whether the magnets and sensors are aligned, misaligned, or both. For example, the magnets and/or magnetic sensors can determine whether the door is open or closed, for example by determining whether the magnets and magnetic sensors are aligned, misaligned, or both.

The strike plate, deadbolt, and/or faceplate can include one or more magnetic sensors, light sensors, distance sensors which can detect whether the door is open or closed, or any combination thereof (each represented as sensor 50 in FIG. 26). For example, the locking device can indicate that the door is partially or fully open when a light sensor detects light and can indicate that the door is closed when the light sensor does not detect light. When the door is closed, the door, door frame, door stop, door jamb, strike, locking device, or any combination thereof, can block light from the light sensor. When the door is ajar, the light sensor can detect light. The light sensor can detect visible light, non-visible light, or both. For example, the light sensor can detect visible light, infrared light, ultraviolet light, or a combination thereof. As another example, the locking device can indicate that the door is partially or fully open when the light sensor detects light above a threshold light intensity and can indicate that the door is closed when the light sensor detects light at or below the threshold light intensity. As yet another example, the locking device can indicate that the door is closed when the distance sensor detects a first distance between the locking device and the door jamb, strike plate, end of the deadbolt channel, or any combination thereof, and can indicate that the door is partially or fully open when the distance sensor detects a second distance between the locking device and the door jamb, strike plate, end of the deadbolt channel, or any combination thereof. The second distance can be greater than the first distance, for example, by about 0.25 inches to about 36.00 inches or more.

The strike plate and/or face plate can include a motor to close the door if the door is detected to be open. As another example, one or more door hinges of the door can have a motor that can be actuated by the locking device 24 or a remote user to close the door if the door is detected to be open.

The strike plate can include electronics to charge the battery of the locking device. For example, the strike plate can include a transmitter coil for a wireless charging system and the deadbolt can include a receiver coil. When the door is closed, current in the transmitter coil can inductively generate current in the receiver coil to charge the battery of the locking device. The strike plate can additionally or alternatively include electrical contacts (e.g., spring-loaded pins) that press against corresponding contacts on the deadbolt when the door is closed and supply electricity to charge the battery 8.

FIG. 27 illustrates that the lock longitudinal axis 72 can be at a lock height 70 from the floor 68 when the locking device 24 is mounted in the door 8. The lock height 70 can be from about 3 ft. to about 3 ft., more narrowly from about 40 in. to about 45 in.

The camera 118 can have a camera horizontal axis 64. The camera horizontal axis 64 can be at a camera height 66 from the floor 68. The camera height 66 can be from about 42 in. to about 47 in.

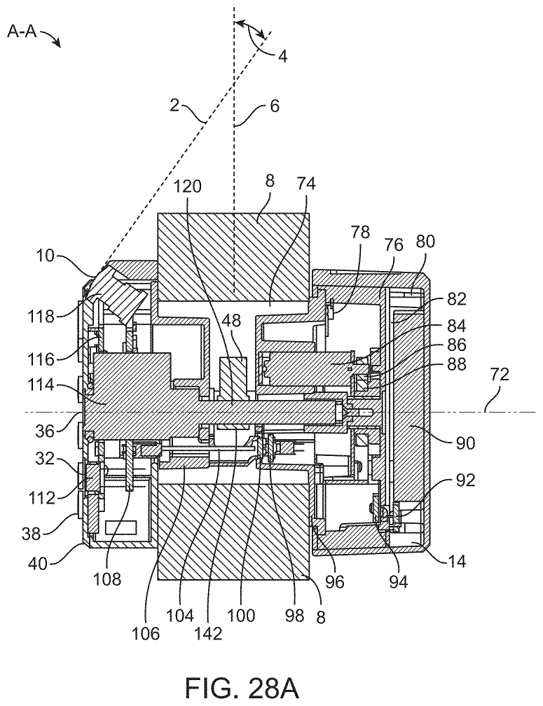

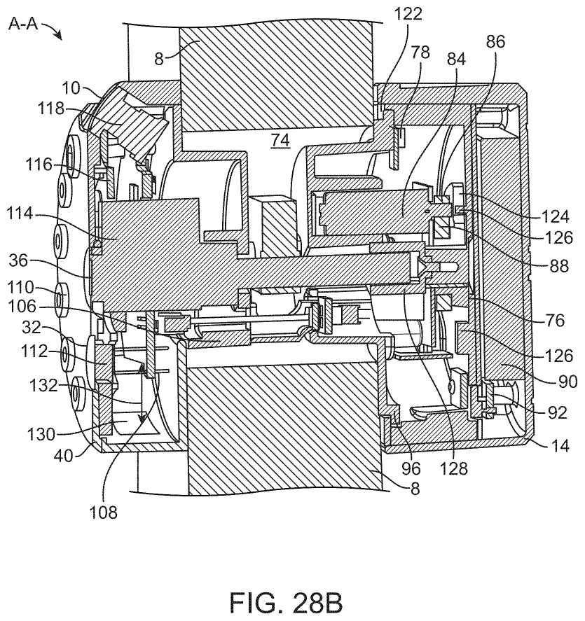

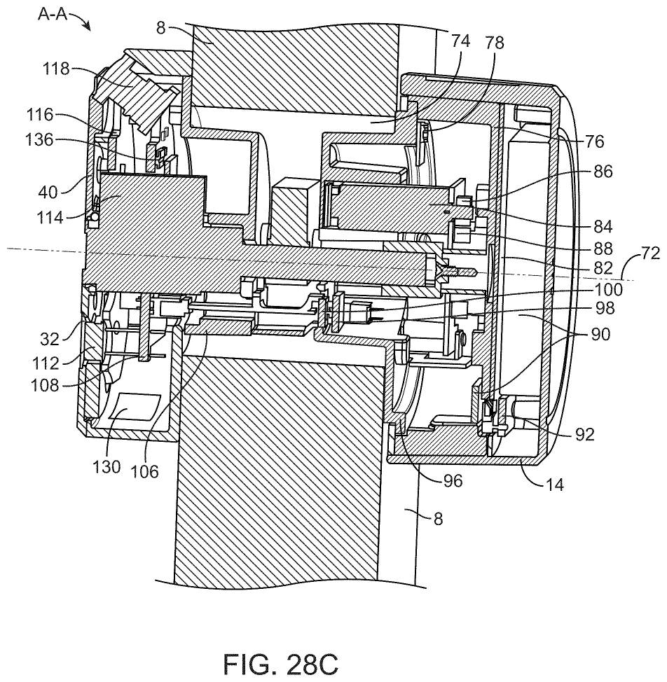

FIG. 28A through FIG. 28C illustrate that the door 8 can have a deadbolt bore hole 74. The locking device 24 can extend through the deadbolt bore hole 74. The locking device 24 can clamp onto the front and back of the door 8 adjacent to the deadbolt bore hole 74. The locking device 24 can have a lock longitudinal axis 72 parallel or collinear with the central radial axis of the deadbolt bore hole 74.

A key can be inserted through the keyway 36 and rotated one direction or another to move the deadbolt 48 to an extended (locked) position and a retracted (unlocked) position. The keyway 36 can be in a lock cylinder 114. The lock cylinder 114 is not necessarily cylindrical in shape. A deadbolt paddle or tailpiece can extend from the lock cylinder 114.

A tailpiece receiver 140 can extend from the deadbolt 48. The tailpiece receiver 140 can have a rotating notch 142 extending through the width of the receiver. The rotating notch 142 can have a symmetric hole such as a single slot (“I”) or plus-sign (“+”) shape, or a non-symmetric hole such as a “D” shaped slot. During assembly of the locking device 24, the deadbolt tailpiece 120 can be slidably inserted into and through the rotating notch 142. When the key turns within the keyway 36, the lock cylinder 114 can rotate the deadbolt tailpiece 120. The deadbolt tailpiece 120 can then rotate within the rotating notch 142, extending the deadbolt 48 into a locked position or retracting the deadbolt 48 into an unlocked position.

The locking device 24 can have a first circuit board 116 and a second circuit board 108. Either or both circuit boards can have a microprocessor and/or memory 136. The circuit boards can be in data communication with the motion sensor, camera 118, keypad including the numerical keys 110 (which can be the same as or similar to numerical key 38), lock button 42, and doorbell 12, and combinations thereof.

The locking device 24 can have an antenna 130. The antenna 130 can be mounted flat or flush to the radially inner surface of the lateral wall of the lock front enclosure 40. For example to reduce interference and increase antenna 130 performance, an antenna gap 132 radially measured between the antenna 130 and the closest element in a radial direction with respect to the lock longitudinal axis 72 can be larger than any other radially measured gap between the inner wall of the radially inner surface of the lateral wall of the lock front enclosure 40 and the closest element.

The camera 118 can be fixed to the lock front enclosure 40 at an angle so that the camera face 10 is at the camera face angle 4. The camera 118 can be attached to the lock front enclosure 40 to form a water-tight seal (e.g., with a rubber or silicone gasket) in a port through which the camera face 10 extends. The camera 118 can longitudinally extend perpendicular relative to the surface of the camera face 10. The camera face 10 can be a lens or a protective cover over a lens. The camera 118 can be completely within the lock front enclosure 40, partially outside of the lock front enclosure 40, or completely outside of the lock front enclosure 40.

The infrared (IR) motion sensor 112 can have a longitudinal axis parallel with the lock longitudinal axis 72. The IR motion sensor 112 can have an IR motion sensor face 32 coplanar with the front surface of the lock front enclosure 40. The IR motion sensor 112 can be attached to the lock front enclosure 40 to form a water-tight seal (e.g., with a rubber or silicone gasket) in a port through which the IR motion sensor face 32 extends.

Numerical keys 110 or code buttons, the lock button 42, and the doorbell 12 can be in data communication with the first and/or second circuit boards 108, for example, to transmit input data from the keys or buttons to the on-board microprocessor and/or to a remote microprocessor in wireless data communication via the antenna 130.

The locking device 24 can have a device front baseplate 106. The device front baseplate 106 can be a rigid structural frame made from metal, plastic, or combinations thereof. The device front baseplate 106 can attach to the lock front enclosure 40, circuit boards, camera 118, motion sensor, lock cylinder 114 and combinations thereof. The device front baseplate 106 and lock front enclosure 40 can define a front chamber of the locking device 24.

The locking device 24 can have a device back baseplate 96. The device back baseplate 96 can be a rigid structural frame made from metal, plastic, or combinations thereof. The device back baseplate 96 can be radially aligned and attach to the device front baseplate 106 during installation. The device back baseplate 96 can rotatably attach to a deadbolt knob 76, knob ring 122, tailpiece collar 128, and combinations thereof. The device back baseplate 96 can fixedly attach to one or more bolt position toggle switches 78, a rear mating connector PCB 98, a body connector 94, the case of a bolt motor 84, a gear collar 172, alignment and connection elements 138, or combinations thereof. The device back baseplate 96 and deadbolt knob 76 can define a back chamber of the locking device 24.

The first and/or second circuit boards 108 can be in data and electrical power communication with each other. A bridge connector 104 can be in data and electrical communication with the second and/or first circuit board 116. The bridge connector 104 can extend from the first and/or second circuit boards 108 rearward to a bridge connector printed circuit board (PCB). The bridge connector 104 can be accessible through a port in or extend rearward from the device front baseplate 106. The bridge connector 104 and bridge connector PCB 100 can be fixed to the device front baseplate 106.

The locking device 24 can have a rear mating connector PCB 98. The rear mating connector PCB 98 can be fixed to the device back baseplate 96. The rear mating connector PCB 98 can be in electrical and/or data communication with the motor, bolt position toggle switches 78, body connector 94, or combinations thereof.

The rear mating connector PCB 98 can be angularly and radially aligned with respect to the lock longitudinal axis 72 with the bridge connector PCB 100. The rear mating connector PCB 98 can be in electrical and data communication with the bridge connector PCB 100 when the locking device 24 is assembled and attached to a door 8. The bridge connector PCB 100 and/or the rear mating connector PCB 98 can have spring-loaded pins extending toward the opposite PCB. One or more springs can push the bridge connector PCB 100 and/or the rear mating connector PCB 98 toward the opposite PCB. During installation and assembly of the locking device 24, the rear mating connector PCB 98 and/or the bridge connector PCB 100 and/or spring-loaded pins in either the rear mating connector PCB 98 and/or bridge connector PCB 100 can translate in a direction parallel with the lock longitudinal axis 72 when the device back baseplate 96 is attached to the device front baseplate 106 through the deadbolt bore hole 74.

The deadbolt knob 76 can fixedly attach to a knob ring 122. The knob ring 122 can be a flange, rim, collar, or ring. The knob ring 122 can be on the front of the rear edge of the device back baseplate 96. The deadbolt knob 76 and knob ring 122 can rotate on the rear edge of the device back baseplate 96 about the lock longitudinal axis 72. The deadbolt knob 76 and knob ring 122 can be longitudinally fixed to the rear edge of the device back baseplate 96.

The locking device 24 can have one or more bolt position toggle switches 78. The bolt position toggle switches 78 can be in data communication with the microprocessors. The deadbolt knob 76 can have one or more hub interference projections 152 that can toggle the bolt position toggle switches 78 depending on the angular position of the deadbolt knob 76 with respect to the lock longitudinal axis 72, as described infra. Each bolt position toggle switch 78 can send a signal to the microprocessor when the respective toggle switch has been toggled by the hub interference projection 152. The microprocessor can then calculate or lookup in memory the corresponding deadbolt 48 position to sense whether the deadbolt 48 is extended in a locked position or retracted in an unlocked position.

The locking device 24 can have a bolt motor 84. The case of the bolt motor 84 can be fixed to the device back baseplate 96. The bolt motor 84 can be powered by the battery 90. The bolt motor 84 can be activated and deactivated by the microprocessor. For example, when the microprocessor receives a signal that the lock button 42 is pressed, the microprocessor can activate the motor to extend the deadbolt 48 into a locked position. When the microprocessor receives a signal from a remote device or server via the antenna 130 to lock or unlock the door 8, the microprocessor can activate the motor to move the deadbolt 48 into a locked or unlocked position.

If an input signal is received by the microprocessor to lock or unlock the deadbolt 48 and the deadbolt 48 is already in the desired position according to the signals from the on-board sensors (i.e., bolt position toggle switches 78, motor, and sensors (e.g., magnetometers 214) in the deadbolt 48, door jam or strike plate 60, or combinations thereof), the microprocessor can do nothing, reset the position of the deadbolt 48 to confirm the bolt position via the on-board sensors, activate the deadbolt 48 regardless of previously detected on-board sensor signals, or combinations thereof.

The bolt motor 84 can have a shaft extending from the case of the motor. The shaft can rotatably and translatably fixedly attach to a motor gear 86. The motor gear 86 can corotate with the motor.

The locking device 24 can have a tailpiece collar 128. The tailpiece collar 128 can be rotatably fixed to the terminal end of the deadbolt tailpiece 120. During assembly the terminal end of the deadbolt tailpiece 120 can be translatably slid into the tailpiece collar 128 in a direction collinear or parallel with the lock longitudinal axis 72. The tailpiece collar 128 can be rotatably fixed to a bolt gear 88 and one or more bolt-knob interfaces 124.

The bolt gear 88 can be rotatably and translatably fixedly attached to the tailpiece collar 128. The bolt gear 88 can be longitudinally between the rear terminal end of the tailpiece and the bolt-knob interface 124. The bolt gear 88 can corotate with the tailpiece collar 128 and/or tailpiece.

The motor gear 86 can mesh with the bolt gear 88. The motor gear 86 can drive and be driven by the bolt gear 88. The motor gear 86 and the bolt gear 88 can each rotate in either direction. The motor gear 86 and bolt gear 88 can rotate in opposite directions to each other. The bolt gear 88 can have larger (as shown), same, or smaller radius than the motor gear 86. The bolt and motor gears 86 can be spur, helical or double helical gears.

The rotational axis of the shaft of the motor can be parallel with the rotational axis of the deadbolt tailpiece 120 and tailpiece collar 128. The rotational axes of the shaft of the motor, the deadbolt tailpiece 120 and the tailpiece collar 128 can be parallel and/or collinear with the lock longitudinal axis 72.

The bolt-knob interfaces 124 can extend radially from a hub at the rear terminal end of the tailpiece collar 128. The bolt-knob interfaces 124 can be a part of and/or fixedly attached to the tailpiece collar 128. The bolt-knob interfaces 124 can corotate with the tailpiece collar 128 and/or deadbolt tailpiece 120.

Knob tabs 126 can extend forward from the internal rear wall of the deadbolt knob 76. The knob taps can overlap with the bolt-knob interfaces 124 in the longitudinal direction. The knob tabs 126 can be configured to remain in contact with the bolt-knob interfaces 124. For example, the knob tabs 126 can firmly contact each angular side of at least one or all of the bolt-knob interfaces 124. Also for example, the knob tabs 126 can tightly slide inside of slots on the bolt-knob interfaces 124. When the bolt-knob interfaces 124 rotate about the axis of rotation of the tailpiece collar 128, the knob tabs 126 can rotate about the axis of rotation of the deadbolt knob 76.

When the deadbolt knob 76 is rotated, the knob tabs 126 can push the bolt-knob interfaces 124. The bolt-knob interfaces 124 can then rotate the tailpiece collar 128 about the lock longitudinal axis 72. The tailpiece collar 128 can then rotate the deadbolt tailpiece 120 which can extend or retracting the deadbolt 48. When the deadbolt 48 is rotated otherwise (e.g., by turning the key or activation of the motor), the bolt-knob interface 124 can push the knob tabs 126, and thus the deadbolt knob 76 can rotate. The deadbolt knob 76 can corotate with the deadbolt tailpiece 120. The axis of rotation of the deadbolt knob 76, tailpiece collar 128 and tailpiece, or combinations thereof, can be collinear.

The bolt gear 88 can also rotate which can rotate the motor gear 86 turning the motor. The power passively generated (i.e., via power derived from the turning of the manual deadbolt knob 76) by the motor can be detected by one or more of the microprocessors. Reception of the passively generated power by the motor can be used by the microprocessor to confirm (e.g., alone or in combination with signals from the bolt position toggle switches 78 and/or sensors (e.g., magnetometers 214) in the deadbolt 48, door jam or strike plate 60) extension or retraction of the deadbolt 48. A current spike by the activated motor, which can be detected by the microprocessor, can indicate the deadbolt 48 has reached a maximum retraction or extension position.

When the battery pack 14 is attached to the rear side of the deadbolt knob 76, the battery pack 14 can be rotatably fixed about the lock longitudinal axis 72 to the deadbolt knob 76, for example from the battery pack interference projection 190 fitting with the battery pack alignment feature 170.

The battery pack 14 can be fixedly attached to a battery cover 82 via a battery cover mount 80. The locking device 24 can have a battery 90 fixed to the front side of the rear wall of the battery pack 14. The battery 90 can be in a chamber defined by the battery cover 82 and the battery pack 14. The battery 90 can be a rechargeable battery (e.g., a NiCd, NiMH, lead acid, or Li-ion battery). The battery pack 14 can be detached from the deadbolt knob 76, recharged, and then reattached to the deadbolt knob 76.

The battery 90 can be electrically connected with a battery connector 92. The battery connector 92 can be in the chamber defined by the battery cover 82 and the battery pack 14. The battery connector 92 can be accessed through the battery cover 82. For example, the battery connector 92 can have spring-loaded pins that can extend to or through a port in the battery cover 82.

The locking device 24 can have a body connector 94 attached to the front side of the rear wall of the deadbolt knob 76. The body connector 94 can be accessible through the rear wall of the deadbolt knob 76. For example, the body connector 94 can have spring-loaded pins that can extend to or through a port in the rear wall of the deadbolt knob 76.

The body connector 94 can be electrically connected with the first and/or second circuit boards 108 via the rear mating connector PCB 98 and bridge connector PCB 100, the remaining electrical components in the locking device 24, or combinations thereof. For example, the body connector 94 can be electrically connected directly to the rear mating connector PCB 98. Current from the battery 90 can be routed to the circuit boards. The microprocessors can then control current to the electrical components (e.g., IR motion sensor 112, camera 118, bolt motor 84, bolt position toggle switches 78, microphones, speakers, the keypad, the antenna 130, either circuit board and/or components on either circuit board, one or more magnetometers 214, or combinations thereof).

The body connector 94 can angularly and radially align with the battery connector 92 with respect to the lock longitudinal axis 72. When the battery pack 14 is attached to the deadbolt knob 76, the body connector 94 can be in electrical communication with the battery connector 92, for example via spring-loaded pins on the battery connector 92 and/or body connector 94.

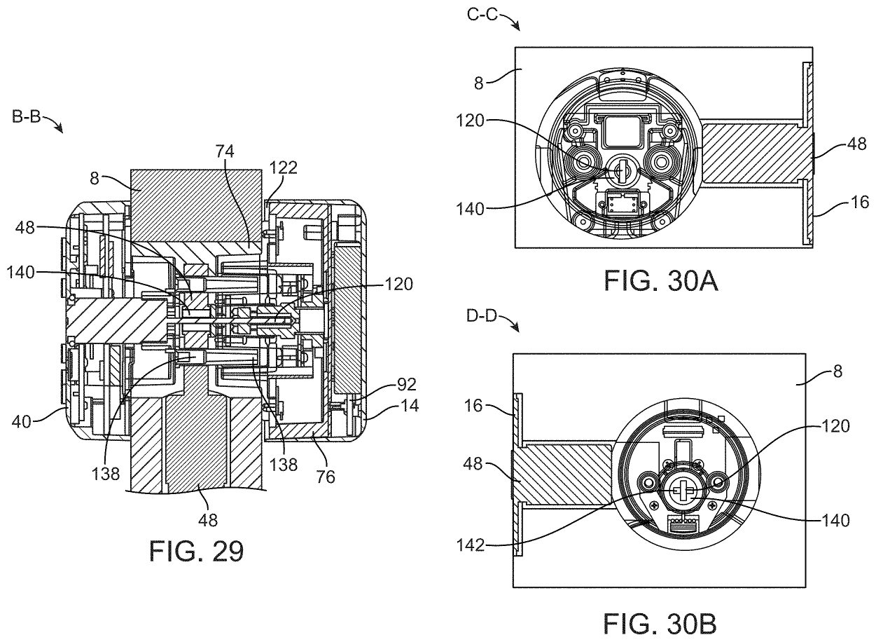

FIG. 29 illustrates that the device front baseplate 106 and the device back baseplate 96 can have alignment and connection elements 138. The alignment and connection elements 138 can radially and angularly align the device front baseplate 106 and the device back baseplate 96 with each other during and after assembly and mounting on the door 8. The alignment and connection elements 138 can be cones on each of the device front baseplate 106 and the device back baseplate 96 seated in each other when the device front baseplate 106 is attached to the device back baseplate 96. The alignment and connection elements 138 can include permanent fixation elements (e.g., screws, rivets, brads) not accessible from the lock front enclosure 40. FIG. 30A is a front view of cross-section C-C of FIG. 25B. FIG. 30B is a front view of cross-section D-D of FIG. 25B.

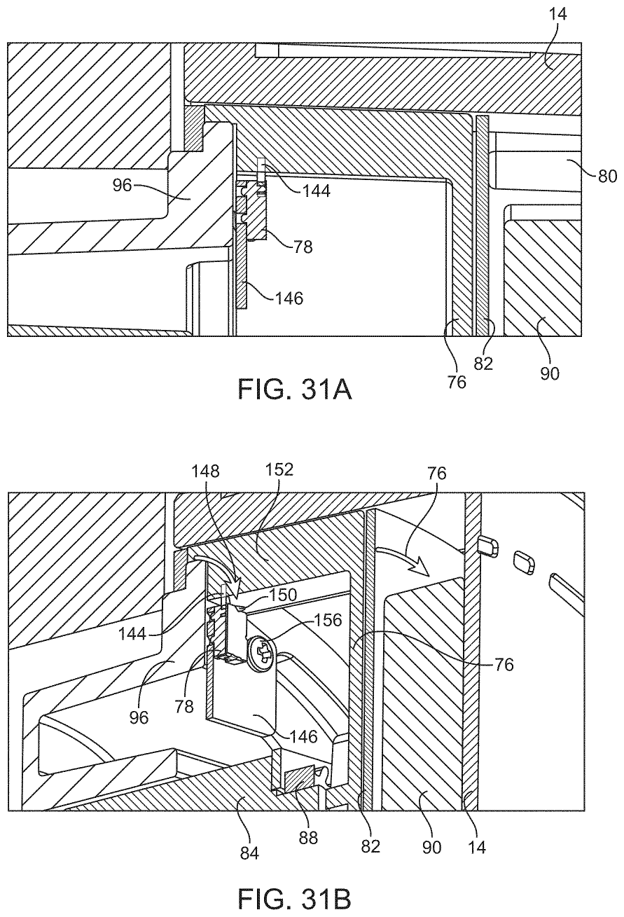

FIGS. 31A and 31B illustrate that the deadbolt knob 76 can have a radially inwardly extending hub interference projection 152. The locking device 24 can have a bolt position toggle switch 78. The bolt position switch can be mounted to a switch circuit board 146. The switch circuit board 146 can send the signal of the bolt position switch to the microprocessor. The bolt position toggle switch 78 can have a toggle tab 160 extending radially outwardly.

The toggle tab 160 can be spring-loaded or an elastic material. When an angular force is applied to the toggle tab 160, the toggle tab 160 can rotate from an unbiased (i.e., a toggle tab first position 144) to a biased (i.e., a toggle tab second position 150) position with respect to the rest of the bolt position toggle switch 78. When the toggle tab 160 is in the toggle tab second position 150, the bolt position toggle switch 78 can signal to the microprocessor that the deadbolt knob 76 has rotated to the position of the specific bolt position toggle switch 78.

The switch circuit board 146 can be attached to the device back baseplate 96 by a switch mounting screw 156 through the switch circuit board 146.

The deadbolt knob 76 can be rotated around the lock longitudinal axis 72, as shown by the rotation of the deadbolt knob 76 (as depicted by rotation arrow 154).

As the deadbolt knob 76 rotates, the hub interference projection 152 can push into the toggle tab 160. As the hub interference projection 152 passes by the toggle tab 160, the hub interference projection 152 can push the toggle tab 160 from an unbiased toggle tab first position 144 to a biased toggle tab second position 150, as shown by tab rotation arrow 148.

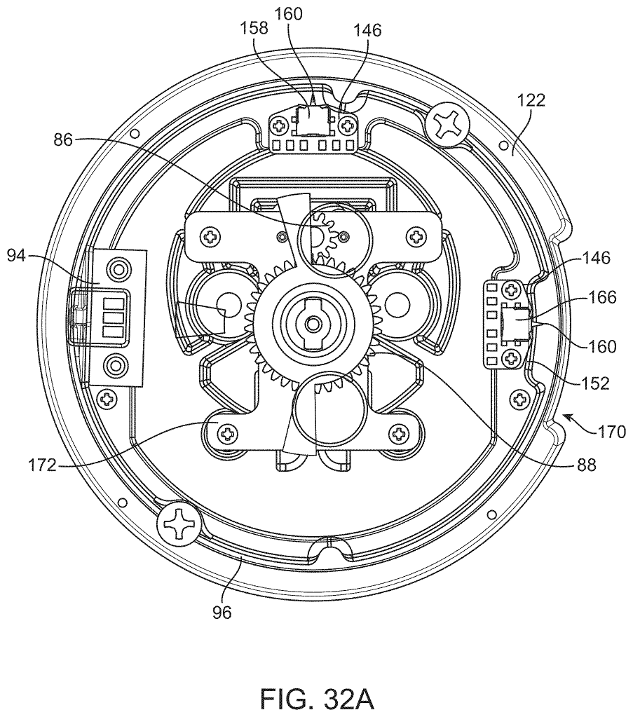

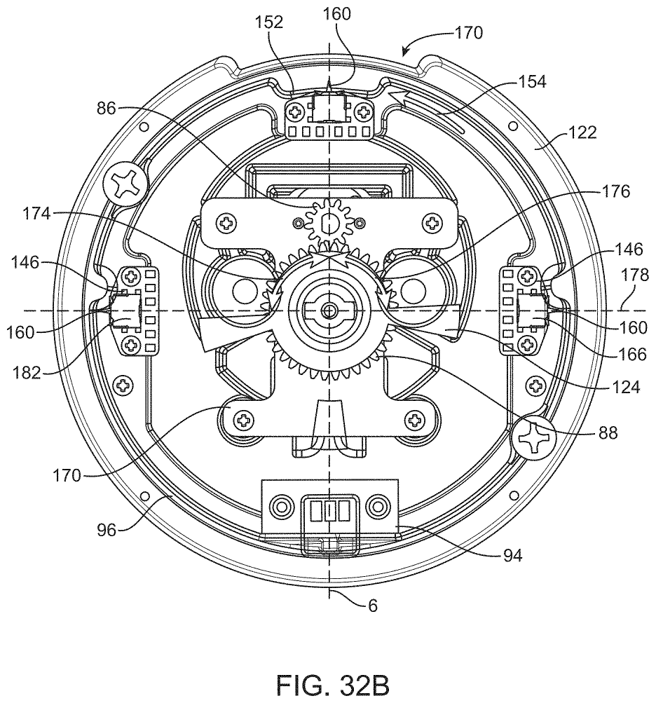

FIGS. 32A and 32B illustrate that the locking device 24 can have a bolt position first toggle switch 182 at the left (of the figure as it appears, i.e., 90° counter-clockwise from the top of the figure or door vertical axis 6), a bolt position second toggle switch 158 at the top (of the figure as it appears or door vertical axis 6), a bolt position third toggle switch 166 (of the figure as it appears, i.e., 90° clockwise from the top of the figure or door vertical axis 6), or combinations thereof.

FIG. 32A illustrates that when the deadbolt knob 76 is in an opened position, rotated so that the hub interference projection 152 is on the right (i.e., 90° clockwise from the top of the figure or door vertical axis 6), the hub interference projection 152 can rotate the toggle tab 160 on the bolt position third toggle switch 166. The bolt position third toggle switch 166 can send a signal to the microprocessor that the bolt position third toggle switch 166 is triggered. The microprocessor can calculate (e.g., looking up in memory) that the bolt position third toggle switch 166 is triggered when the deadbolt 48 is in a locked position extending out of the door 8.

The hub interference projection 152 and the battery pack alignment feature 170 can be co-angular (as shown) or at different angles on the deadbolt knob 76 with respect to each other.

FIG. 32B illustrates that when the deadbolt knob 76 is rotated, as shown by the rotation of the deadbolt knob 76 (as depicted by rotation arrow 154), so that the hub interference projection 152 is at the top (of the figure as it appears or door vertical axis 6).

The locking device 24 can have a bolt transverse axis 178. The locking device 24 can be installed in a right-handed or a left-handed configuration on the door 8 (e.g., depending on which side of the door the exterior or front side of the handle faces). For the right-handed configuration, the hub interference projection 152 can rotate within the right-hand separation angle 174. The right-hand separation angle 174 can be between the bolt position third toggle switch 166 when locked and the bolt position second toggle switch 158 when unlocked. For the left-handed configuration, the hub interference projection 152 can rotate within the left-hand separation angle 176. The left-hand separation angle 176 can be between the bolt position first toggle switch 182 when locked and the bolt position second toggle switch 158 when unlocked.

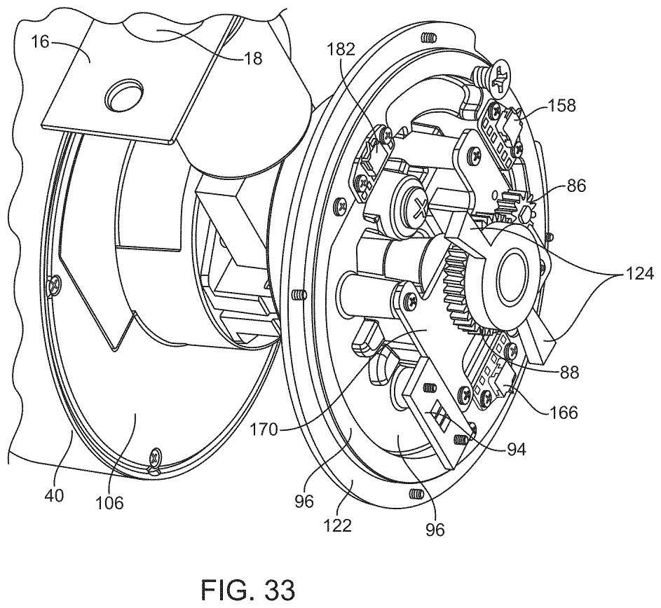

FIG. 33 illustrates that the motor gear 86 meshes with the bolt gear 88. When the bolt motor 84 activates, the motor gear 86 can rotate. The motor gear 86 can deliver torque from the bolt motor 84 to the bolt gear 88. When the bolt gear 88 is rotated, the deadbolt 48 is extended or retracted depending on the direction of rotation.

The microprocessor can sense when the deadbolt 48 is in a locked position, for example based on receiving a signal from the appropriate bolt position toggle switch 78. When the deadbolt 48 is in a locked position and the microprocessor receives a command to unlock the door 8 (e.g., from a wirelessly received signal or an unlock code entered through the code buttons), the microprocessor can activate the bolt motor 84 in the direction to unlock the door 8. When the appropriate bolt position toggle switch 78 that indicates that the deadbolt 48 is in an unlocked position sends a signal to the microprocessor that the toggle tab 160 on the respective switch has been activated, the microprocessor can deactivate the motor, stopping rotation of the deadbolt 48. In combination or in lieu of signals from the bolt position toggle switches 78, the microprocessor can receive signals from a magnetometer 214 or magnet 58 in the deadbolt 48 and/or door jam or strike plate 60 indicating the position of the deadbolt 48 with respect to the door jam or strike plate 60.

The locking device 24 can have a gear collar 172. The gear collar 172 can be fixed to the device back baseplate 96. The gear collar 172 can have ports through which the bolt motor 84 shaft and the tailpiece collar 128 can extend. The motor gear 86 and the bolt gear 88 can be adjacent to the rear side of the gear collar 172.

Toggle tabs 160 shown in FIGS. 32A, 32B and 33 illustrate toggle tabs 160 in three concurrent states of deflection for illustrative purposes.

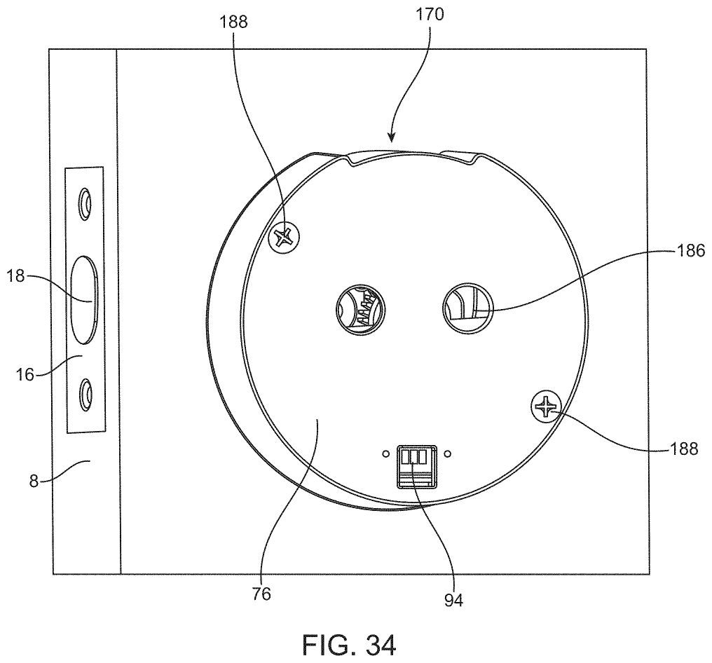

FIG. 34 illustrates that the deadbolt knob 76 can be fixed to the remainder of the locking device 24, other than the battery pack 14, by knob screws 188. The knob screws 188 can be magnetic, such as permanent magnets or electromagnets. The knob screws 188 can be elements other than screws, such as other embedded or adhesive magnetic discs or cylinders. The battery back can be made from a magnetic material such as a ferrous material, for example ferritic stainless steel, and/or the battery pack 14 can have one or more magnetic elements corresponding in angular position to the knob screws 188 when the battery pack 14 is mounted on the deadbolt knob 76 when the battery pack alignment feature 170 receives the battery pack interference projection 190. The knob screws 188 can magnetically couple with the battery pack 14 material and/or with the magnetic elements in or on the battery pack 14, for example, holding the battery pack 14 to the deadbolt knob 76.

The deadbolt knob 76 can extend rearward from the door 8. When the deadbolt 48 is in an unlocked position retracted into the door 8, the battery pack alignment feature 170 can be pointed toward the top of the locking device 24. The body connector 94 can be visible and directly accessed through the deadbolt knob 76.

Rotation of the deadbolt knob 76 in a first direction can extend the deadbolt 48 out of the door 8 into a locked position. Rotation of the deadbolt knob 76 in a second direction opposite the first direction can retract the deadbolt 48 into the door 8 and an unlocked position. The deadbolt knob 76 can be rotated directly or via the battery pack 14 when the battery pack 14 is on the deadbolt knob 76.

The deadbolt knob 76 can have knob ports 186. During assembly, a tool, such as a screwdriver, can be inserted through the knob ports 186 to insert and activate, fasten or tighten attachment elements, such as screws, that can attach internal elements, such as the device front baseplate 106, to the device back baseplate 96.

The deadbolt knob can have a reset button, which can be sunk below a surface of the deadbolt knob face. When the reset button is pressed, software of the locking device can be reverted to a factory default version. For example, software of the locking device can be reverted to a factory default version when the reset button is pressed for about 0.5 seconds to about 3.0 or more seconds.

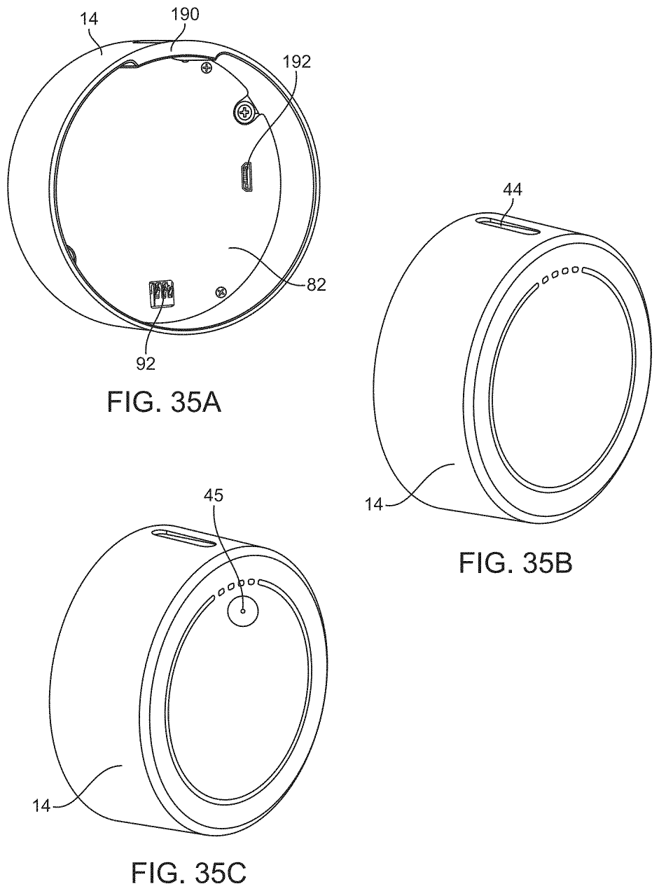

FIGS. 35A and 35B illustrate that the battery pack 14 can have a battery pack interference projection 190 extending radially inward from the lateral wall of the battery pack 14. The battery pack interference projection 190 can be angularly aligned with the angle indicator 44. The battery pack interference projection 190 can be shaped and sized to slide in and out of the battery pack alignment feature 170 in the direction of the lock longitudinal axis 72 when the battery pack 14 is pushed onto the deadbolt knob 76.

The battery pack interference projection 190 can be shaped and sized to interference fit against the battery pack alignment feature 170 in an angular direction when the battery pack 14 is rotated about the lock longitudinal axis 72. The battery pack 14 can snap fit and/or pressure fit onto the deadbolt knob 76.

The battery pack 14 can have a charging port 192 in electrical communication with the battery 90. The charging port 192 can extend and be accessible through the battery cover 82. The charging port 192 can be a USB connector. An external power source can be plugged into the charging port 192 to charge the battery 90.

The battery connector 92 can extend and be accessible through the battery cover 82. The battery connector 92 can have spring-loaded pins (for example three pins as shown). The battery connector 92 can electrically connect with the body connector 94 and delivery electrical power from the battery 90 in the battery pack 14 through the battery connector 92 and body connector 94 to the remainder of the electronic elements in the locking device 24.

The deadbolt knob 76 can have a power socket, suck as a USB connector, that can receive a plug from an alternate power source (i.e., other than the battery pack 14). For example, when the battery pack 14 is removed for recharging, the alternate power source can be plugged into the power socket to deliver electrical power to the locking device 24, for example, without the battery pack 14. The alternate power source can be unplugged from the power socket before the battery pack 14 is reattached to the locking device 24 after charging.

The locking device 24 can have an on-board backup battery that can be activated when the battery pack 14 is removed from the remainder of the locking device 24 (e.g., for recharging).

FIG. 35C illustrates that the battery pack can have an indicator light 45. The indicator light can turn on or off to indicate a status of the battery pack or the locking device, or a combination thereof. For example, the light can turn on or off to indicate that the battery has a low charge. The indicator light can additionally or alternatively turn on or off to indicate that the locking device is or is not locked. The indicator light can have multiple colors of lights (e.g., red, yellow, and/or green LEDs), can turn on or off for different lengths of time or at different frequencies, or a combination thereof. For example, the indicator light can turn on a steady green light to indicate that the battery charge is greater than a threshold level, and can turn on a steady red light to indicate that the battery charge is less than a threshold level, or can turn on a steady yellow light to indicate that the battery charge is between the green and red threshold levels. A long blink of the indicator light (e.g., around one second) can indicate that the locking device is locked. Several short blinks of the indicator light (e.g., three blinks each around ¼ second) can indicate that the locking device is unlocked. Any combination of colors, length of blinks, and frequency of blinks of the indicator light can be used to convey information about the battery pack or locking device.

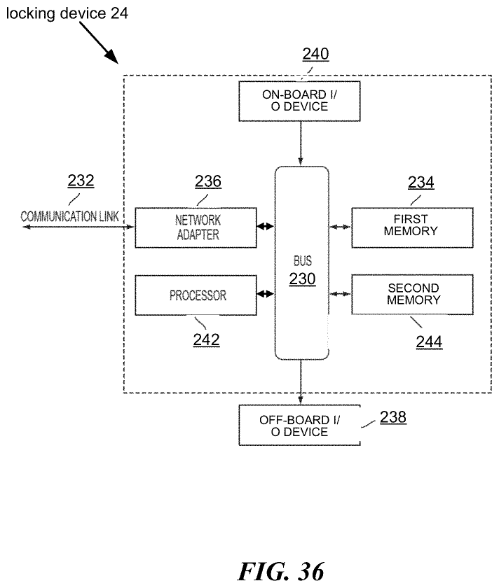

FIG. 36 illustrates a schematic diagram of a variation of data components of the locking system 194.

The locking device 24 can have a bus 230, for example on board the first and/or second circuit board 108. The locking device 24 can have one or more on-board input/output (I/O) devices, such as the keypad. The locking device 24 can have a network adapter 236 such as a modem on the first and/or second circuit board 108 in communication with the antenna 130. The network adapter 236 can create communication links 232 with remote devices. The locking device 24 can have one or more processors 242 (also referred to herein as microprocessors). The locking device 24 can have a first memory 234 and a second memory 244, for example on the first and/or second circuit boards 108.

The network adapter 236, processor 242, first and second memories and off-board I/O devices 238 can be in direct two-way data communication directly with the bus 230. The on-board I/O devices 240 can be in one-way data communication to the bus 230. The off-board I/O devices 238 can be in one-way data communication from the bus 230.

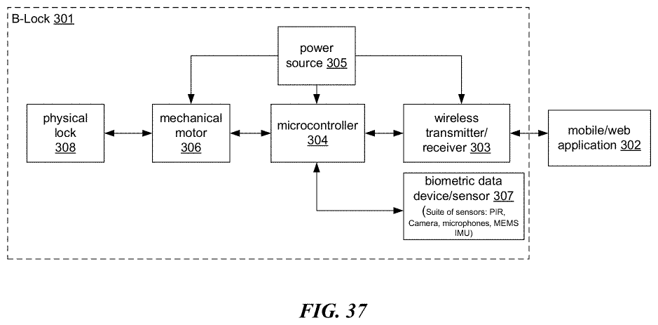

FIG. 37 is a block diagram illustrating an embodiment of an electronic lock that includes a personal data device, consistent with various embodiments. The locking device 24 or biometric lock can have the physical lock (e.g., the lock cylinder 114, deadbolt tailpiece 120, and deadbolt 48), power source (e.g., battery), mechanical motor (e.g., bolt motor 84), micro controller (e.g., microprocessor), sensor (e.g., IR motion sensor 112, camera 118, PIR, microphones, MEMS, IMU), wireless transmitter receiver (e.g., wireless modem and antenna), or combinations thereof.

In some embodiments, the electronic lock is a biometric lock, and the personal data device is a biometric scanner, with which a user can input personal data, such as biometric data of a biometrically identifiable part of his body. In other embodiments, the electronic lock is a password lock, and the personal data device is a keypad, touchpad, microphone, etc., with which a user can input personal data, such as a password or pass phrase. In yet other embodiments, the electronic lock is a voice recognition lock, and the personal data device is a microphone into which a user can provide personal data, such as a sample of his voice. In some embodiments, personal data is identifying information that can be used to establish and identify of an individual. While the following discussion involves a biometric lock, much of the discussion is applicable to other types of electronic locks, such as a password lock or a voice recognition lock, among others.

Biometric lock 301 can include physical lock 308. As will be appreciated by a person of ordinary skill in the art, physical lock 308 includes some components that are similar to those of a standard lock for a particular application. For example, a biometric lock for a particular application of locking a door 8 of a building can include some components similar to those of a standard lock to lock a door 8 of a building. The components can include, for example, a dead bolt, mechanical parts to cause the dead bolt to move and lock/unlock a door 8, a key hole/cylinder into which a key can be inserted to lock/unlock a door 8, etc.

As a second example, a biometric lock for a particular application of locking a door 8 of a safe can include some components similar to those of a standard lock to lock a door 8 of a safe. The components can include, for example, a combination or security code entry mechanism, multiple dead bolts, each of which extend from the door 8 and enter the door frame 202 of the safe to secure the safe door, mechanical parts to cause the dead bolts to move and lock/unlock the safe door, etc. As a third example, a biometric lock for a particular application of locking a door 8 of a car can include some components similar to those of a standard lock to lock a door of a car. The components can include, for example, a latch to latch the car door closed, a key hole/cylinder into which a key can be inserted to lock/unlock the car door, a wireless receiver and a processing unit to receive a wireless signal (that includes a security code), to validate the security code, and to unlock/lock the car door upon validation of the security code, etc.

Various embodiments of biometric lock 301 can be used to lock any of various doors, such as a door on a building, a door on a car, a door on a safe, a door on a cabinet, etc. Biometric lock 301 can be unlocked and/or locked based on validation of biometric data, which is obtained by biometric data device 307. Biometric data device 307 is a device that can obtain data of a biometrically identifiable object where the data can be used to identify the biometrically identifiable object. Examples of biometrically identifiable objects include a finger, a hand, an iris, a face, etc. Examples of biometric data devices include a fingerprint scanner, a hand scanner, an iris scanner, a face scanner, a camera 118, etc. In some embodiments, biometric data device 307 is not integrated in a biometric lock, but rather is integrated in or coupled to a mobile device, such as a mobile device that is executing mobile/web application 302.

Biometric data device 307, which is a personal data device, can obtain biometric data of a user, and can send the biometric data to microcontroller 304. Microcontroller 304 can have a local memory that stores various types of data or information, such as security keys, biometric information, access details, logs of user interaction, associated usage timestamps, etc. Microcontroller 304 can keep a record of owner and/or administrator information for biometric lock 301. In some embodiments, each biometric lock has a single registered owner. In some of these embodiments, in addition to having a single registered owner, each biometric lock can have one or more administrators. An owner can authorize a user to be an administrator. Both owners and administrators can authorize a user to be able to unlock/lock a biometric lock.

When a new user indicates a request to open biometric lock 301 by scanning his fingerprint using biometric data device 307, the request is sent to microcontroller 304. Microcontroller 304 compares biometric data obtained by biometric data device 307 from the new user against registered user data that is stored in local memory, which can be non-volatile memory. If the biometric data matches a registered user that is authorized to open biometric lock 301, microcontroller 304 signals mechanical motor 306 to actuate the deadbolt 48 of physical lock 308 in order to open biometric lock 301.

Power source 305 provides power to biometric lock 301, and can operate on a battery energy source, a wired power outlet, etc. For example, power source 305 can be a rechargeable battery.

Biometric lock 301 can include light emitting diodes (LEDs), a display, etc. to indicate the lock/unlock status of biometric lock 301 to users. Physical lock 308 can include a knob for manually locking/unlocking biometric lock 301 that is accessible from the inside of the door 8 on which biometric lock 301 is mounted. Physical lock 308 can also include a key hole/cylinder that is accessible from the outside of the door 8 on which biometric lock 301 is mounted, and into which a user can insert a physical key to lock/unlock biometric lock 301.

In various embodiments, wireless transmitter/receiver 303 can communicate via any of various technologies, such as a cellular network, a short-range wireless network, a wireless local area network (WLAN), etc. The cellular network can be any of various types, such as code division multiple access (CDMA), time division multiple access (TDMA), global system for mobile communications (GSM), long term evolution (LTE), 3G, 4G, etc. The short-range wireless network can also be any of various types, such as Bluetooth, Bluetooth low energy (BLE), near field communication (NFC), etc. The WLAN can similarly be any of various types, such as the various types of IEEE 802.11 networks, among others. In some embodiments, wireless transmitter/receiver 303 can also or alternately communicate via a wired connection, such as via internet protocol (IP) messages sent over a wired Ethernet network. In some embodiments, wireless transmitter/receiver 303 can communicate with a server.

Microcontroller 304 can maintain a log of entries and exits and can send the log information via wireless communication facilitated by wireless transmitter/receiver 303 to, for example, a biometric lock application running on a mobile device, such as mobile/web application 302. Microcontroller 304 can log when a user opens biometric lock 301 with a physical key, and can share this log information with the lock owner and/or administrator(s). Logs of biometric lock 301 being locked and/or unlocked through the use of a physical key can, for example, inform the owner of events such as unauthorized access into a space (e.g., a burglary). In some embodiments, a voltage output of mechanical motor 306 is monitored by a circuit of biometric lock 301 in order to sense when physical lock 308 is manually locked and/or unlocked using a physical key. In some embodiments, a capacitive/optical sensor of biometric lock 301 can track the opening and closing of the door 8. Biometric lock 301 can be equipped with other sensors that track vibrations, temperature, etc. Biometric lock 301 can also be equipped with a display, touch sensors, and/or a camera 118 to enable communication to and/or from users.

In some embodiments, biometric data device 307 can communicate with both microcontroller 304 and mobile/web application 302. Mobile/web application 302 can be a mobile or a web application that runs on, for example, a mobile device. Biometric data device 307 may be not part of biometric lock 301, but rather part of or coupled to a mobile device. A biometric data device can be part of or coupled to a mobile device executing a mobile/web application which can be executed on a mobile device. Biometric data device 307, rather than microcontroller 304, can validate the biometric data, such as by comparing the biometric data to stored biometric data of users that are authorized to unlock/lock biometric lock 301. The stored biometric data can be stored, for example, in a database. The stored biometric data can reside locally on microcontroller 304, can reside on biometric data device 307, or can reside at another location that is accessible via wireless transmitter/receiver 303. If a user is verified as being authorized to lock/unlock biometric lock 301 at the time of the verification, biometric lock 301 will lock or unlock the door/gate on which biometric lock 301 is mounted.

Mobile/web application 302 can help users of biometric lock 301 to organize and manage access to a protected resource, such as a house, a car, a safe, etc. The log information can help inform the owners and/or administrators how the resource is accessed. Biometric lock 301 can also be applied to an object which has a lock mechanism, but not a door for restricting access to the object, such as a computer or a boat. For example, biometric lock 301 can be used as a lock mechanism for the computer or the boat. An owner and/or administrator of biometric lock 301 can utilize mobile/web application 302 to authorize an individual to be able to lock/unlock biometric lock 301 for any period of time.

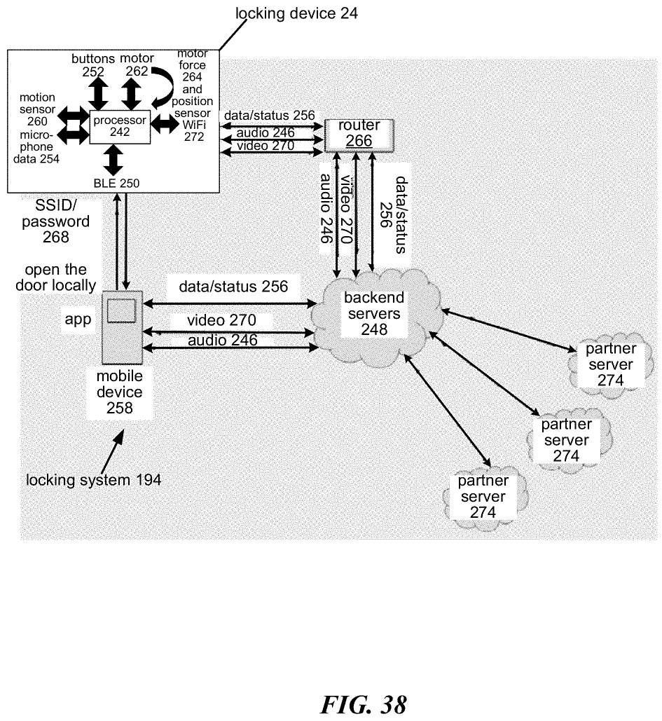

FIG. 38 illustrates a schematic diagram of a variation of data transfers between components of the locking system 194.

The microprocessor 242 (or processor) on-board the locking device 24 can send and receive data to and from the motion sensor 260, keypad, camera 118, audio microphone data 254, motor force 264 (e.g., torque or current), motor 262 and deadbolt position sensor data, and combinations thereof. The processor 242 can also activate the motor 262 and buttons 252. The processor 242 can send the received data (including data concerning the status 256) and audio 246, including status, audio 246 and video 270 information, via WiFi 272 for example, to a LAN router 266, and/or via Bluetooth Low Energy (BLE) 250 for example, to a mobile device 258 running an app. The processor can receive data such as audio and status information from the router and/or the mobile device. The mobile device can also send an SSID/password 268 to the microprocessor to signal the microprocessor to open the door 8.

The router 266 and/or mobile device 258 can communicate the data received from the processor 242 to backend servers 248 and receive data such as audio 246 and data concerning the status 256 from the backend servers 248 to send to the processor 242. The backend servers 248 can send and receive some or all of the data to various partner servers 274.

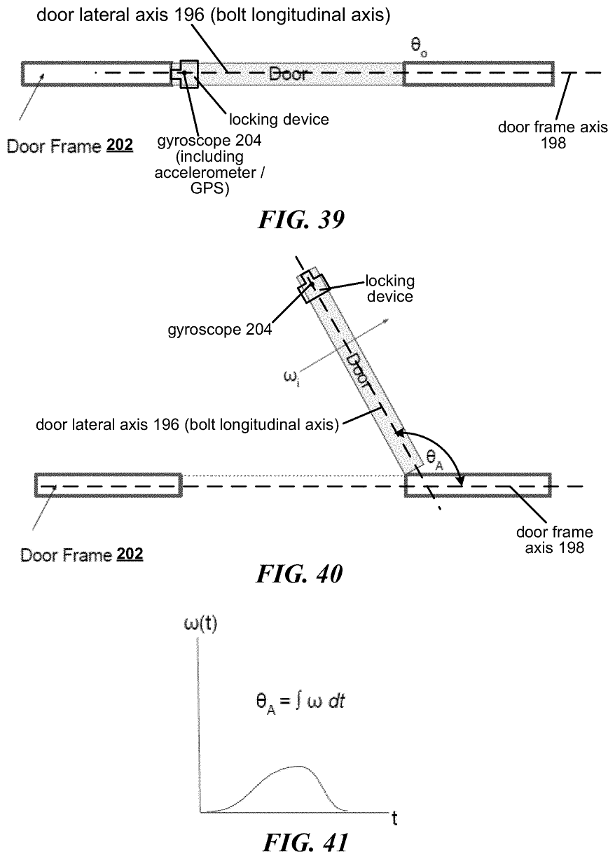

FIG. 39 illustrates that the locking device 24 can have one or more position and/or motion tracking elements 200, for example a gyroscope 204, accelerometer, satellite location sensor (e.g., GPS sensor) or combinations thereof (referred to as a gyroscope 204 for brevity). The door 8 can be closed in the door frame 202 so that a door frame axis 198 is collinear with a door lateral axis 196. The door lateral axis 196 can be collinear with the bolt longitudinal axis. The angle between the door frame axis 198 and the door lateral axis 196 can be θ. When the door 8 is closed, θ can be θ₀, for example about 0°. The lateral side of the door away from the gyroscope 204 can be hinged to the door frame 202.

FIG. 40 illustrates that the door 8 can be rotated open at an angular velocity ω. At a time A, the angular velocity of the door 8 can be ωᵢ and angle of the door 8, θ, can be θ_{A}. The angle of the door 8, θ_{A}, can be calculated by one or more processors in the locking device 24 or remote processors in data communication with the locking device 24. For example, the gyroscope 204 can sense the angular velocity of the door 8, ωᵢ.

FIG. 41 illustrates that the angle of the door 8 can be calculated as the area under the curve shown in the graph, as shown by the formula: θ_{A}=∫ωdt. The device and system can sense the angle of the door 8 and whether the door 8 is open or closed.

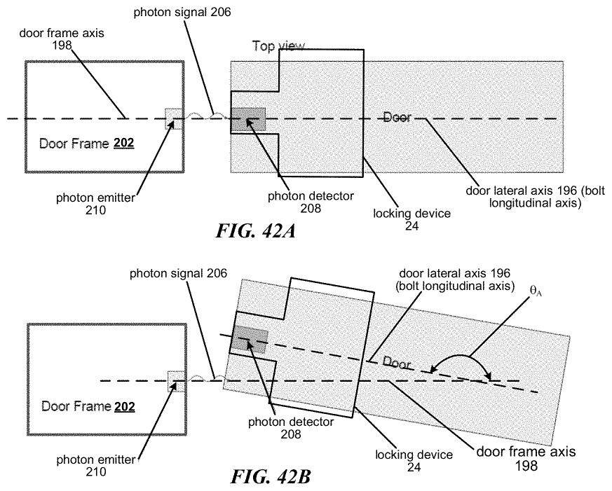

FIG. 42A illustrates that the locking device 24 can have one or more photon detectors 208 and/or photon emitters 210. The door frame 202 adjacent to the locking device 24, for example in the strike plate 60, can have one or more photon emitters 210 and/or photon detectors 208 corresponding with the photon detectors 208 and/or photon emitters 210 in the locking device 24. For example, the central emitting axes of the photon emitters 210 in the door frame 202 can be collinear with the corresponding central detecting axes of the photon detectors 208 in the door frame 202 and vice versa when the door 8 is closed, as shown in FIG. 42A. The central emitting axes of the photon emitters 210 in the door frame 202 (as shown in FIGS. 42A and 42B) can be and the central detecting axes of the photon detectors 208 in the door frame 202 can be collinear with the door frame axis 198. The central detecting axes of the photon detectors 208 (as shown in FIGS. 42A and 42B) and the central emitting axes of the photon emitters 210 in the door 8 can be collinear with the door lateral axis 196.

The photon emitters 210 can emit a photon signal 206. All of the photon emitters 210 can emit identical signals or all or some of the photon emitters 210 can emit unique signals. For example, the photon emitters 210 can emit signals that vary in amplitude, wavelength, cycling timing (e.g., a specific sequence of on times and off times for the signal), or combinations thereof. The photon signal 206 can be collimated.

When the photon signals 206 are received by the photon detectors 208, one or more processors in the door 8, the door frame 202 and/or remotely located, can receive data from the photon detectors 208 that the photon signals 206 are being received. The processor or processors can then indicate that the door 8 is closed.

FIG. 42B illustrates that when the door 8 is rotated into an opened position, the photon detector 208 cannot detect the photon signals 206. The photon detectors 208 can then send no data or data indicating that no photon signal 206 is being received. The processor or processors can then indicate that the door 8 is opened.

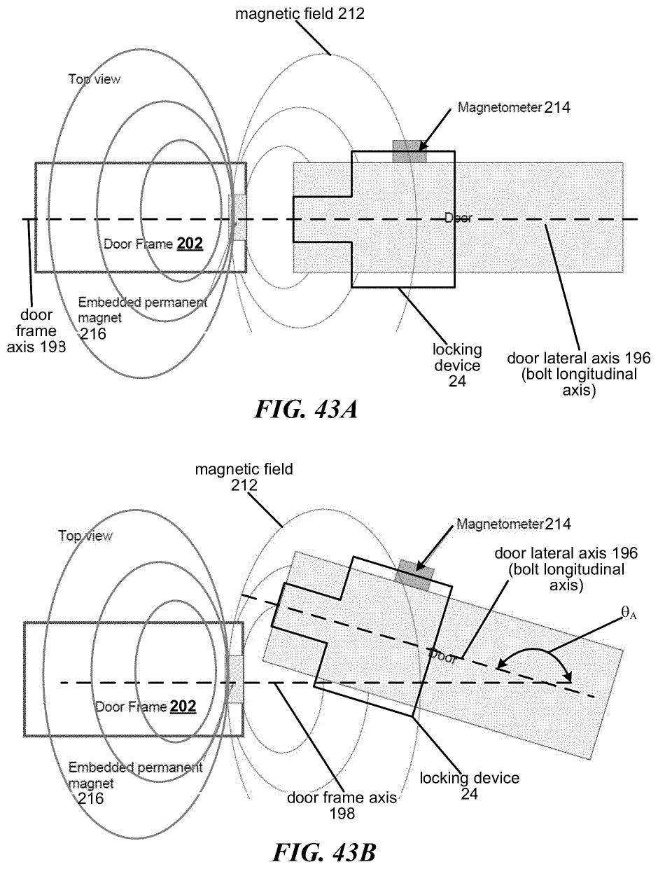

FIG. 43A illustrates that the locking device 24 can have a magnetometer 214. The magnetometer 214 can be positioned adjacent to the magnet 58 when the door 8 is closed, or on the front or rear side of the locking device 24, as shown. The door frame 202 can have one or more embedded permanent magnets 216, for example in the strike plate 60. The entire strike plate 60 can be a permanent magnet. The magnet 58 can create a magnetic field 212. The magnetic field 212 can have a field strength reducing in strength relative to distance away from the magnet 58, as indicated by the field lines.

When the magnet field strength detected by the magnetometer 214 is above the desired field strength to indicate that the door 8 is closed because of the proximity of distance between the magnetometer 214 and the magnet 58, one or more processors in the door 8, the door frame 202 and/or remotely located, can receive data from the magnetometer 214 that a high enough magnet field strength to indicate closured of the door 8 is received. The processor or processors can then indicate that the door 8 is closed.

FIG. 43B illustrates that when the door 8 is rotated into an opened position, the magnetometer 214 may be positioned outside of the magnetic field 212 detectable by the magnetometer 214, or to a position where the magnetic field 212 is weaker than a limit required for the door to be considered closed. The magnetometer 214 can then send no data or data to the processor or processors indicating that the magnetic field 212 is insufficient or not detectable. The processor or processors can then indicate that the door 8 is opened.

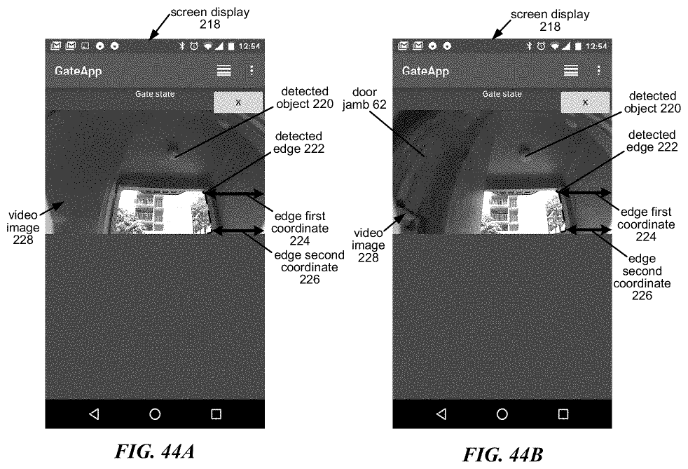

FIG. 44A illustrates that the camera 118 can send one or more video images 228, such as one or more individual still frame images or continuously streaming video, to the remote device (e.g., via the app). The images can appear on a screen display 218 of the remote device. One or more processors in the locking device 24, the remote device, or combinations thereof can analyze the video image 228 and record reference data when the door 8 is closed, as shown in FIG. 44A.

For example, the processor can identify one or more detected objects 220 and/or detected edges 222 in the reference images when the door 8 is closed. The processor can identify when the door 8 is closed for an image using any of the methods disclosed herein, detecting the most frequently occurring positions for detected objects 220 and edges, determining when frequently detected objects 220 and edges are at their common lateral-most positions in the images (e.g., the right-most position for doors closing to the left, and the left-most position for doors closing to the right), or combinations thereof.

The detected objects 220 can have reference X (horizontal within the image) and Y (vertical within the image) coordinate positions in the reference image for when the door 8 is closed. The detected edges 222 can have reference edge first coordinates 224 and reference edge second coordinates 226. The system can store the reference coordinates in memory for the detected objects 220 and edges when the door 8 is in a closed position.

FIG. 44B illustrates that when the door 8 is opened, the coordinates of detected objects 220 and detected edges 222 can change in the image with the door 8 opened compared to the coordinates for the detected objects 220 and edges in the reference images when the door 8 is closed. The processor can compare the reference X and Y coordinates of the detected objects 220 and the edge first and second coordinates with the coordinates of the detected objects 220 and edge first and second coordinates in the image with the door 8 opened.

The processors can analyze all images or sample less than all images to determine whether the door 8 is opened or closed. The processors performing this and any other analysis, calculations or computations described herein, including but not limited to image processing such as computer vision techniques, can be the local processor or processors in the locking device 24, remote processor or processors such as in a server, for example as a backend and/or partner server 274, those in a mobile device wired or wirelessly connected directly or indirectly to the locking device 24 and/or server or servers, or combinations thereof. Remote and local processors can work alone or in combination with each other on any tasks.

When the door 8 is opened, the door jamb 62 can appear in the video image 228. The processor can record the door jamb 62 with the reference coordinates of the detected objects 220 and detected edges 222. The processor can search for the reference door jamb image to detect when the door jamb 62 is in the current image and indicate or confirm that the door 8 is open.

The processor can calculate the angle of the door opening, θ_{A}, based on the position of the door jamb 62, detected objects 220 and detected edges 222 in the image from the open door 8. For example, if the horizontal field of view of the camera 118 is 150°, the camera 118 has an evenly scaled horizontal perspective, and the detected object 220 moves 20% horizontally across the field of view between the reference image when the door 8 is closed and the image when the door 8 is opened, then the processor can conclude that the angle of rotation of the opened door 8, θ_{A}, is 30° (i.e., 20% of 150°).

The processor or processors can perform computer vision techniques to analyze the images from the camera 118. For example, computer vision techniques can track bodies moving across the field of view of the camera 118. If a person or other visual object in the field of view enters the door 8 (e.g., goes into the home) and does not exit through the doorway (e.g., remains inside of the doorway or stays in the home), for example within a pre-set amount of time, the processor or other component of the system can store and/or transmit to a remote server or mobile device the time, most recent entry code and/or associated data, images and image analysis associated with the event, and/or send an alert to a remote server and/or mobile device that indicate that someone or something entered the doorway and stayed in the doorway or home at all or beyond the pre-set amount of time.

The computer vision techniques for tracking human body models can be applied by the processors on each frame of video, for example to look for human motion. The reference geometry of the door 8 and/or consistent or reliable background objects in the image can be stored by the device or system, as can be which sides of the video images 228 are “inside” and “outside” of the doorway (or home). The computer vision techniques can count and record the number of human bodies moving across the field of view.

The computer vision techniques and/or other processes executed by the processor can track or otherwise keep a running total of the net number of human bodies in the images that have entered and exited the doorway (or home). For example, if the right side of the frame is the opening side of the door 8, and an image identified as a human body moves from the left to the right side of the image and exits the frame when the door 8 is open, that will add one to the total number of human bodies that entered the doorway (and vice versa). If an identified human body image fails to appear from the right side of the frame after a preset amount of time, and/or image processing of the face of the human body of the image fails to identify a face having permission to enter or remain inside of the doorway, the processor can indicate that the human remained inside of the doorway (or home). The locking device 24 or system can then send an alert message and/or data from the event such as a time, images, audio, face recognition data, or combinations thereof, to one or more servers and/or mobile devices (e.g., of the home owners). The servers and/or mobile devices can analyze the alert message and/or data, and manually (e.g., after user review and determination if the alert and/or data warrants further investigation or alert) and/or automatically (after further image processing, such as face recognition analysis) send an alert and/or further data, if triggered, to yet further servers or mobile devices, such as a police and/or alarm company server, a mobile device in a police and/or security vehicle and/or on police or security personnel, or combinations thereof.

Components of the locking device described herein can be integrated into a door, a door frame, or both. The battery and processing components of the locking device can be housed by the door. The door can have a solar panel to recharge the battery. The locking device can have a solar panel to recharge the battery. The door can additionally or alternatively couple the battery to electrical wiring of the building in which the door is installed, or the electrical wiring of the building can directly power the components of the locking device. Sensors can be disposed on or near a surface of the door, the door frame, or both. For example, the camera can be placed near a peephole of the door, or can be used instead of a peephole. As another example, the camera can be attached to or integrated with the door frame. An antenna can be disposed near a surface of the door, or the entire door can function as an antenna. Hinges of the door can detect whether the door is open (e.g., via magnetic sensors, distance sensors, resistive sensors, or capacitive sensors), and can be motorized to automatically close the door if the door is detected to be open.

The locking device can be placed on an interior or exterior gate or door of an apartment building or complex or gated housing community. For example, when a locking device is placed on the exterior gate or door, the exterior locking device can communicate with one or multiple locking devices interior to the complex or community (e.g., locking devices used to lock individual homes or apartments behind the exterior gate or door). For example, a call button pressed at the exterior locking device can cause a sound signal to play at the locking device of a house or apartment, or the microphones and speakers of the interior and exterior locking devices can provide intercom functionality between the apartment or home and exterior gate or door. The exterior locking device may be unlocked by a signal transmitted from a home's or apartment's locking device, for example in response to a resident pressing an “unlock” button on the interior locking device or entering a code at the interior locking device. Activity at the exterior locking device (e.g., entry of a pin code or an intercom call) can additionally or alternatively be communicated to a resident's mobile phone through the locking device mobile application.

The locking device can have any of the features and functionality as described in any of U.S. patent application Ser. No. 15/360,758, filed Nov. 23, 2016; U.S. patent application Ser. No. 14/736,126, filed Jun. 10, 2015; U.S. patent application Ser. No. 14/736,072, filed Jun. 10, 2015; U.S. patent application Ser. No. 14/641,069, filed Mar. 6, 2015; and U.S. patent application Ser. No. 14/641,047, filed Mar. 6, 2015; each of which is incorporated herein by reference in its entirety for all purposes.

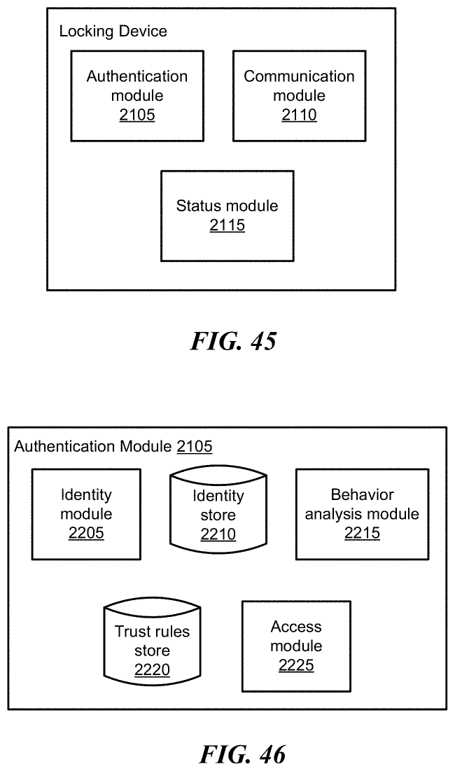

The locking device and system can perform trust verification to authorize or deny people access to a space, determine and control the status of a space, and communicate with other devices regarding the status of a space. FIG. 45 is a block diagram illustrating functional modules executable by the locking device to perform the trust verification, status control, and communication. As shown in FIG. 45, the locking device can include an authentication module 2105, a communication module 2110, and a status module 2115. The functional modules can be stored, for example, by the first or second memory shown in FIG. 36, by the microcontroller 304 shown in FIG. 37, or by another storage device. The modules can be executed by the processor shown in FIG. 36, by the microcontroller 304, or by another processing device.

The authentication module 2105 can identify a person in proximity to the locking device and authorize or deny the person access to a space locked by the locking device.

FIG. 46 is a block diagram illustrating submodules within the authentication module 2105. As shown in FIG. 46, the authentication module 2105 can include an identity module 2205, an identity store 2210, a behavior analysis module 2215, a trust rules store 2220, and an access module 2225.

The identity module 2205 can determine an identity of a person in proximity to the locking device. A person can be in proximity to the locking device when at least one sensor of the locking device can detect the person or an object carried by the person. Using data received from the camera (e.g., a face of the person, a vendor company name, a vendor logo, or any combination thereof), the microphone (e.g., a voice of the person), the antenna (e.g., a Bluetooth or WiFi signature of a mobile device carried by the person), and/or other sensors, the identity module 2205 can develop and store an identity of a person in the identity store 2210. The identity can be a digital representation of biological or biometric features of the person, such as facial features, voice features, iris features, or fingerprint features. As another example, the identity can be a digital representation of non-biological or non-biometric features of the person. For example, the identity can include features of objects carried by the person, such as digital signatures of one or more mobile devices belonging to the person (e.g., Bluetooth signatures or MAC addresses), information extracted from a credit card or driver's license of the person, visual information detected from the camera such as the person's company name on their uniform or vehicle, or any combination thereof. As yet another example, the identity can be a digital representation of biometric and non-biometric features and information. The identity stored in the identity store 2210 can be used to identify a person in proximity to the locking device or to determine when a person is in proximity to the locking device for a first time.

The identity module 2205 can automatically determine the data for building an identity when a person is determined to be in proximity to the locking device. For example, the identity module 2205 can collect data from the sensors when motion is detected, or when a person provides an input into the locking device (e.g., inserting a key, entering a PIN or access code, ringing the doorbell, or pressing a “lock” button). A person can additionally or alternatively provide explicit identity data to the locking device by, for example, linking a picture of the person's face or fingerprint, an audio sample of the person's voice, or a digital signature of a device. For example, an owner of the locking device can provide explicit identity data to the locking device when installing the locking device, ensuring that the owner's identity is verified at the locking device.

The identity module 2205 can communicate with an external data source to generate the identity of a person. Data stored by an external entity can provide information about a person's criminal record, credit score, zip code, or other information that can be used to build a trust profile for the person. The external data source can be, for example, a database provided by FIDO Alliance™, credit monitoring bureaus, or other similar organizations. As another example, the external data source can be a database or information provided by a vendor such as a delivery company, retailer (e.g., online retailer), or grocery store.

The identity module 2205 can store an identity of a location of the locking device, in addition to or instead of an identity of a person. Data corresponding to the location can include a sound profile of the location, a profile of digital signatures in the environment, a baseline image profile of the location, or other data. The identity module 2205 can store the location identity in the identity store 2210, where it can be used as a baseline to compare to conditions of the location or to determine if the locking device has been moved to a new location.

The behavior analysis module 2215 can use data from the identity store 2210 to track behaviors of a person in proximity to the locking device. Identity data in the identity store 2210 can be used to identify a reason for a particular person to be near the locking device. If the locking device is positioned on an exterior door of a house or apartment, the behavior analysis module 2215 can identify a person as a resident of the house or apartment based on when and how frequently the locking device detects the person. For example, the behavior analysis module 2215 can determine a person is a resident based on detecting that the person is in proximity to the locking device at an above-threshold frequency (e.g., at least once per day) and/or at particular times of day (e.g., several hours at night). The behavior analysis module 2215 can identify that a person is a neighbor to the house or apartment where the locking device is located, based on how frequently the person is in proximity to the locking device, based on the person at certain times being located in proximity to the locking device without entries or without frequent entries to the house or apartment, or any combination thereof. Other people can be identified based on their occupation. For example, the behavior analysis module 2215 can identify that a person is associated with emergency services personnel based on a wireless signal emitted by a unique badge or visual identification of a badge or uniform. As another example, the behavior analysis module 2215 can identify people based on their uniform, company information on their uniform, company information on their vehicle, or any combination thereof.

Identity data in the identity store 2210 can be used by the behavior analysis module 2215 to determine a person's behavior. Machine learning algorithms and/or heuristic techniques can be applied to the identity data to identify a specific behavior of a person, such as entering a space (e.g., house or apartment) locked by the locking device, leaving the house or apartment, delivering an item to the house or apartment, picking up an item from the house or apartment, putting an item into a car visible to the locking device, putting an item into a car visible to a camera of the locking device, or taking an item out of the car. For example, the behavior analysis module 2215 can track the location of a person or object over a short period of time, such as a few seconds, and determine a direction of motion of the person or object based on the tracked location. The behavior analysis module 2215 can apply heuristic rules to the determined direction of motion to identify a particular behavior. For example, if a person is determined to be walking away from the locking device on an exterior door of a house, the behavior analysis module 2215 may determine that the person is leaving the house. If a person is determined to be walking toward the locking device while carrying an object and determined to be walking away from the locking device without carrying the object, the behavior analysis module 2215 may determine that the person delivered the object to the house. The behavior analysis module 2215 can additionally or alternatively apply a classifier to features extracted from the identity data, such as a direction of motion of a person or object, an identity of the person or object, time of day, or any combination thereof. The classifier, when applied to the features, can output a probability that the features correspond to a particular behavior. The behavior analysis module 2215 may identify the behavior as the particular behavior if the probability is greater than a threshold probability.

Identity data in the identity store 2210 can be used by the behavior analysis module 2215 to determine patterns in a person's behaviors. The patterns can be determined by analyzing the times a person is in proximity to the locking device, the number of times a person is in proximity to the locking device, or both. For example, the behavior analysis module 2215 can retrieve data indicating a plurality of times a person was in proximity to the locking device. A clustering algorithm, such as K-means clustering, hierarchical clustering, or biclustering, can be applied to the proximity data to cluster the proximity information based on time. Based on the clusters, the behavior analysis module 2215 can determine whether a person is typically in proximity to the locking device at particular times, or whether the person's behavior is random. For example, if the mean distance between data points assigned to a cluster is less than a threshold, the behavior analysis module 2215 may determine that the center point of the cluster is a time the person is typically in proximity to the locking device. If the mean distance between the data points assigned to a cluster is greater than the threshold, the behavior analysis module 2215 may determine that the times associated with the cluster are random.

Example behaviors analyzed by the behavior analysis module 2215 can include a typical departure or arrival time for a resident of a space (e.g., house or apartment) based on proximity information clustered by time. The behavior analysis module 2215 can determine typical departure or arrival times for neighbors, or typical days on which delivery or maintenance personnel visit a house or apartment. When the identity data is combined with other data from the sensors, the behavior analysis module 2215 can build more sophisticated pictures of the behaviors of people who are in proximity to the locking device. For example, the behavior analysis module 2215 can determine that a neighbor walks his dog around the same time each day (e.g., based on images captured with the neighbor and a dog at approximately the same time each day), that the resident of a house locked by the locking device goes golfing around the same time each Saturday (e.g., based on images of the neighbor placing golf clubs into a car at approximately the same time each Saturday), or that the resident of the house left work early due to illness (e.g., based on the resident being present at an unusual time, and image or thermal data indicating the resident is flushed and feverish).

The trust rules store 2220 can store one or more trust rules. Each trust rule can define an authentication process for a person to access the space locked by the locking device, and can be specified for a particular person or associated with a trust level of the person. A trust rule associated with a high trust level may define a low-security authentication process. For example, the resident of a house or apartment locked by the locking device may have a high trust level, and may be authenticated by her proximity to the locking device. Thus, the locking device may automatically unlock when the resident is present. A trust rule associated with a moderate trust level may define a moderately secure authentication process. For example, an expected visitor (e.g., maintenance personnel or a delivery driver) may have a moderate trust level during the window of time he is expected to visit, and may be authenticated by his proximity to the locking device and entry of an access code into the locking device. A trust rule associated with a low trust level may define a highly secure authentication process. For example, an unexpected visitor may have a low trust level, and may be denied authentication even with a key or correct access code.

The authentication process(es) defined by the trust rules may rely on any combination of inputs into the locking device. Example inputs that can be used in an authentication process include inserting a physical key into the keyway of the locking device, an image of a person's face, an image of a person's fingerprint, a code entered into the locking device via the buttons on the locking device, a code or data transmitted from a mobile device to the locking device, an image of a linear or matrix barcode (e.g., displayed on a mobile device), detection of a digital signature of a device, an image of a hand signal, an audible password/codeword/sound sequence produced by a person or played by a mobile device, and/or a doorbell ringing sequence. For example, an authentication process may require a person to insert a key in the keyway and speak the phrase “Open Sesame” to unlock the locking device. Another authentication process may require a person to scan his fingerprint (e.g., by holding his finger to the camera) and use a mobile application to transmit a code from his mobile device to the locking device. Yet another authentication process may require a person to take a picture of the locking device with her mobile phone and enter a PIN into the locking device. Another authentication process may unlock the locking device if the camera detects the face of a resident.

The trust rules can be added, removed, or changed by the owner of the locking device, for example using the mobile or software application associated with the locking device. The owner can also change or modify trust levels for particular people, for example to upgrade or downgrade a person's trust level.

The access module 2225 can grant or deny a person access to a space based on the identity of the person and the trust rules. When a person attempts to access the space locked by the locking device, the access module 2225 can retrieve an identity of the person from the identity store 2210 and retrieve a trust rule from the trust rules store 2220 associated with the trust level of the person. If the person satisfies the authentication process associated with the trust rule, the access module 2225 can unlock the locking device. If the person does not satisfy the authentication process, the access module 2225 can keep the locking device locked.

Returning to FIG. 45, the communication module 2110 can communicate with other devices to share data captured by the locking device and receive information from the other devices.

Multiple locking devices can communicate with each other via the communication module 2110 to share sensor data, to transmit notifications, or both. A network of locking devices, for example in a neighborhood, can collectively track people or objects as they move throughout the neighborhood, generate notifications about security threats, track events in the neighborhood (such as a flood or an earthquake), and share sensor data if a sensor of one locking device in the network is disconnected, damaged, or blocked. The locking devices can automatically communicate with other nearby locking devices. Users of the locking devices can additionally or alternatively opt in to a locking device network to share data from their devices and receive data from the other devices in the network.

For example, one or more sensors of a locking device may be unable to collect data. Sensors of a locking device may be unable to collect data for a variety of reasons. The camera can be partially or fully blocked, for example, or power of the locking device's battery may be low, or a sensor may malfunction. If a camera or other sensor of a locking device is not able to collect data, the communication module 2110 can communicate with a nearby locking device to request the data.

As another example, a network of locking devices in a neighborhood can track an untrusted individual as she passes through the neighborhood. When the untrusted individual, such as a person who is present in the neighborhood for a first time, is detected by one of the locking devices, the communication module 2110 can send a notification to the other locking devices in the network. The notification can include identity information for the untrusted individual, including for example a picture of the individual or a wireless signature detected from a device carried by the individual. The locking devices in the network can track the untrusted person's path through the neighborhood as the person passes into and out of proximity of the locking devices in the network. If the person's behavior appears to be innocent (e.g., merely walking through the neighborhood), the locking devices in the network may take no action. However, if the person's behavior appears suspicious (e.g., entering multiple homes in the neighborhood), the locking devices may call the police and/or increase security. For example, the locking devices may heighten authentication requirements to unlock the locking devices. If the cameras or other sensors of the locking devices are typically triggered when motion is detected, the locking devices in the network may turn on the sensors when an untrusted individual is in the neighborhood, rather than waiting for motion detection to turn on the sensors.

Locking devices can be configured to communicate with other locking devices not in the same neighborhood, either by peer-to-peer communication or via a server. For example, if a locking device detects an earthquake (e.g., via an accelerometer signal), the communication module 2110 can notify other locking devices and/or a server about the earthquake and its intensity. Using data received from a plurality of locking devices, the server can, for example, determine intensity and propagation speed of the earthquake and can send warnings to locking devices, cell phones, televisions, or other devices about the earthquake.

The communication module 2110 can communicate with restaurant or store computing systems to allow a person to place an order through the locking device. The communication module 2110 can use chat bots or linguistic analysis techniques to determine that a person has placed an order (e.g., “I want a cheese and mushroom deep dish pizza from Paxti's at 6”), and can transmit the order to the appropriate system. The communication module 2110 can also enable authentication of the delivery driver, for example by sending the delivery driver a temporary access code for the locking device or by unlocking the locking device when the delivery driver is detected to be in proximity.

In addition to or instead of detecting voice inputs, the communication module 2110 can detect image inputs and communicate information based on the image inputs. For example, the communication module 2110 can detect a covert hand sign intended to alert others of a dangerous person or situation. When the communication module 2110 detects that a person has made the hand sign, the communication module 2110 can notify other locking devices, mobile devices, and/or other devices about the danger.

The communication module 2110 can communicate with a person via the speaker of the locking device. Custom messages can be played to a person based on an identification of the person. For example, the communication module 2110 can play a message to a wife, upon arriving home, that her husband will be home in five minutes, or can play a message to a child that dinner is in the refrigerator.

The status module 2115 of the locking device can monitor and/or control a status of a space near the locking device.

The status module 2115 can receive data from the sensors of the locking device and determine, based on the data, a status of a space in proximity to the locking device. The space monitored by the status module 2115 can be a space locked by the locking device (e.g., the interior of a house or apartment), a subset of a space locked by the locking device (e.g., a single room within a house or apartment locked by the locking device), or a space monitorable by the sensors of the locking device (e.g., spaces both interior to and exterior to a house or apartment locked by the locking device).

The status of a space can be determined by applying any of a variety of heuristic techniques or machine learning techniques to the data sensed by the locking device. Applying heuristic techniques, the status module 2115 can identify the status of a space if a given condition exists. For example, the status module 2115 can determine that there is a fire if a smoke detector detects smoke, or can determine that there is a gas leak if more than a threshold amount of carbon monoxide is detected. Machine learning techniques can be used in addition to or instead of heuristic techniques. The status module 2115 can, for example, apply sensor data to one or more classifiers, which can output a likely status of a space based on the combination of conditions detected by the sensors. For example, the status module 2115 may determine that a resident of a space has collapsed or fainted by applying images captured by the camera, sounds captured by the microphone, and/or other sensor data to a classifier trained to detect fainting.

The status module 2115 can communicate the status of a space to an external device, such as the resident's mobile phone, to notify the resident of the status. Some statuses can be communicated to systems or people other than the resident of the space, such as neighbors or emergency personnel. For example, the status module 2115 can contact a fire department if a fire is detected, can contact a gas company if a gas leak is detected, or can contact an ambulance if the resident of a space is determined to have collapsed. Neighbors can be contacted if a status of a space may affect the neighbors. For example, if a break-in is detected at a home, an alert can be sent to mobile phones or computers of neighbors to watch for the burglar, or to locking devices of the neighbor to increase their security.

The status module 2115 can communicate with external devices to control the status of the space. For example, the status modules 2115 of several locking devices associated with a house (e.g., a locking device on each of the front door, back door, and a side door) can communicate with one another to triangulate a position of a person in the house. Based on the person's position, the status module 2115 can, for example, lock or unlock the locking device, control temperature of the space, turn on or turn off lights, turn on or turn off electronic devices such as a television or stereo system, or increase or decrease the volume of media played by the television or stereo system. The status module 2115 can communicate with a light controller, a temperature controller, an electronic switch, or other relevant devices to control the status of the space based on the triangulated position of the person.

The status module 2115 can control the locking device or an external device to rectify an undesirable status of the space. For example, if the door with the locking device is left ajar, the status module 2115 can control a motor coupled to the door hinges to close the door. If a fire is detected, the status module 2115 can turn on sprinklers in the space to put out the fire. If emergency personnel is called, the status module 2115 can unlock the locking device when the emergency personnel arrive to give them access to the space.

Another example status of a space that can be controlled by the status module 2115 includes advertisements displayed by devices in the space. The status module 2115 can communicate with an advertisement provider to, for example, display an advertisement on a particular device when a person is in the room with the device, rather than displaying the ad when the person is not in the room.

In another example, the status module 2115 can communicate with traffic light controllers to change the timing of traffic lights. For example, the status module 2115 can receive data indicating that residents of a given neighborhood typically leave their homes around a certain time, and communicate with one or more traffic light controllers in or near the neighborhood to improve traffic flow out of the neighborhood.

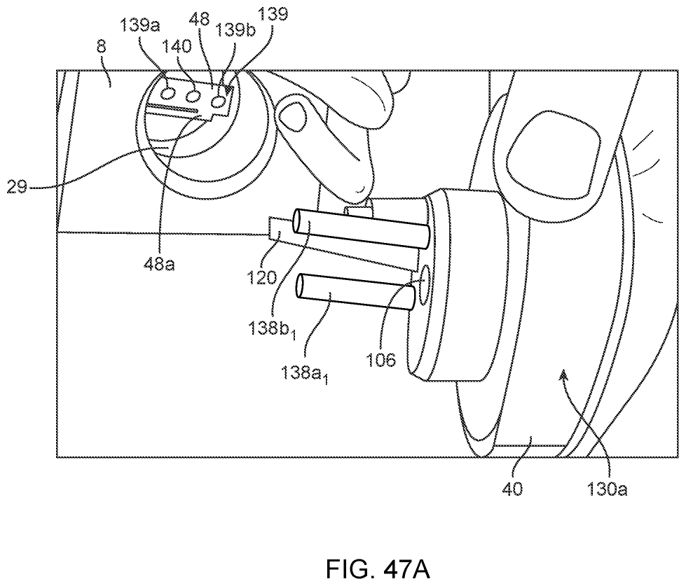

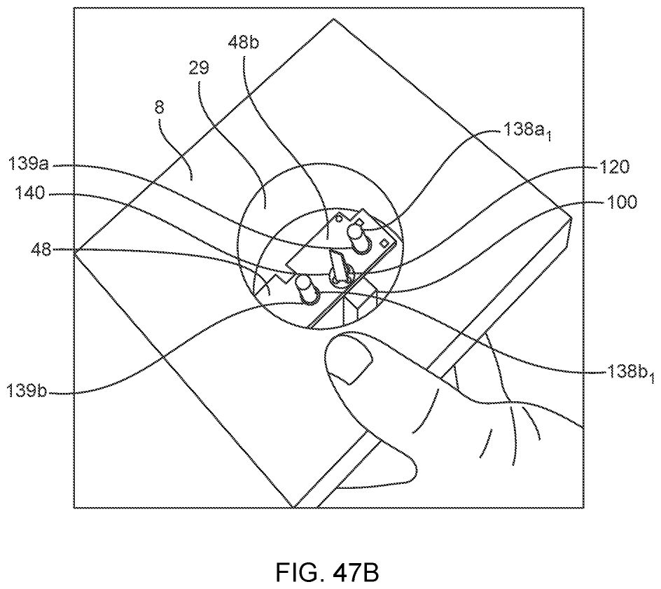

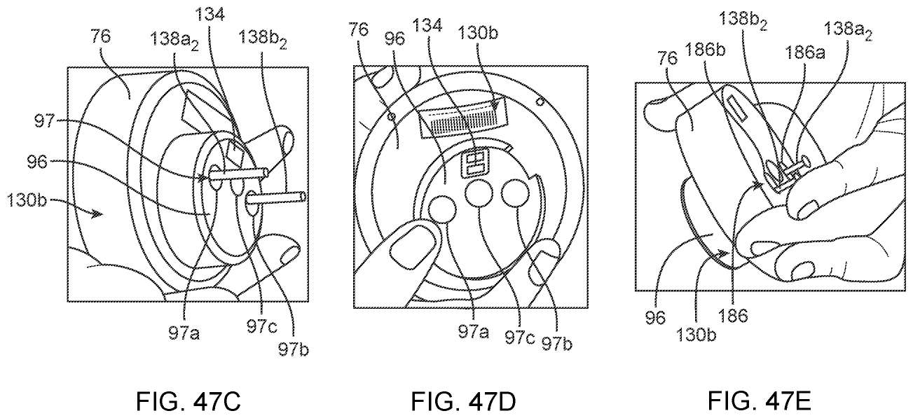

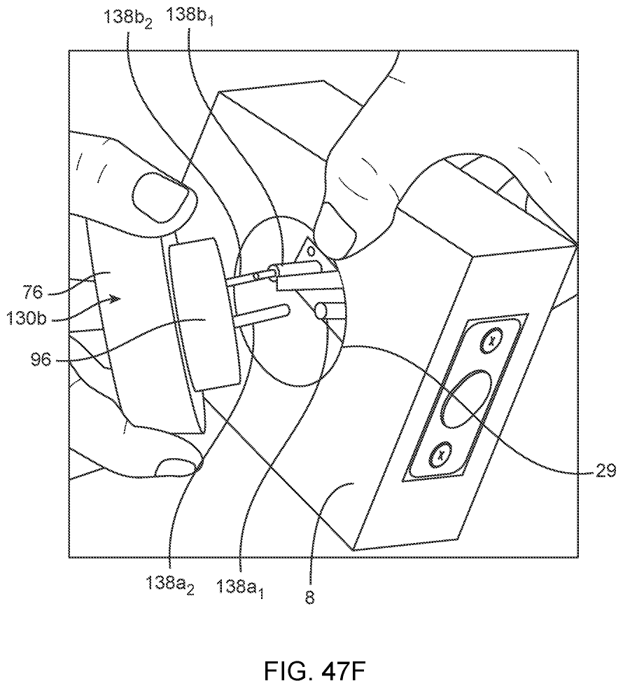

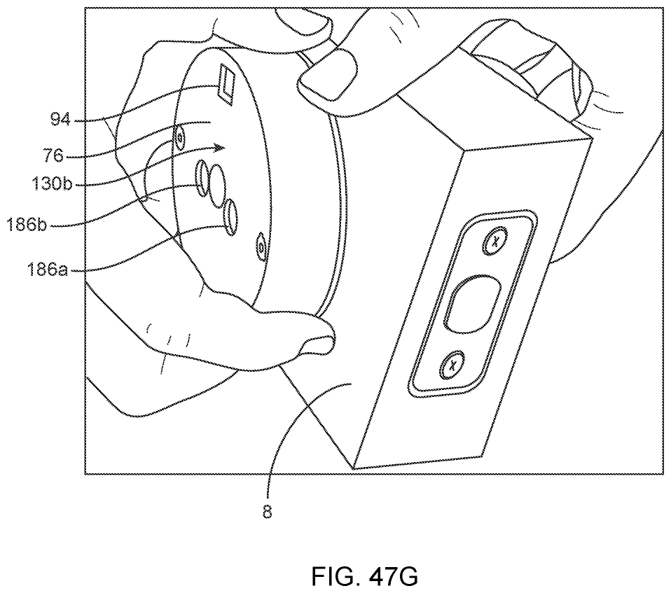

FIGS. 47A-47B illustrate a variation of a method of installing the locking device 24 to a door 8.

FIG. 47A illustrates that the method can include attaching the deadbolt 48 to the door 8. A first portion of the deadbolt 48 can be in a door bore 29 and a second portion of the deadbolt 48 can be in the bore hole 74 (not shown). The bore 29 can have a regular or irregular shape. For example, the bore 29 can have a polyhedral shape (e.g., square cuboid, rectangular cuboid, parallelepiped), a frustum shape (e.g., conical frustum, pyramidal frustum), a cylindrical shape, or any combination thereof.

FIG. 47A further illustrates that the deadbolt 48 can have one or multiple deadbolt connector holes 139, for example, deadbolt first and second connector holes 139a, 139b. Each connector hole 139 (e.g., 139a, 139b) can be configured to receive one or multiple alignment and connection elements 138 when the locking device 24 is attached to the door 8.

FIG. 47A further illustrates that a device first side 130a can have one or multiple device first side connectors 138, for example, device first side first and second connectors 138a1, 138b1. The device first side first and second connectors 138 (e.g., 138a1, 138b1) can be alignment and connection elements configured to align and secure the device first side 130a with the deadbolt 48, a device second side 130b (not shown), or any combination thereof. The device first side connectors 138 can be fixed to the device first side 130a. For example, the device first side connectors 138 can be attached to or integrated with the device first side 130. The base of the device first side connectors 138 can be attached or integrated with the device front baseplate 106. As another example, the device first side connectors 138 can be attached to or integrated with a surface (e.g., interior surface, exterior surface) of the lock front enclosure 40 or a component therein. The device first side connectors 138 (e.g., connectors 138a1 and 138b1) can extend away from (e.g., perpendicularly away from) the device front baseplate 106. The device first side 130a can be removably attached to the deadbolt 48 with the device first side connectors 138, for example, to one or more of the connector holes 139, the deadbolt tailpiece receiver 140, or any combination thereof. The device first side 130a can be removably attached to the device second side 130b (not shown) with the device first side connectors 138, for example, to one or more device second side connectors (not shown).

FIG. 47B illustrates that the device first side 130a can be attached to the door 8 by attaching the device first side 130a to the deadbolt 48. To attach the device first side 130a to the deadbolt 48, the device first side connectors 138 can be inserted through the deadbolt connector holes 139. For example, FIG. 47B illustrates that the device first side first and second connectors 138a1, 138b1 can be inserted through the deadbolt first and second connector holes 139a, 139b, respectively. The device first side connectors 138 can be translated and/or rotated through the deadbolt connector holes 139. For example, the device first side connectors 138 can be configured to be slideable through the deadbolt connector holes 139, and/or can be screwed or snapped into place. The device first side connectors 139 and the deadbolt connector holes 139 can fit together with a loose fit, a friction fit, a snap fit, a screw fit, or any combination thereof. The device first side connectors 138 and the deadbolt tailpiece 120 can extend through the deadbolt 48 from a deadbolt first side 48a to a deadbolt second side 48b. For example, FIG. 47B illustrates the device first side connectors 138 (e.g., 138a1 and 138b1) having been inserted through the deadbolt connector holes 139 and the deadbolt tailpiece 120 having been inserted through the tailpiece receiver 140.

FIG. 47C illustrates that the locking device second side 130b can have one or multiple device second side connectors 138, for example, device second side first and second connectors 138a2, 138b2. The device second side connectors 138 can be configured to engage with the device first side connectors 138 to removably secure the device first and second sides 130a, 130b together, for example, on a door (e.g., door 8). For example, the device second side first and second connectors 138a2, 138b2 can be removably engageable with the device first side first and second connectors 138a1, 138b1, respectively.

The locking device second side 130b can include the deadbolt knob 76. The device back baseplate 96 can have one or multiple ports device back baseplate ports 97 configured to receive the device second side connectors 138 (e.g., 138a2 and 138b2), the deadbolt tailpiece 120, or any combination thereof. For example, FIG. 47C illustrates that the device back baseplate 96 can have ports 97a, 97b and 97c. The device second side first and second connectors 138a2, 138b2 can be configured to extend through the device second side ports 97a and 97b, respectively, and the distal end of the deadbolt tailpiece 120 can be configured to extend through the port 97c when the device first and second sides 130a, 130b are attached to the door 8. The ports 97 (e.g., ports 97a, 97b, and 97c) can be holes in the device back baseplate 96.

The device second side connectors 138 can have a fixed length or an adjustable length (e.g., extendible and compressible length). The device second side connectors 138 can be attached to or integrated with the device second side 130b, for example, attached to or integrated with the deadbolt knob 76 or a component therein.

FIG. 47D illustrates that the device second side connectors 138 (e.g., 138a2 and 138b2) can be moveable into the housing of the device second side 130b. For example, the distal end of the device second side connectors 138 can be moveable into the device second side 130b through the ports 97a and 97b, respectively. From within the device second side 130b, the device second side connectors 138 can be moveable to the positions illustrated in FIG. 47C.

FIG. 47D illustrates that a proximal end of the of the device second side connectors can end extend through knob ports 186, for example, through first and second knob ports 186a, 186b, respectively, when the device second side connectors 138 are in the position shown in FIG. 47D.

FIG. 47C-47E illustrate that the device second side connectors 138 can translate along and rotate about their respective longitudinal axes while fixed to the device second side 130b. Such movability allows the device second side connectors 138 (e.g., 138a2 and 138b2) to more easily align with the device first side connectors 138 (e.g., 138a1 and 138b1).

The device second side 130b (e.g., deadbolt knob 76) can be removably attached to the device first side 130a with the device second side connectors 138, for example, to one or more of the device first side connectors 138. The deadbolt knob 76 can be removably attached to the deadbolt 48 with the device second side connectors 138, for example, to one or more connectors or holes 139. The battery pack 14 can be attached to the deadbolt knob 76.

The device first and second side connectors 138 can be male connectors, female connectors, or both. The connectors 138 can have screw threads. The female connectors 138 can have an opposing connector receiving port and an opposing connector receiving channel configured to receive an opposing connector. The receiving channel can be threaded. The receiving channel can be non-threaded. A first portion of the receiving channel can be threaded (e.g., a proximal or distal portion) and a second portion of the receiving channel can be non-threaded (e.g., a proximal or distal portion). The female connectors 138 can guide the male connectors 138 into place.

One or more of the device first side connectors 138 and/or one or more of the device second side connectors 138 can be male connectors. One or more of the device first side connectors 138 and/or one or more of the device second side connectors 138 can be female connectors. The male connectors can be configured to be inserted into or received by a corresponding female connector. For example, the device first side connectors 138 (e.g., 138a1 and 138b1) can be female connectors and the device second side connectors 138 (e.g., 138a2 and 138b2) can be male connectors, or vice versa. The male connectors can be fasteners (e.g., screws), rods, tapered rods, magnets, or any combination thereof. The female connectors can be female fasteners (female screws), channels, tapered channels, magnets, or any combination thereof. The device first and second sides 130a, 130b can be removably attached to one another via the device first and second side connectors 138, for example, via engagement of the 138a1-138a2 connector pair and via engagement of the 138b1-138b2 connector pair. The device first side connectors can be attached to the device second side connectors sequentially or simultaneously. The device first side connectors 138 can be configured to align and connect with the device second side connectors 138 to attach the device first side 130a to the device second side 130b. For example, the device first side connectors 138a1 and 138b1 can be configured to attach to the device second side connectors 138a2 and 138b2, respectively. The device first and second side connectors 138 can be removably attached to one another, for example, with a magnetic fit, snap fit, friction fit, screw fit, loose fit, or any combination thereof.

The front mating PCB 100 (also referred to as the bridge connector PCB 100) can mate with the rear mating PCT 134 when the deadbolt knob 76 is attached to the device first side 130a, for example, via the connectors 138 (e.g., via connectors 138a1, 138a2, 138b2 and 138b1). The mating PCB portions 100 and 134 allow for easy electrical connection without having to fish any wires through the door 8 and/or between components of the device such as the device first side 130a, device second side 130b, the deadbolt 48, or any combination thereof.

FIG. 47F illustrates that the device first and second side connectors 138 can be aligned with one another prior to inserting the device second connectors 138 into the device first connectors 138 (or vice versa) to attach the device first and second sides 130a, 130b together. The device first side connectors 138a1 and 138b1 can guide the device second side connectors 138a2 and 138b2 into place. The connectors 138 can be fixed to the housing. The deadbolt holes 139, the device first side connectors 138 (e.g., 138a1 and 138b1), the device second side connectors 138 (e.g., 138a2 and 138b2), or any combination thereof, desirably allow the locking device 24 to be self-aligning during installation. In this way, the locking device 24 can be mechanically rigid such that installation is standardized and made simple and convenient for the installer. Having the connectors attached to the locking device 24 also helps prevent attachment elements (e.g., the connectors 138) from being misplaced or lost.

FIG. 47G illustrates the device first side connectors 138 having been inserted into the device second side connectors 138. The device first and second sides 130a, 130b can be removably attached to the door 8 via engagement between the device first and second side connectors 138. FIG. 47G further illustrates that the locking device 24 can have two first side connectors 138a1 and 138b1 and two second side connectors 138a2 and 138b2.

During disassembly of the locking device 24 from the door 8, a tool, such as a screwdriver or a pusher, can be inserted through the knob ports 186 to remove, deactivate, unfasten, or loosen the device second side connectors 138 from the device first side connectors 138. During assembly of the locking device 24 to the door 8, the same or a different tool can be inserted through the knob ports 186 to insert, activate, fasten, or tighten the device second side connectors 138 to the device first side connectors 138. For example, during assembly, a tool (e.g., a screw driver or pusher) can be inserted through the knob ports 186a and 186b to attach the device second connectors 138a2 and 138b2 to the device first side connectors 138a1 and 138b1, respectively. When the device first and second side connectors 138 are attached to one another via the attachment tool, the device second side 130b can be flush with the door 8. In other variations, an attachment tool is not required to attach the device first and second sides 130a, 130b together. For example, the device second side connectors 138 can be removably locked to the device first side connectors 138 from the device second side 130b, for example, with a releasable snap fit, screw fit, friction fit, or any combination thereof with or without the use of a tool.

### Facial Recognition & Facial Recognition Processing

The camera 118 can take pictures of people within its field of view (FOV). The camera 118 can be configured to autofocus on a person when the person is in its FOV. For example, the camera 118 can be configured to autofocus on a person's face. The camera 118 can have zoom capabilities and can automatically zoom in on a person. For example, the camera 118 can be configured to auto zoom on the person's face. The camera 118 can take one or more pictures of the entire person or parts of the person (e.g., their face). The device 24 can send facial pictures to a facial recognition algorithm for processing. The facial recognition algorithm can be stored locally on the device 24, in the cloud (e.g., on a server), on a phone, or any combination thereof. For example, pictures taken by the camera 118 (e.g., facial pictures) can be processed on hardware of the device 24 that can run the facial recognition algorithm, can be uploaded to the cloud and processed on a server having the facial recognition software, can be uploaded to the a person's phone (e.g., a user's phone, an owner's phone) and processed on hardware on the phone having the facial recognition algorithm, or any combination thereof. Where the picture is sent to a server or the person's phone for facial recognition processing, the server and phone can send the facial recognition results back to the device 24.

### Multi-Factor Authentication

The device 24 can use one or multiple authentication protocols to authenticate a person who is at or near the device 24 (e.g., less than about 0.1 meters to about 50 meters from the device 24, or who is touching the device). The device 24 can automatically unlock when the person is authenticated. The device 24 can use biometric data, non-biometric data, or both forms of data to authenticate people. The device 24 can use one or multiple authentication factors, for example, 1 to 10 or more authentication factors, including every 1 authentication factor within this range (e.g., 2 factors, 3 factors, 4 factors). The authentication factors can include facial recognition, global positioning satellite (GPS) coordinates, wireless data transmission (e.g., Bluetooth, NFC, GSM), fingerprints, voiceprints (also referred to as audio authentication), iris scans, one or more security questions (which can be electronically or orally answered), physical access to a token, or any combination thereof. The device 24 can be configured to automatically unlock in the presence of two or more of these factors. For example, for two-factor authentication, the authentication factors can include facial recognition and GPS coordinates for geo-fencing. As another example, for three-factor authentication, the authentication factors can include facial recognition, geo-fencing and wireless data transmission authentication (e.g., Bluetooth authentication or NFC authentication, for example, RFID tags)).

For example, to auto-unlock for a person near the device 24, the device 24 can take a picture of the person (e.g., using the camera 118), run a facial recognition algorithm on the picture or send the picture or pictures to the cloud or another device (e.g., the person's smartphone) to analyze the picture(s) with a facial recognition algorithm, check GPS coordinates of the person (e.g., the GPS coordinates of the person's device linked to the device 24, for example, their smartphone), and/or use any other authentication marker (also referred to as authentication factors) such as Bluetooth. The device 24 can automatically unlock when the device 24 verifies that the face of the person and the physical device associated with the person (e.g., the person's smartphone) are both authorized for entry, and the physical device is within a threshold distance from the device 24. The threshold distance can be, for example, about 1 meter to about 50 meters or more, including every 1 meter increment within this range.

Multi-factor authentication can desirably result in a high confidence unlocking algorithm whether the token device is a smartphone, RFID tag, watch with NFC, or any combination thereof. Multi-factor auto-unlocking can also keep the lock secure if a person loses their smartphone, RFID tag, or watch having wireless data transmission authentication information on it, for example, by using the facial recognition factor with one or more of the other factors (e.g., voiceprint, fingerprint, iris scans, security question). Multi-factor unlocking can reduce or eliminate the occurrence of unlocking when an authorized person, for example, is not near the device or is otherwise not trying to enter or exit the door having the device (e.g., when the person is walking from their kitchen to their dining room but passes by the door having the device 24 on their way there).

Using machine learning, the device 24 can learn movement patterns of the device 24 that should and should not unlock the device 24, for example, even if each factor of the multi-factor authentication for the device 24 is satisfied. This can be especially helpful where facial recognition is not used as one of the factors, or where a person is already inside the space protected by the device 24.

### Event Timeline

The device 24 can record and keep track of device events (e.g., locking, unlocking, pictures, facial recognitions, entries, exits, grants of authentication, denials of authentication). For example, different family members can come and go using their unique pin codes, where each pin code entry can be a device event. The device 24 can record the time they enter and exit with time stamps. Using this data, a timeline of events can be generated and presented to a user on a web interface or on the device application using a dashboard interface. Events in the timeline can be categorized based on the user (e.g., pin code entry, facial recognition entry), the time, the event (e.g., enter, exit, enter and exit, delivery, biometric data recognition, non-biometric data recognition), or any combination thereof. A user can filter the timeline to view information they want to focus on based on, for example, facial recognition, the token, or any authentication factor. For example, a user can filter everything they or another user did, all the deliveries (e.g., filter out entries and exits by your family members and friends) made during a time period (e.g., morning, afternoon, day, week, month, year), the occurrences of unknown objects or people triggering the motion sensor or camera 118, or can filter the recorded data based on their pin code, other pin codes (e.g., family member pin codes), or any combination thereof. The generation of an automatic timeline by the device 24 can give users more control about how they go through the history of events. For example, the device 24 can have preset and customizable filtering options to give users the flexibility to filter the device events recorded by the device 24 as they please.

### Wi-Fi Authentication

The device 24 can have a Wi-Fi chip. The Wi-Fi chip can scan for Wi-Fi information/codes stored on other devices (e.g., smartphones) that are associated with the device 24. The device 24 can use the Wi-Fi chip to do the same thing that Bluetooth can do but using Wi-Fi instead. For example, a user's phone can have Wi-Fi, the device 24 can have Wi-Fi, and each Wi-Fi device can have a unique code. The device 24 can scan for the owner's or other authorized user's unique Wi-Fi code to verify that s/he is nearby and can authenticate the user this way using Wi-Fi. This Wi-Fi authentication can be one of the factors in the multi-factor authentication described above. The Wi-Fi chip can identify the media access control (MAC) addresses of nearby devices, the provisioning data in the device smartphone application as a credential, or both. For example, when the device 24 is installed or updated, a user can use their phone to instruct the lock 24 to connect to their home network (e.g., by giving it their home network SSID and password). The SSID and password can be stored on the phone in the application and on the device 24 so the device 24 can compare its Wi-Fi credentials with the Wi-Fi credentials it detects within range of the Wi-Fi chip. When the device 24 detects that a user's phone has the same Wi-Fi credentials as those stored on the device 24, the device 24 can automatically unlock or perform one or more additional authentication factors. For example, the device 24 and other devices can be on the same Wi-Fi network. The device 24 can scan the Wi-Fi network and can unlock the door for other devices (e.g., phones) the device 24 detects that the other device is on or has access to the same Wi-Fi network. The presence of the other device on the Wi-Fi network indicates that the device shares the same Wi-Fi security credentials, and the device 24 can be programmed to unlock when this condition is satisfied, or when this condition and one or multiple additional factors in a multi-factor authentication protocol are satisfied, for example, facial recognition and/or geo-fencing.

### LCD Buttons & Load-Balancing Physical Buttons

In addition to or instead of physical buttons, the device 24 can have a liquid crystal display (LCD), for example, on the lock front enclosure 40, configured to display touchscreen buttons. Touchscreen buttons desirably do not show wear. To prevent wear from appearing on the LCD screen, the touchscreen buttons can be displayed in a different arrangement and/or order every N number of times the buttons are displayed to load-balance the input on the LCD so it makes it more difficult to guess what buttons are being used to unlock the device 24 based on wear. N can be range for example from 1 to 10 or more, where a value of N=1 corresponds to displaying the buttons in a different arrangement and/or order every time the buttons are displayed and where a value of N=10 corresponds to displaying the buttons in a different arrangement and/or order after the buttons have been displayed ten times.

For physical keypad buttons such as the numerical keys 38 of the device 24, the use of the buttons (e.g., keys 38) can be load-balanced to prevent or minimize uneven button wear, which can desirably help minimize an unauthorized person from visually identifying which buttons are most used based on wear. For example, the device 24 can count the number of times each key is pressed and can measure the expected life and condition of each button using software on the device 24, in the cloud, or on a smartphone. The device 24 can send password update/reset notifications to the user, for example, every 3-4 months, or can send out the notification every time one or more keys has reached a threshold number of presses, for example, 500-1500 presses.

The device 24 can suggest a new pin to the users to load balance which of the keys 38 are pressed, and can make the suggestion intelligently based on the usage of each button. In addition to suggesting various pins, the device 24 can suggest not using certain numbers when helping users pick their new pin.

The device 24 can determine button usage based on the user and can suggest pins for each user of the device. For example, if a device 24 has three users A, B and C with each user having a unique pin, and user A uses their pin twice as often as user B and twice as often as user C, the device 24 can suggest load-balancing pins to help ensure even wear of the buttons, for example, pin 1234 for user A and the same pin 5678 for users B and C such that numbers 1-8 get used approximately the same amount. The device 24 can suggest shorter pins for some users and longer pins for other users to accommodate different frequencies of pin usage.

Additionally or alternatively, a phone can directly connect to the device 24 via wireless data transmission (e.g., using Wi-Fi), and the user can use their phone application screen as the keypad to enter the code so that the physical keys 38 of the device 24 do not need to be used. The application can transfer the code to the device 24 to prevent or minimize wear of the keys 38.

### Multiple Cameras

The device 24 can have multiple cameras (e.g., multiple cameras 118) arranged in an array, for example, 2 to 5 or more cameras (e.g., 2 cameras, 3 cameras). The cameras can be pointed in different directions relative to one another so that the device 24 can have a larger effective field of view for tracking people moving in and out of the space than if only one camera were used. For example, the device 24 can have a front camera, a back camera, a jam camera, or any combination thereof. The front camera can be camera 118. The jam camera can be positioned in the door jam and can provide a field of view into the room when the door is open. The back camera can be on the battery cover 82 and face away from the door and provide a field of view into space when the door is closed and/or open. The images and videos from each of the cameras can be combined. People, animals, and objects can be tracked across the fields of view of the multiple cameras.

### Central Front Doors

Application programming interfaces can connect to central call boxes (e.g., condo call boxes) so instead of calling a user's phone, the call box will call the application through which the user can grant or deny access, or through which the application can guide the person through an authentication protocol over the call box communication channel.

### Buzzer/Door Bell Fingerprint Sensor

A buzzer button on or associated with the device 24 can include a fingerprint scanner so that for anyone who presses the button, the owner will get a scan of the person's fingerprint. The buzzer button can be the doorbell of a house and can be in wireless communication with the device 24. This can make it easier to do fingerprint sensing without taking up real estate on the device 24.

### Safety Features

Where the device 24 can do facial or voiceprint recognition, if the device 24 senses a person walking around with a face or detects a voice, and that face/voice is not in a library of people that are authorized to enter the space, then the device 24 can automatically take action. For example, the device 24 can send a warning to the person (e.g., please leave, get out of here, get off the lawn), send a notification to the owner and other authorized users of the device 24, or both. The warning message can be a pre-recorded audio message or a message that the owner of the device 24 records after receiving a notification that someone is near their door. Additionally or alternatively, the device 24 can contact the police, for example, if movement is detected on a back camera of the device without first having registered movement on the front camera, which can indicate the presence of a break-in.

### Knock Detection

The device 24 can recognize when a person is knocking on the door 8 and can send a notification to the user that someone is knocking. The device 24 can recognize knocking using accelerometers, through audio detection, or both, where the microphone 34 of the device 24 can pick up the sound of knocking. The device 24 can recognize the sound as a knocking sound and can send the owner or a user a notification that someone is knocking on the door. The device 24 can suggest that a knocker use the buzzer (e.g., “please use the doorbell”) when the device 24 detects that a person is knocking on the door.

Unless contrary to physical possibility, it is envisioned that (i) the methods/steps described above may be performed in any sequence and/or in any combination, and that (ii) the components of respective embodiments may be combined in any manner.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.).

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

Methods recited herein may be carried out in any order of the recited events that is logically possible, as well as the recited order of events. Moreover, additional steps or operations may be provided or steps or operations may be eliminated to achieve the desired result.

Furthermore, where a range of values is provided, every intervening value between the upper and lower limit of that range and any other stated or intervening value in that stated range is encompassed within the invention. Also, any optional feature of the inventive variations described may be set forth and claimed independently, or in combination with any one or more of the features described herein.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise, all technical and scientific terms used herein have the same meaning as commonly understood by one of ordinary skill in the art to which this invention belongs.

It will be understood by one of ordinary skill in the art that the various methods disclosed herein may be embodied in a non-transitory readable medium, machine-readable medium, and/or a machine accessible medium comprising instructions compatible, readable, and/or executable by a processor or server processor of a machine, device, or computing device. The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

We claim:

1. A secure access system comprising:
a door management platform comprising: processor, locking mechanism, a motor coupled to the processor and the locking mechanism, an input element, and a camera;
a first server;
a second server,
wherein the first server is configured to expect a delivery event,
wherein the first server is configured to communicate with the second server that the delivery event will occur and a delivery time window associated with the delivery event,
wherein the second server is configured to send a one-time access code to first server after approval by an administrator of the door management platform, wherein the one-time access code is valid during the delivery time window, and
wherein the second server is configured to send the delivery access code and the delivery time window to the door management platform.

2. The system of claim 1, wherein the door management platform is configured to unlock the locking mechanism when the access code is entered into the input element during the delivery time window.

3. The system of claim 1, wherein the second server is configured to send facial recognition data associated with the one-time access code to the first server.

4. The method of claim 1, wherein the door management platform comprises a processor, a locking mechanism, a motor coupled to the processor and the locking mechanism, and a camera.

5. The system of claim 1, wherein the door management platform further comprises:
memory coupled to the processor
a wireless communication interface coupled to the processor
a microphone coupled to the processor
a speaker coupled to the processor

6. A secure access method comprising:
informing a first server a delivery event expected to occur;
communicating by the first server to a second server that the delivery event will occur and a delivery time window associated with the delivery event;
communicating by the second server to the first server a one-time access code after approval by an administrator of the door management platform, wherein the one-time access code is valid during the delivery time window; and
communicating, by the second server to a door management platform, the one-time access code and delivery time window.

7. The method of claim 6, further comprising unlocking the locking mechanism by the door management platform after receiving entry of the access code into an input element on the door management platform during the delivery time window.

8. The method of claim 6, wherein the door management platform comprises a processor, a locking mechanism, a motor coupled to the processor and the locking mechanism, and a camera.

9. The method of claim 6, further comprising creating by the second server the one-time access code.

10. A door management platform, for remotely managing access to an area, comprising:
a processor;
a memory coupled to the processor;
a wireless communication interface coupled to the processor;
a microphone coupled to the processor;
a speaker coupled to the processor;
a camera coupled to the processor;
a locking mechanism; and
a motor coupled to the processor and to the locking mechanism,
wherein the door management platform is configured to send, via the wireless communication interface, a real-time stream of video acquired by the camera to a computing device of an administrator of the door management platform to enable the administrator to see a person requesting access to an area protected by the door management platform,
wherein the door management platform is configured to provide, via the wireless communication interface, a two-way real-time audio connection between the door management platform and the computing device of the administrator to enable the administrator and the person requesting access to be able to verbally communicate, the two-way real-time audio connection being facilitated by the microphone and the speaker, and
wherein the door management platform is configured to lock or unlock the door management platform in response to a message received from the computing device of the administrator after the administrator verifies, based on the real-time video stream or the real-time audio connection, an identify of the person requesting access, the message indicating to lock or unlock the door management platform.

11. The door management platform of claim 10, further comprising:
a doorbell button coupled to the processor,
wherein the door management platform is configured to send a notification of activation of the doorbell button to the computing device of the administrator in response to the doorbell button being activated by being pressed by the person requesting access, and
wherein configuration of the door management platform to provide the real-time video stream and the real-time audio connection includes being configured to provide the real-time video stream and the real-time audio connection in response to said notification of activation.

12. The door management platform of claim 10,
wherein the door management platform is configured to communicate with a mobile device of the person requesting access.

13. The door management platform of claim 12,
wherein the door management platform is configured to receive, from the computing device of the administrator, an electronic signature that is to be captured by the computing device to acknowledge delivery of an item, and
wherein the door management platform is configured to send the electronic signature to the mobile device of the person requesting access.

14. The door management platform of claim 12, wherein the door management platform is configured to receive, via the mobile device, personal data of the person requesting access, and to send the personal data to the computing device of the administrator.

15. The door management platform of claim 14, wherein the personal data includes a photo, of the person requesting access, that the administrator can use to identify the person requesting access, the photo being an electronic copy of a photo that is stored at a server of an employer of the person requesting access.

16. The door management platform of claim 12, wherein the door management platform is configured to communicate with the mobile device of the person requesting access via any of a short distance wireless communication standard, a local area wireless network, or a cellular network.
